(19) United States
(12) Patent Application Publication
(10) Pub. No.: US 2018/0137984 A1
(43) Pub. Date: May 17, 2018

(54) SOLID STATE ENERGY STORAGE DEVICE

(71) Applicant: Capacitor Sciences Incorporated, Menlo Park, CA (US)

(72) Inventors: Paul T. Furuta, Sunnyvale, CA (US); Yan Li, Fremont, CA (US); Barry K. Sharp, San Francisco, CA (US); Pavel Ivan Lazarev, Menlo Park, CA (US)

(21) Appl. No.: 15/805,016

(22) Filed: Nov. 6, 2017

Related U.S. Application Data
(63) Continuation-in-part of application No. 14/719,072, filed on May 21, 2015, now Pat. No. 9,932,358.

(51) Int. Cl. H01G 7/06

(52) U.S. Cl. CPC H01G 7/06

(57) ABSTRACT

The present disclosure provides a solid state energy storage device, comprising: a first electrically conductive electrode, a second electrically conductive electrode; and at least one metadielectric layer located between the first and second conductive electrodes. The metadielectric layer comprises at least one type of mesogen. The mesogen consists of an organic compound with at least one electrically resistive substituent and at least one polarizable unit. The polarizable unit may be independently selected from intramolecular and intermolecular polarizable units.

### CLAIM OF PRIORITY

This Application is a continuation-in-part of U.S. patent application Ser. No. 14/719,072 filed May 21, 2015, the entire contents of which are incorporated herein by reference.

### FIELD OF THE INVENTION

The present invention relates generally to passive components of electrical circuit and more particularly to a solid state energy storage device based on metacapacitor.

### BACKGROUND

Energy storage is a crucial component of a large number and variety of electronic devices, particularly mobile devices and vehicles, such as electric and hybrid gas-electric vehicles (also “hybrid vehicles” herein). Energy storage devices can be based on a variety of physical effects. For example, electric fields can be employed to store energy in capacitors, and chemical reactions (involving ion motion) can be employed to store energy in batteries. However, energy storage in a capacitor can be limited by the geometry of current devices (e.g., 2-D capacitor plates having limited surface areas) and either a low permittivity or low dielectric breakdown voltage, and batteries can have a slow response time due to the relatively slow ion motion inherent in electrochemical reactions.

There are limitations associated with current batteries. For example, current batteries can have low storage densities due to the relatively low voltage (<5V) resulting from the electrochemical reactions of the ions. In addition, the low mobility of ions in current batteries can lead to slow charge and discharge performance. Furthermore, the reliance of existing batteries on ionic transport causes high degradation rates of the batteries. The performance of battery powered devices, such as hybrid or electric vehicles, can be limited by the low energy stored per weight of batteries used in such vehicles.

One important characteristic of a dielectric material is its breakdown field. The breakdown field corresponds to the value of electric field strength at which the material suffers a catastrophic failure and conducts electricity between the electrodes. For most capacitor geometries, the electric field in the dielectric can be approximated by the voltage between the two electrodes divided by the spacing between the electrodes, which is usually the thickness of the dielectric layer. Since the thickness is usually constant it is more common to refer to a breakdown voltage, rather than a breakdown field. There are a number of factors that can dramatically reduce the breakdown voltage. In particular, the geometry of the conductive electrodes is important factor affecting breakdown voltage for capacitor applications. In particular, sharp edges or points hugely increase the electric field strength locally and can lead to a local breakdown. Once a local breakdown starts at any point, the breakdown will quickly “trace” through the dielectric layer until it reaches the opposite electrode and causes a short circuit.

Breakdown of the dielectric layer usually occurs as follows. Intensity of an electric field becomes high enough to “pull” electrons from atoms of the dielectric material and makes them conduct an electric current from one electrode to another. Presence of impurities in the dielectric or imperfections of the crystal structure can result in an avalanche breakdown as observed in semiconductor devices.

In some instances, a high breakdown voltage is achieved for the device at least in part by using materials having a high purity. Generally, minimizing the number of defects in the dielectric material can increase the breakdown voltage. The devices known in the art comprise a pure or substantially pure dielectric material. The dielectric material may be highly pure. For example, the dielectric material comprised of polymeric material may have a polydispersity index (PDI) less than or equal to 2.5, or a monomer content less than or equal to 5%. In some embodiments, the dielectric material, for example, comprises polymeric material that may preferentially have a PDI less than or equal to 1.6 and a monomer content less than or equal to 2%. In some embodiments, the dielectric material may, for example, have fewer than or equal to 500 parts per million (ppm) of free ionic contaminants. In some embodiments, the dielectric material may preferentially have fewer than 200 ppm of free ionic contaminants. Alternatively, in some embodiments, the dielectric material, for example, may be greater than or equal to 99% pure. An impurity may be taken to mean an atomic impurity or a defect in a crystal structure. In some instances, breakdown voltage can be tuned by the degree of crystallinity. An additional factor that can influence the tuning of breakdown voltage is the type of crystalline repeat unit found in the dielectric material.

In some instances, a high breakdown voltage is achieved for the device at least in part by using materials able to withstand a high breakdown voltage. The intrinsic breakdown values of the dielectric matrix material depend on the composition of the material, and the use of high breakdown voltage materials can help increase the device breakdown voltage. Examples of dielectric matrix materials that may be used in the devices include, without limitation, silica, praseodymium oxide, alumina, diamond, hafnium oxide and combinations thereof. Some suitable matrix materials are described in U.S. Patent Publication No. 2010/0183919.

Another important characteristic of a dielectric material is its dielectric permittivity. There are many different types of dielectric materials used for capacitors. These materials include ceramics, polymer film, paper, and electrolytes of different kinds. The most widely used polymer film materials are polypropylene and polyester. Increasing the dielectric permittivity of a material used for a capacitor allows for an increase in the possible volumetric energy density of the capacitor, which makes it an important technical task.

Second-order nonlinear optical (NLO) effects of organic molecules have been extensively investigated for their advantages over inorganic crystals in electro-optical devices. Properties studied, for example, include their large optical non-linearity, ultra-fast response speed, high damage thresholds and low absorption loss, etc. Particularly, organic thin films with excellent optical properties have tremendous potential for integrated optics in fields such as optical switching, data manipulation and information processing. Among organic NLO molecules, azo-dye chromophores have been a special interest to many investigators because of their relatively large molecular hyper-polarizability (b) due to delocalization of the p-electronic clouds. They were most frequently either incorporated as a guest in the polymeric matrix (guest-host polymers) or grafted into the polymeric matrix (functionalized polymers) over the past decade.

Hyper-electronic polarization of organic compounds is described in greater detail in Roger D. Hartman and Herbert A. Pohl, “Hyper-electronic Polarization in Macromolecular Solids”, Journal of Polymer Science: Part A-1 Vol. 6, pp. 1135-1152 (1968). Hyper-electronic polarization may be viewed as the electrical polarization external fields due to the pliant interaction with the charge pairs of excitons, in which the charges are molecularly separated and range over molecularly limited domains. In this article four polyacene quinone radical polymers were investigated. These polymers at 100 Hz had dielectric constants of 1800-2400, decreasing to about 58-100 at 100,000 Hz. The essential drawback of the method of production of the material described in this article is the use of high pressure (up to 20 kbars) for forming the samples intended for measurement of dielectric constants.

It is known that energy storage devices based on capacitors have many advantages over electrochemical energy storage devices, e.g., batteries. However, ordinary energy storage devices based on capacitors often do not store enough energy in a small volume or weight as in case of a battery, or at low energy storage cost, which makes capacitors impractical for some applications, for example electric vehicles. Compared to batteries, the disclosed solid state energy storage device is able to store energy with a very high power output and energy density, i.e., high charge/recharge rates, have long shelf life with little degradation, and can be charged and discharged (cycled) hundreds of thousands or millions of times.

### SUMMARY

The present disclosure provides a solid state energy storage device, comprising:

a first conductive electrode, a second conductive electrode and at least one metadielectric layer located between the first and second conductive electrodes. The metadielectric layer comprises at least one type of mesogen. The mesogen consists of an organic compound with at least one electrically resistive substituent and at least one the intramolecular or intermolecular polarizable unit.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWING

Aspects of the present disclosure may be appreciated by referring to the accompanying drawing figures in which: FIG. 1 schematically illustrates the disclosed solid state energy storage device, in accordance with an embodiment of the invention.

FIG. 2 schematically illustrates an example of the disclosed solid state energy storage device comprising intermediate layers.

FIG. 3 schematically illustrates an example of the disclosed solid state energy storage device comprising electrically conductive layers.

FIG. 4 schematically illustrates an example of the disclosed solid state energy storage device comprising tunnel barrier layers.

FIG. 5 schematically illustrates dependence of the charge (Q) accumulated on electrodes on the electric field (V/μm) for polypropylene and four metadielectric materials.

FIG. 6 schematically illustrates a coiled energy storage device. FIG. 7 schematically illustrates a plot of permittivity versus voltage for a material having a first permittivity (ε₁) below a critical voltage (Vc₁) and a second permittivity (ε₂) above a critical voltage.

FIG. 8 schematically illustrates a plot of permittivity versus voltage for a material having a first permittivity (ε₁) below a first critical voltage (Vc₁) and a second permittivity (ε₂) above a critical voltage (Vc₁) and a third permittivity (ε₃) above a second critical voltage (Vc₂).

FIG. 9 schematically illustrates a Q-V plot for a standard material (B) and a material having a permittivity that varies with voltage (A).

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “vehicle,” as used herein, generally refers to any electric device configured to move, or cause an object to be moved, from one point to another. In an embodiment, a vehicle can include an electric device configured to transport objects from one point to another. In another embodiment, a vehicle can include a car, bus, motorcycle, motorized bicycle, scooter, boat, plane, train, tram, or robot. In another embodiment, a vehicle can include an electric vehicle. In another embodiment, a vehicle can include a hybrid gas-electric vehicle (also “hybrid vehicle” herein).

The term “meta-dielectric layer,” as used herein, generally refers to any material configured to retain charge (electrons or electron holes), or having materials or species configured to retain or redistribute charge among the species. A meta-dielectric layer can include one or more mesogens, such as nematic structures, chematic structures, chiral nematic structures, lyotropic type structures (including, but not limited to lamellar and micelle structures), or any combination thereof. In some cases, the mesogens may include supramolecular structures of composite electro-polarizable organic compounds, composite non-linear electro-polarizable organic compounds, composite polarizable organic compounds, or any combination thereof. Further, a defining feature of all said composite polarizable compounds above is high resistivity of substituents of the composite organic compounds. Examples high resistivity substituents may include alkyl groups such as C₁-C₅₀ chains and may be branched, unbranched; fully saturated with H, F, Cl, Br; partially halo-substituted; fused polycyclic groups; or any combination thereof.

U.S. patent application Ser. No. 15/469,126 (Attorney Docket Number CSI-050-US) filed Mar. 24, 2017; Ser. No. 15/449,587 (Attorney Docket Number CSI-050B-US, YanLi polymers) filed Mar. 3, 2017; Ser. No. 15/449,524 (Attorney Docket Number CSI-003B) filed Mar. 3, 2017, Ser. No. 15/710,587 (Attorney Docket Number CSI-050C, YanLi polymers) filed Sep. 20, 2017; Ser. No. 15/090,509 (Attorney Docket Number CSI-051) filed Apr. 4, 2016; Ser. No. 15/163,595 (Attorney Docket Number CSI-051B) filed May 24, 2016; Ser. No. 14/919,337 (Attorney Docket Number CSI-022) filed Oct. 21, 2015; Sharp polymers commonly described in U.S. patent application Ser. No. 15/043,247 (Attorney Docket Number CSI-046) filed Feb. 12, 2016; Furuta polymers as commonly described in U.S. patent application Ser. No. 15/043,186 (Attorney Docket Number CSI-019A) filed Feb. 12, 2016 and U.S. patent application Ser. No. 15/043,209 (Attorney Docket Number CSI-019B) filed Feb. 12, 2016; which are incorporated herein by reference, describe exemplary composite polarizable organic compounds, which are herein referred to as polarizable units. A meta-dielectric layer can be formed of a material that permits the flow of charge under predetermined voltage conditions. A meta-dielectric layer can include an organic semiconductor, such as a p-type or n-type organic semiconducting material, or an organometallic material. P-type organic semiconducting materials can include pi-conjugated carbon chains and rings with and without hetero-atoms. Organic semiconductors that are chemically doped (“doped”) p-type, such as, e.g., with the aid of electron withdrawing groups (e.g. —NO₂). N-type organic semiconducting materials can include pi-conjugated carbon chains and rings with and without heteroatoms (e.g. benzimidazobenzophenanthroline) that are “doped” n-type, such as with the aid of electron donating groups (e.g. —NH₂).

Another significant advance of a meta-dielectric layer comprising organic polarizable composite compounds is its inherent flexibility and compressibility relative to metal oxides and other inorganic materials such as those described in U.S. patent application Ser. No. 14/700,048 filed on Apr. 29, 2015; and Ser. No. 14/238,472 filed Jul. 10, 2012.

The term “tunnel barrier layer,” as used herein, generally refers to thin layers of wide-bandgap materials through which a transport (carrying over) of mobile carriers of a charges (electrons and holes) by means of tunneling is carried out. Exemplary tunnel barrier layers comprise, without limitation, silicon dioxide (SiO₂).

The term “electrically conductive layer,” as used herein, generally refers to layers made of electro-conductive materials. The electrically conductive layers, without limitation, can be formed of any metal, metallic or metal-containing material, such as one or more of Au, Pt, W, Al, Cu, Ag, Ti, Se, Ge, Pd, Ni, Co, Rh, Ir and Os. In another embodiment, the electrically conductive layers can be formed of an organic semiconducting material, such as a doped organic semiconducting material. In another embodiment, the electrically conductive layers can be formed of carbon (e.g., diamond, graphite), such as a carbon thin film.

The term “intermediate layer,” as used herein, generally refers to layers which provided in order of increasing permittivity and decreasing breakdown voltage. The intermediate layers may comprise, without limitation, lead zirconate titanate (PZT), barium strontium titanate (BST), BaTiO₃, TiO₂, Pr₂O₃, HfO₂, Al₂O₃, Si₃N₄, or any combination thereof.

The present disclosure provides the solid state energy storage device as disclosed above. In one embodiment of the present disclosure, the organic compound is selected from the list comprising: any compound with rigid electro-polarizable organic units, composite organic polarizable compounds, composite electro-polarizable organic compounds, composite non-linear electro-polarizable compounds, Sharp polymers, Furuta co-polymers, para-Furuta polymers, YanLi polymers, or any combination thereof, and wherein the composite electro-polarizable organic compounds and composite non-linear electro-polarizable organic compounds comprise chromophores, tictiods, anisometric conjugated aromatic ring systems, rylene fragments, zwitterions, ionic liquids, electron donor groups in conjugation with an aromatic ring system, electron with drawing groups in conjugation with an aromatic ring system, or any combination thereof. Rylene fragments herein refer to perylene-like derivative structures based on a framework of naphthalene units linked in peri-positions. In some embodiments, the aforementioned rylene fragments may also consist of phenyl groups, naphthyl groups, anthryl groups or any combination thereof in conjugation with the rylene fragment. By way of example and not limitation, in some embodiments, the said organic compounds comprised of rylene fragments may include electron donor and acceptor groups in conjugation with conjugated rings of the rylene fragment.

In another embodiment of disclosed solid-state energy storage device, the mesogen of the metadielectric layer comprises domain structures selected from any combination of nematic structures, chematic structures, chiral nematic structures, and lyotropic type structures (including, but not limited to lamellar and micelle structures).

In yet another embodiment of the solid state energy storage device, the metadielectric layer further comprises several inclusions which have a permanent dipole moment (an interfacial dipole) and are located on one or two of surfaces of the metadielectric layer, wherein a material of the inclusions are independently selected from the list comprising: barium titanate, lead titanate, bismuth titanate, strontium bismuth tantalate, barium strontium titanate, zirconium titanate, lead zirconium titanate, or combinations thereof.

In still another embodiment, the metadielectric layer comprises non-ionic plasticizers selected from phthalate and non-phthalate classes of plasticizers. In some instances, the metadielectric layer may comprise of a mixture of plasticizers. Plasticizers may be included in the metadielectric layer to increase electrical resistivity, increase breakdown voltage, mechanical properties, or any combination thereof.

To any of the embodiments of the metadielectric layer, a plasticizer can be added. The work of Kamlesh Pandey in Effect of Plasticizers on Structural and Dielectric Behaviour of [PEO+(NH4)2C4H8(COO)2] Polymer Electrolyte, Journal of Polymers, 2013 Article ID 752596 teaches that plasticizers can increase the ion mobility in electrolytic polymers. A plasticizer should therefore allow the polar ionic fractions of the polymer to increase mobility in their local “pocket”, the polar plasticizers should congregate in the polar areas of the polymer, and not be attracted to the “tail” phases. The plasticizer should thereby increase the mobility of the polymer while simultaneously thermally treating the final film product.

Preferred, non-limiting, plasticizers would be selected from high boiling point aprotic solvents such as propylene carbonate, NMP, and DMSO.

In some embodiments of the solid state energy storage device, the metadielectric layer may have an effective breakdown strength between about 0.1 volts per nanometer (V/nm) and about 1.0 V/nm.

In one embodiment of the present disclosure, the polarizable unit of the organic compound is rigid and each rigid polarizable unit is electrically isolated from other intramolecular and intermolecular rigid polarizable units with an electrically resistive substituents. The rigid polarizable unit may be an aromatic polycyclic conjugated molecule that self-assembles using pi-pi stacking in a column-like supramolecule or an electro-conductive oligomer that self-assembles using pi-pi stacking in a column-like supramolecule. The polarizable unit of the organic compound i may have the shape of a two-dimensional flat form, rod-like, disc-like or sphere-like forms. Where the polarizable units have a rod-like shape they are oriented perpendicular to the plane of the electrodes of disclosed device. This minimizes the mechanical relaxation of the polarization units as the applied field decreases.

In another embodiment of the disclosed solid state energy storage device, the metadielectric layer has a permittivity that varies non-linearly with voltage. In yet another embodiment of the solid state energy storage device, the metadielectric layer has a first relative permittivity (ε₁) below a first critical voltage (Vc₁) and a second relative permittivity (ε₂) above the first critical voltage (Vc₁), the second permittivity (ε₂) is greater than the first relative permittivity (ε₁) and the second relative permittivity (ε₂) is at least 1,000 above a first critical voltage Vc₁ and the resistivity of the dielectric material is between 10¹⁶Ωcm and 10²⁴Ωcm. In still another embodiment of the solid state energy storage device, the metadielectric layer has a second critical voltage (Vc₂) which is greater than the first critical voltage (Vc₂≥Vc₁) and third permittivity (ε₃) above Vc₂ and in this case the second permittivity, ε₂, applies below Vc₂. The second permittivity ε₂ is greater than the first permittivity (ε₁), and the third permittivity (ε₃) is greater than the second permittivity (ε₂).

In some embodiments of the disclosed solid state energy storage device, capacitance varies non-linearly with voltage. For example, operating the solid state energy storage device in a DC voltage regime, the capacitance is a non-linear function of voltage.

In some embodiments of the present disclosure, the solid state energy storage device further comprises one or more intermediate layers independently located in one or more of the following positions: between the metadielectric layers, between the metadielectric layer and the first electrode, between the metadielectric layer and the second electrode. Wherein the intermediate layer is comprised of a material with a permittivity that is higher than the permittivity of the metadielectric layer and smooths the interfacial surfaces between the metadielectric layer and the electrically conductive electrode The intermediate layers may be comprised of lead zirconate titanate (PZT), barium strontium titanate (BST), BaTiO3, TiO₂, Pr2O₃, HfO₂, Al₂O₃, Si₃N₄, or any combination thereof. Electrodes or electrode smoothing materials as described in U.S. application Ser. No. 15/368,171 (Attorney docket number CSI-078) filed Dec. 2, 2016, which is incorporated in its entirety herein, are preferred for the solid state energy storage device.

In another embodiment of disclosed solid state energy storage device, the electrically resistive substituent is flexible and may be comprised of alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof. The electrically resistive substituent may be described with the formula C_{X}Q_{2X+1}, where C is Cabon, X≥1 and Q is hydrogen (H), fluorine (F), or chlorine (Cl), and the electrically resistive substituent is selected from the group consisting of single chain, branched chain, and polycyclic species.

In yet another embodiment of the solid state energy storage device, the organic compound further comprises dopant groups connected to the rigid polarizable unit, a number of dopant groups ranging from 1 to 10 and the dopant groups may be nucleophilic groups (donors) or electrophilic groups (acceptors). The electrophilic groups (acceptors) are independently selected from: —NO₂, —NH₃⁺ and —NR¹₃⁺ (quaternary nitrogen salts), counterion Cl⁻ or Br⁻, —CHO (aldehyde), —CRO (keto group), —SO₃H (sulfonic acids), —SO₃R¹ (sulfonates), —SO₂NH₂ (sulfonamides), —COOH (carboxylic acid), —COOR (esters, from carboxylic acid side), —COCl (carboxylic acid chlorides), —CONH₂ (amides, from carboxylic acid side), —CF₃, —CCl₃, —CN. The amine radical R¹ may be selected from the list comprising alkyl (methyl, ethyl, isopropyl, tert-butyl, neopentyl, cyclohexyl etc.), allyl (—CH₂—CH═CH₂), benzyl (—CH₂C₆H₅) groups, phenyl (+substituted phenyl) and other aryl (aromatic) groups\. The nucleophilic groups (donors) may be independently selected from —O⁻ (phenoxides, like —ONa or —OK), —NH₂, —NHR², —NR₂, —OH, —OR² (ethers), —NHCOR² (amides, from amine side), —OCOR² (esters, from alcohol side), alkyls, —C₆H₅, vinyls, where the radical R² is selected from the list consisting of alkyl (methyl, ethyl, isopropyl, tert-butyl, neopentyl, cyclohexyl etc.), allyl (—CH2-CH═CH2), benzyl (—CH2C6H5) groups, phenyl (+substituted phenyl) and other aryl (aromatic) groups. Finally the rigid polarizable unit and the dopant groups or the rigid polarizable unit, the dopant groups and the flexible electrically resistive substituents may form a non-centrosymmetric molecular structure.

In still another embodiment of the solid state energy storage device, the metadielectric layer is comprised of a material having a high breakdown field (E_{bd}) in at least one high-field regions where the breakdown field strength (E_{bd}) is greater than about 1 V/nm and areas of the high-field regions are less than about 1 μm² and/or have a volume that is less than about 1 μm³. In some instances, the high breakdown voltage is achieved for the device at least in part by concentrating high fields in small regions of the material. In general, materials can withstand higher local electric fields than can be sustained in the bulk of the materials. In some cases, the breakdown field decreases when the absolute number of defects present in the volume of material exposed to the high electrical field decreases. A material such as silica that can withstand about 1 V/nm in the bulk may, therefore, be able to withstand a greater strength electric field by reducing the size of silica particles up to a quantum dot, i.e., the nanometer length-scale. By concentrating high electric fields in small regions of the material one may therefore be able to increase the breakdown voltage of the disclosed devices. In some embodiments, the small region has an area correspond to the supramolecular or crystalline structures formed by polarizable units of the metadielectric. The field strength can be above any suitable threshold only in a small region of the device. In some embodiments, the field strength threshold is about 0.1 V/nm, about 0.5 V/nm, about 1 V/nm, about 2 V/nm, about 3 V/nm, about 4 V/nm, about 5 V/nm, or about 10 V/nm. In some embodiments, the field strength threshold is greater than about 0.1 V/nm, greater than about 0.5 greater than about V/nm, greater than about 1 V/nm, greater than about 2 V/nm, greater than about 3 V/nm, greater than about 4 V/nm, greater than about 5 V/nm, or greater than about 10 V/nm. The device may have a field strength greater than about 1 V/nm only in areas of less than about 1 μm², alternatively the device may have a field strength greater than about 1 V/nm in volumes less than about 1 μm³, according to yet other aspects of the present invention the device may have a field strength greater than about 2 V/nm only in areas less than about 100 nm², and/or the device may have a field strength greater than about 2 V/nm only in volumes less than about 1,000 nm³. The high-field regions independently comprise voids or composite organic compounds forming nematic crystals, chematic crystals, chiral nematic crystals, lamellar structures, micelle structures, or any combination thereof.

In one embodiment of the present disclosure, the intramolecular or intermolecular rigid polarizable units are substantially evenly dispersed in a matrix formed by flexible electrically resistive substituents. The intramolecular or intermolecular rigid polarizable units may form a substantially crystalline lattice located in the matrix. The matrix may be comprised of alkyl chains, alkyne chains, polymers, crosslinked polymers, the crosslinked flexible electrically resistive substituents, fused poly-cycles and branched chains which may be cross-linked and fluorinated. The matrix electrically isolates the intramolecular and intermolecular rigid polarizable units and increases the metadielectric layer's mechanical elasticity during the compression and decompression that results from the application and removal of strong electric fields. The matrix which is formed by the flexible electrically resistive substituents listed above, promotes an increase in breakdown voltage of the disclosed solid state energy storage device. The matrix may further comprise a material having an electron effective mass greater than about 0.01 times the free electron mass. The metadielectric layer may additionally comprise a high breakdown material such as titanium oxide, lithium oxide, lithium fluoride, silicon oxide, silicon nitride, silicon oxynitride, magnesium oxide, praseodymium oxide, aluminum oxide, diamond, hafnium oxide, or any combination thereof. In some cases, the active layer comprises few defects, impurities, voids, inclusions, substitutional defects, stacking faults, lattice strain mismatches, or any combination thereof.

In another embodiment of disclosed solid state energy storage device, the matrix has a first permittivity under an applied electric field below a critical electric field (E_{q}) and a second permittivity under an applied electric field above Ec, wherein the first permittivity is lower than the second permittivity.

In yet another embodiment of the solid state energy storage device, the matrix further comprises an anti-ferroelectric material and cross-linked substituents attached to the rigid polarizable units of the organic compound which may have a permanent electric dipole moment.

In one embodiment of the solid state energy storage device, the matrix is flexible and compressible. In another embodiment of the disclosed solid state energy storage device, the matrix further comprises a material having an electron effective mass greater than about 0.1 times the free electron mass.

In yet another embodiment of the present disclosure, the solid state energy storage device further comprise at least one conductive layer located between first and second metadielectric layers, wherein the breakdown field (E_{bd}) of the device is at least 0.9 V/nm. In still another embodiment of the solid state energy storage device, a distribution of the intramolecular or intermolecular rigid polarizable units of the organic compound in the metadielectric layer at least partially compensates the electric field applied between electrodes.

In one embodiment of the solid state energy storage device, the mesogens in the metadielectric layer are electrically coupled together in (by) a positive feedback. In another embodiment of the disclosed solid state energy storage device, the mesogens are arranged in the metadielectric layer such that electrical coupling in the direction of the applied field is much stronger than electrical coupling in the directions perpendicular to the applied field.

In yet another embodiment of the solid state energy storage device, the metadielectric layer further comprises interfacial dipoles and/or has a polycrystalline structure, the crystallites which comprise the mesogen are either lyotropic liquid crystal phases and thermotropic liquid crystals. The crystallites may have the shape of a needle, sphere, disk, rod, parallelepiped and any combination thereof, and where the crystallites have an anisometric shape, they are elongated in the direction substantially perpendicular to planes of the conductive electrodes.

In still another embodiment of the present disclosure, the solid state energy storage device further comprise at least one tunnel barrier layer independently located between the metadielectric layer and at least one intermediate layer located near the one of electrode, wherein the permittivity of the tunnel barrier layer is lower than the permittivity of the intermediate layer, and the breakdown voltage of the tunnel barrier layer is higher than the breakdown voltage of the intermediate layer.

In another embodiment of the present disclosure, the solid state energy storage device further comprise at least two repeat units, where each repeat unit comprises at least one metadielectric layer, at least one tunnel barrier layer and at least one intermediate layer.

FIG. 1 schematically illustrates a solid state energy storage device 100, in accordance with an embodiment of the invention. The solid state energy storage device 100 includes a first electrically conductive electrode 105, an active layer 110, and a second electrically conductive electrode 115. The first and second electrodes 105 and 115 are formed of an electrically conductive (“conductive”) material. The active layer 110 can comprise at least one type of mesogen. The mesogen consists of at least one type of organic compound or polymer with at least one electrically resistive substituent and at least one polarizable unit. In another aspect of the invention, a solid state energy storage device having a plurality of active layers is provided. In another embodiment, the electrically conductive electrodes 105 and 115 can be formed of any metal, metallic or metal-containing material, such as one or more of Au, Pt, W, Al, Cu, Ag, Ti, Se, Ge, Pd, Ni, Co, Rh, Ir and Os.

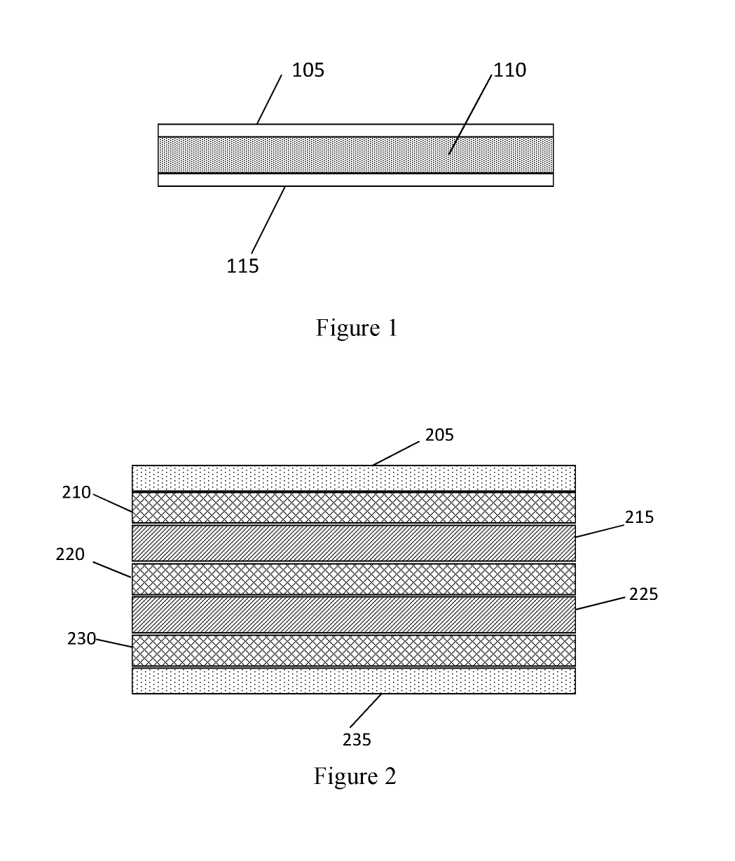

FIG. 2 schematically illustrates a solid state energy storage device 200, in accordance with another embodiment of the invention. The solid state energy storage device 200 includes a first electrically conductive electrode 205, a first intermediate layer of first type 210, a first active layer 215, a second intermediate layer of first type 220, a second active layer 225, a third intermediate layer of first type 230, and a second electrically conductive electrode 235. The intermediate layer of first type comprises a material that has a permittivity that is higher than the permittivity of the metadielectric active layers 215, 225 and smooths interfacial surfaces between the metadielectric layer and the conductive electrode. In an alternative embodiment, the first intermediate layer of the first type 210 can be omitted. In another embodiment, the second intermediate layer of the first type 220 can be omitted. In yet another embodiment, the third intermediate layer of the first type 230 can be omitted. In another embodiment, the first and second intermediate layers of the first type 210 and 220 can be omitted. In still another embodiment, the first and third intermediate layers of the first type 210 and 230 can be omitted. In another embodiment, the second and third intermediate layers of first type 220 and 230 can be omitted. In another embodiment, the electrically conductive electrodes 205 and 235 can be formed of any metal, metallic or metal-containing material, such as one or more of Au, Pt, W Al, Cu, Ag, Ti, Se, Ge, Pd, Ni, Co, Rh, Ir and Os.

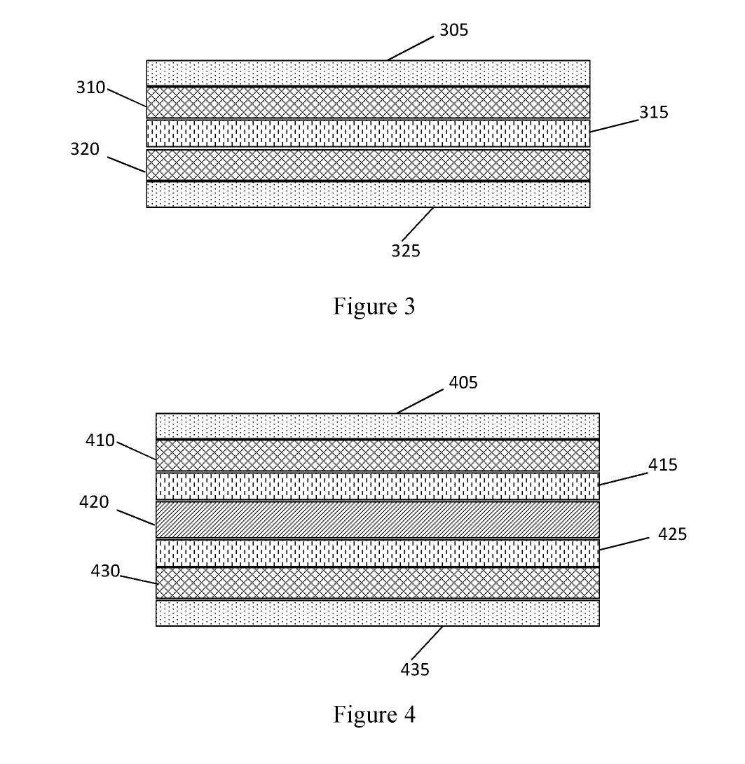

FIG. 3 schematically illustrates a solid state energy storage device 300, in accordance with yet another embodiment of the invention. The solid state energy storage device 300 includes a first electrically conductive electrode 305, a first active layer 310, an electrically conductive layer 315, a second active layer 320, and a second electrically conductive electrode 325. In another embodiment, the electrically conductive layers can be formed of any metal, metallic or metal-containing material, such as one or more of Au, Pt, W, Al, Cu, Ag, Ti, Se, Ge, Pd, Ni, Co, Rh, Ir and Os. In another embodiment, the electrically conductive layers can be formed of an organic semiconducting material, such as a doped organic semiconducting material. In another embodiment, the electrically conductive layers can be formed of carbon (e.g., ribtan, graphite), such as a carbon thin film.

In an embodiment, the plurality of electrically conductive layers can include between 2 and 10,000 electrically conductive layers. For example a typical coil capacitor consists of 2 electrically conductive layers. On the other hand in some embodiments the capacitor may be of the prismatic capacitor type which has as many as 2× the number of turns of a typical capacitor.

In an embodiment, the solid state energy storage device can include up to and including 10,000 metadielectric layers.

In an embodiment, the number of active layers (m) is one higher than the number of the electrically conductive layers (n), i.e., m−n+1. In another embodiment, the number of active layers is two higher than the number of the electrically conductive layers, i.e., m=n+2. In another embodiment, the number of active layers is three higher than the number of electrically conductive layers, i.e., m−n+3. In another embodiment, the number of active layers is four higher than the number of electrically conductive layers, i.e., m−n+4. In another embodiment, the number of active layers is five higher than the number of the electrically conductive layers, i.e., m=n+5. In general there may be up to 30 more active layers than conductive layers. In an embodiment, the electrically conductive layers and active layers are disposed one after another or sequentially. The additional active layers may be coextruded active layers having different permittivities and resistivity between the electrically conductive layers.

In an embodiment, each of the active layers can have a thickness between about 0.1 nm and 500 μm, or between about 0.3 nm and 300 μm. In another embodiment, each of the active layers can have a thickness that ranges from 0.1 nm to 500,000 nm, dependent upon the type and size of the device. In an embodiment, the active layers are of the same width (or thickness). In another embodiment, a thicker active layer is disposed in-between a plurality of thinner active layers. By way of example and not by way of limitation a sub nanometer layer may for a low resistance/high permittivity monolayer of molecules oriented parallel to a surface, whereas a 20-50 nm layer may be for a monolayer that is oriented perpendicular to a surface and 1000 to 50,000 nm layer may be for a stand-alone film having high energy density and moderate power density. In general thicker layers are appropriate for very high power devices without changes in the form factor of the final devices.

In an embodiment, each of the electrically conductive layers can have a thickness between about 0.35 nm and 500 μm. In another embodiment, each of the electrically conductive layers can have a thickness up to an including about 0.35 nm, or 0.4 nm, or 0.5 nm, or 0.6 nm, or 0.7 nm, or 0.8 nm, or 0.9 nm, or 1 nm, or 10 nm, or 20 nm, or 30 nm, or 40 nm, or 50 nm, or 100 nm, or 200 nm, or 300 nm, or 400 nm, or 500 nm, or 1,000 nm, or 5,000 nm, or 10,000 nm, or 50,000 nm, or 100,000 nm, or 200,000 nm, or 300,000 nm, or 500,000 nm. In an embodiment, the electrically conductive layers are of the same width (or thickness). In another embodiment, the electrically conductive layers have varying thicknesses. By way of example and not by way of limitation embodiments may include electrically conductive layers comprised of graphene monolayers which have a thickness of around 0.35 nm, other embodiments may have electrically conductive layers comprised of evaporated self-healing aluminum which has a thickness of around 2-5 nm and some other embodiments may have thin metal electrically conductive layers as small as 0.5 mm 500 μm.

FIG. 4 schematically illustrates a solid state energy storage device 400, in accordance with an embodiment of the invention. The solid state energy storage device 400 includes a first electrically conductive electrode 405, a first intermediate layer 410, a first tunnel barrier layer 415, an active layer 420, a second tunnel barrier layer 425, a second intermediate layer 430, and a second electrically conductive electrode 435. In an alternative embodiment, the first tunnel barrier layer of first type 415 can be omitted. In another embodiment, the second tunnel barrier layer of first type 425 can be omitted. The first tunnel barrier layers are made of wide-bandgap materials through which a transport (carrying over) of mobile carriers of a charges (electrons and holes) by means of tunneling is carried out. Exemplary tunnel barrier layers comprise, without limitation, silicon dioxide (SiO₂). Other exemplary tunnel barrier layer include monomolecular layer and comprised of amphiphilic molecules selected from the list consisting of amines (RNH₃⁺), carboxylates (RCO₂⁻), sulfates (RSO₄⁻), sulfonates (RSO₃⁻), phosphates (RHPO₄⁻), alcohols (ROH), thiols (RSH), where R is a carbon chain comprising more than ten CH₂— or CF₂— groups which may be interrupted by a heteroatom such as O, N, or S. In some embodiments the tunnel barrier layer is not less than 1 nm and is defined by the carbon chain length.

FIG. 9 schematically illustrates dependence of the charge (Q) accumulated on electrodes on the voltage (V) enclosed to the device (Q-V plot) for a standard material (B) and a material of the metadielectric layer having a permittivity that varies non-linearly with voltage (A).

With reference to FIG. 9, the total energy stored in an exemplary device can depend on, for example, (a) the maximum attainable voltage across the device electrodes, Vmax, (b) the charge stored on the device electrodes at this voltage, Qₘₐₓ and/or (c) the form of the Q-V curve for the device. Generally, the energy total stored in the device, E, is given by Equation (I):

E=∫₀^{Qmax}V(Q)dQ (I)

Without limitation, the energy stored in devices (and energy density) may be increased in at least the following three ways: increase of the breakdown voltage, increase of permittivity c of dielectric material of the metadielectric layer and increase of an area under the Q-V curve.

The maximum voltage Vₘₐₓ can be limited by the maximum voltage that can be sustained by a device, i.e., the breakdown voltage, V_{bd}. Devices designed to increase Vₘₐₓ can allow increased breakdown voltage, V_{bd}.

The maximum accumulated charge Qₘₐₓ can be equal to C₂*Vₘₐₓ, where C₂ is the capacitance of the device when it is in the Q-V state denoted by “A” in FIG. 9. The device capacitance at A is given by

C₂=εε₂Area/d

wherein ε is permittivity of free space and ε₂ is the permittivity of the dielectric material in state A, and ‘d’ is the distance between the electrodes. In some embodiments, C₂ can be increased by increasing permittivity ε₂ and/or by increasing the area and/or decreasing the thickness of the device. Changing geometric parameters of area and thickness may not change the energy density of the device, therefore described herein are devices that include dielectric material with increased permittivity.

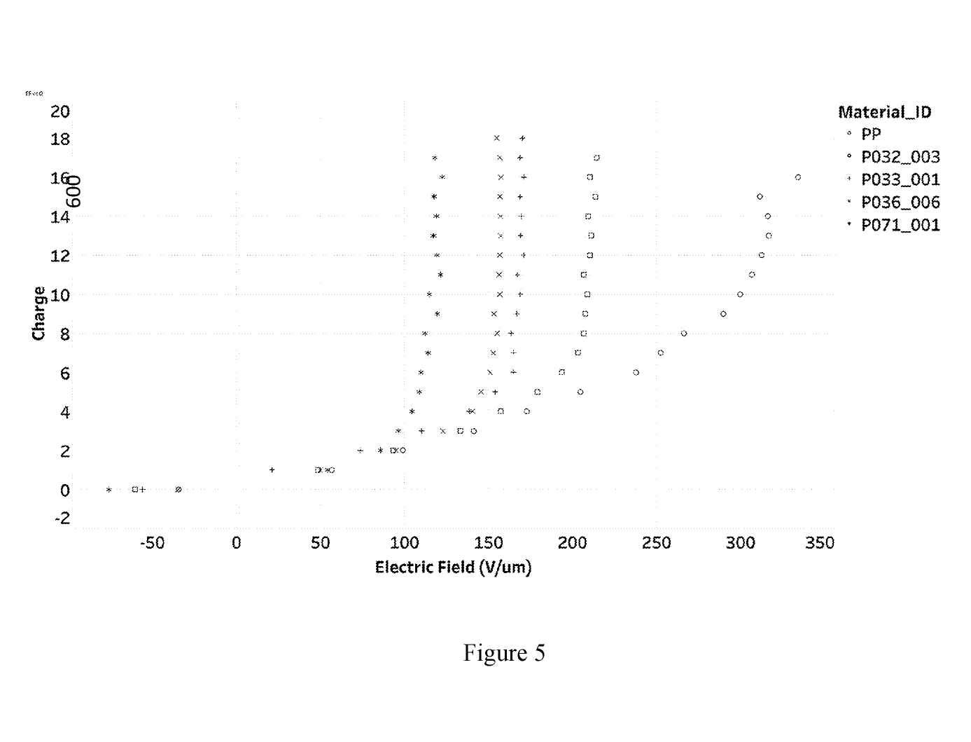

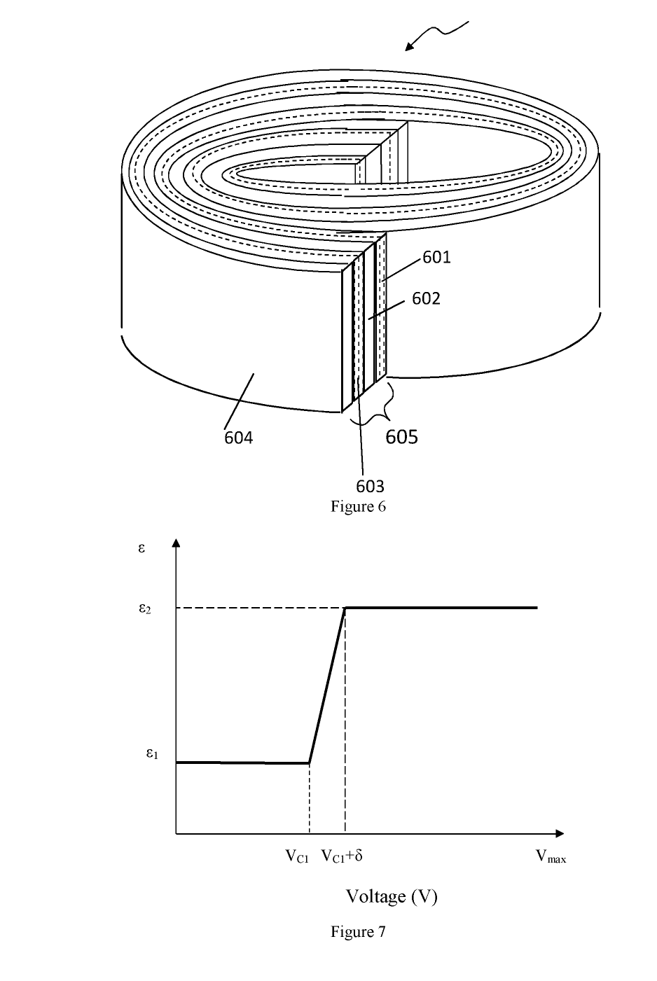

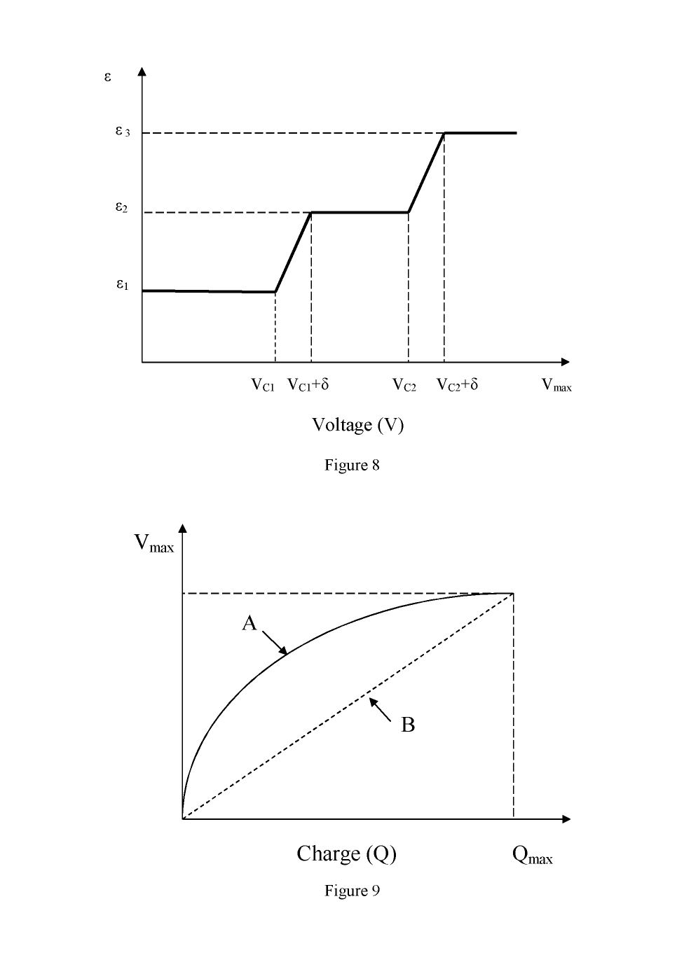

Generally, the energy stored in a device equals the area under the Q-V curve in a plot such as that shown in FIG. 9. For most materials the capacitance does not depend on Q (i.e., V(Q)=Q/C as indicated by dotted line “B” in FIG. 5) and the energy stored in the device is given by Equation (II):

E=½C*Vₘₐₓ² (II)

If C is dependent on Q, then the form of the curve in FIG. 9 may allow an increased stored energy up to C*Vₘₐₓ², which is two times the stored energy for most materials.

The area under the Q-V curve may be increased by including a dielectric material with non-linear dependence of permittivity on V. The aforementioned composite polarizable organic compounds or polarizable units are at least in part characterized by their non-linear polarizability as individual molecules/polymers or when forming supramolecular structures (e.g. Furuta co-polymer lamella supramolecular structures). The non-linear polarizable characteristics of these materials can effectively compensate the influence of an external electric field or applied voltage, which leads to increased charge (Q) accumulation on the electrodes of the solid state energy storage device.

In some instances, the active layer has a first permittivity (ε₁) below a critical voltage (Vc₁) and a second permittivity (ε₂) above the critical voltage. In general, the second permittivity (ε₂) is greater than the first permittivity (ε₁).

The first permittivity (ε₁) may be any suitable value between 1 and 100. In some embodiments, the first permittivity (ε₁) is about 1. In some embodiments, the first permittivity (ε₁) is less than about 1.

The second permittivity (ε₂) may be any suitable value between 1,000 and 100,000.

In an embodiment, the disclosed solid state energy storage device (ESD) is integrated into a transportation vehicle, such as a car, bus, motorcycle, motorized bicycle, scooter, boat, plane, robot, or charging station. In an embodiment, the ESD is integrated into an electric vehicle. In another embodiment, the ESD is integrated into the power system of a hybrid-electric vehicle. In another embodiment, the ESD is provided for use with a vehicle employing a fuel cell. In another embodiment, the ESD integrated into an aircraft. In another embodiment, the ESD is integrated into a boat. In an embodiment, the ESD is integrated into electric grid applications such as high frequency regulation, peak load shifting, and storage of electricity generated by renewable energy devices such as wind turbines, solar thermal generators, or photovoltaics. In an embodiment, the ESD is integrated into portable electronic devices such as laptops, notebooks, tablets, music players, DVD players, mobile phones, etc.

As noted above, the organic compound in the mesogen used in the metadielectic layer of an energy storage device according to aspects of the present disclosure may include electro-polarizable compounds, Sharp polymers, Furuta co-polymers, para-Furuta polymers, YanLi polymers or combinations thereof.

Sharp polymers are composites of a polarizable core inside an envelope of hydrocarbon (saturated and/or unsaturated), fluorocarbon, chlorocarbon, siloxane, and/or polyethylene glycol as linear or branched chain oligomers covalently bonded to the polarizable core that act to insulate the polarizable cores from each other, which favorably allows discrete polarization of the cores with limited or no dissipation of the polarization moments in the cores. The polarizable core has hyperelectronic, nonlinear, or ionic type polarizability. “Hyperelectronic polarization may be viewed as the electrical polarization in external fields due to the pliant interaction with the charge pairs of excitons, in which the charges are molecularly separated and range over molecularly limited domains.” (See Roger D. Hartman and Herbert A. Pohl, “Hyper-electronic Polarization in Macromolecular Solids”, Journal of Polymer Science: Part A-1 Vol. 6, pp. 1135-1152 (1968)). Ionic type polarization can be achieved by limited mobility of ionic parts of the core molecular fragment.

An electro-polarizable compound has a general structural formula:

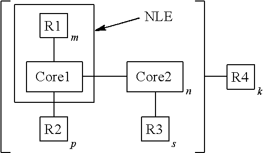

Where Core1 is an aromatic polycyclic conjugated molecule having two-dimensional flat form and self-assembling by pi-pi stacking in a column-like supramolecule, R1 is a dopant group connected to the aromatic polycyclic conjugated molecule (Core1), m is the number of dopant groups R1 which is equal to 1, 2, 3 or 4, R2 is a substituent comprising one or more ionic groups from a class of ionic compounds that are used in ionic liquids connected to the aromatic polycyclic conjugated molecule (Core1) directly or via a connecting group, p is number of ionic groups R2 which is equal to 0, 1, 2, 3 or 4. The fragment marked NLE containing the aromatic polycyclic conjugated molecule with at least one dopant of group has nonlinear effect of polarization. The Core2 is an electro-conductive oligomer self-assembling by pi-pi stacking in a column-like supramolecule, n is number of the electro-conductive oligomers which is equal to 0, 2, or 4, R3 is a substituent comprising one or more ionic groups from a class of ionic compounds that are used in ionic liquids connected to the electro-conductive oligomer (Core2) directly or via a connecting group, s is number of the ionic groups R3 which is equal to 0, 1, 2, 3 or 4. The R4 is a resistive substituent providing solubility of the organic compound in a solvent and electrically insulating the column-like supramolecules from each other, k is the number of R4 substituents, on said electro-polarizable compound, which is equal to 0, 1, 2, 3, 4, 5, 6, 7 or 8.

In one embodiment of the present disclosure, the aromatic polycyclic conjugated molecule (Core1) comprises rylene fragments.

### Example 1

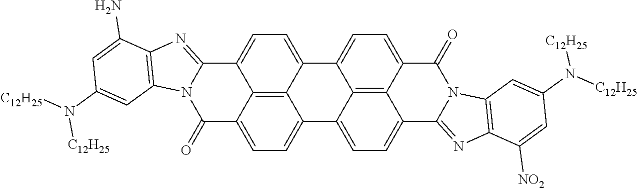

### Procedure:

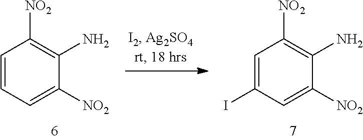 [SMILES: Nc1c([N+](=O)[O-])cccc1[N+](=O)[O-] ; Nc1c([N+](=O)[O-])cc(I)cc1[N+](=O)[O-]]

To EtOH (40.0 mL) was added compound 6 (4.2 g, 23.0 mmol, 1.0 equiv.), AgSO₄ (10.0 g, 32.1 mmol, 1.4 equiv.) and I₂ (8.2 g, 32.1 mmol, 1.4 equiv.). The mixture was stirred at room temperature for 18 hrs. The solid was filtered off and washed with EA. The filtrate was concentrated. The residue was separated through a column to afford compound 7 5.4 g (77%) as a dark yellow solid. ¹H NMR (300 MHz, CDCl₃) not available.

Scale up: To EtOH (1000.0 mL) was added compound 6 (100.0 g, 547.6 mmol, 1.0 equiv.), AgSO₄ (238.0 g, 764.3 mmol, 1.4 equiv.) and I₂ (195.2 g, 764.3 mmol, 1.4 equiv.). The mixture was stirred at room temperature for 18 hours. The solid was filtered off and washed with EA (200 mL×2). The filtrate was concentrated until ⅓ of the filtrate volume remained. The solid was filtered and washed by cold EtOH (100 mL×2) to provide compound 7 43 g as dark yellow solid with less than 5% starting material 6 inside. The filtrate was concentrated and the above-described procedure was repeated with 0.7 equiv. of AgSO₄ and I₂. The same working up process was applied to provided second batch of compound 7 30 g as dark yellow solid with less than 5% starting material 6 inside. The solids were combined to afford compound 7 73 g (43.4%). ¹H NMR (300 MHz, CDCl₃) not available. Reaction was tracked by TLC.

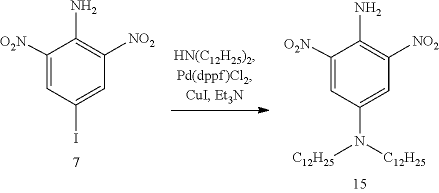

To anhydrous THF (10.0 mL) and TEA (10.0 mL) was added compound didodecylamine (1.2 equiv.), compound 7 (1.0 equiv.), Pd(dppf)Cl₂ (0.02 equiv.), CuI (0.04 equiv.). The mixture was degassed under vacuum and purged with N₂ three times. The reaction was stirred at 70° C. for 8.0 hrs. The mixture was cooled down and EA (10 mL) was added to dilute. The solid was filtered off and the filtrate was concentrated, then separated with a column to afford compound 15.

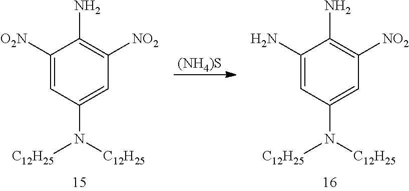

To EtOH (20.0 mL) was added compound 15 (7.5 g, 14.1 mmol, 1.0 equiv.) and ammonium sulfide (8.6 g 20% water solution, 28.2 mmol, 2.0 equiv.). The mixture was stirred at 80° C. for 1 hour. 2.0 equivalents of ammonium sulfide were added again. The mixture was stirred 80° C. for an additional 1 hour. The mixture was concentrated, diluted with EA, washed with water and brine. The organic phase was collected, concentrated and separated through a column to give product 16.

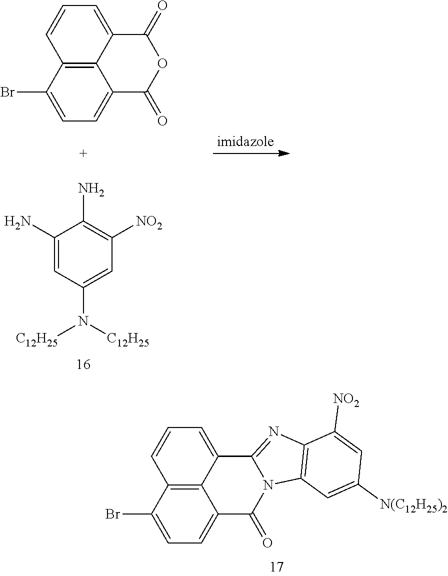

To a 25 mL flask was added compound 16 (1 equiv.), 4-bromo-1,8-naphthalic anhydride (1 equiv.) and imidazole (70 equiv.). The mixture was degassed under vacuum and purged with N₂ three times. The reaction was stirred at 130° C. for 3 hours and 180° C. for 12 more hours. The dark purple mixture was cooled down. The solid was washed with water (3×60 mL) and EtOH (3×60 mL), and vacuum dried to give 17.

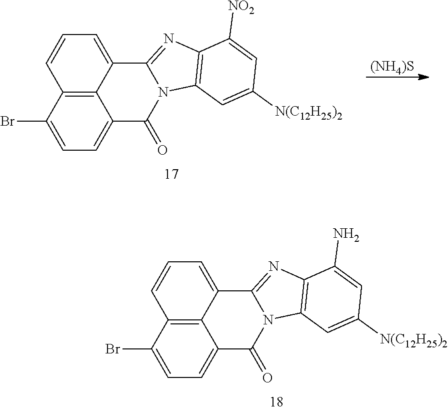

To EtOH (20.0 mL) was added compound 17 (1.0 equiv.) and ammonium sulfide (2.0 equiv.). The mixture was stirred at 80° C. for 1 hour. Refilled 2.0 equiv. ammonium sulfide. The mixture was stirred at 80° C. for an additional 1 hour. The mixture was concentrated, diluted with EA, washed with water and brine, and dried to give 18.

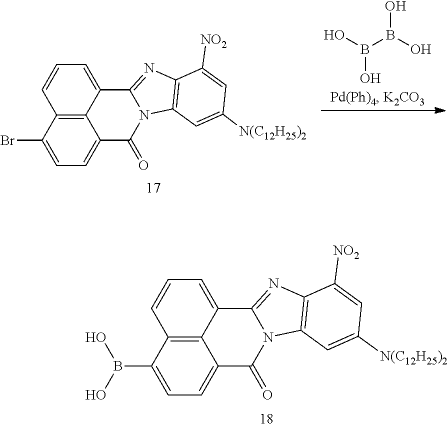

A deaerated mixture of 17 (2.0 mmol), boronic acid dimer (2.0 mmol), and Pd(Ph)₄ (4·10-2 mmol) in aq. Na2CO3 (1.4 M, 15 ml) was held at 65° C. for 9 hours. Thereafter, the reaction mixture was cooled and extracted with chloroform (3×15 ml). The organic phase was dried over anhydrous MgSO4 and concentrated in vacuo to give 18.

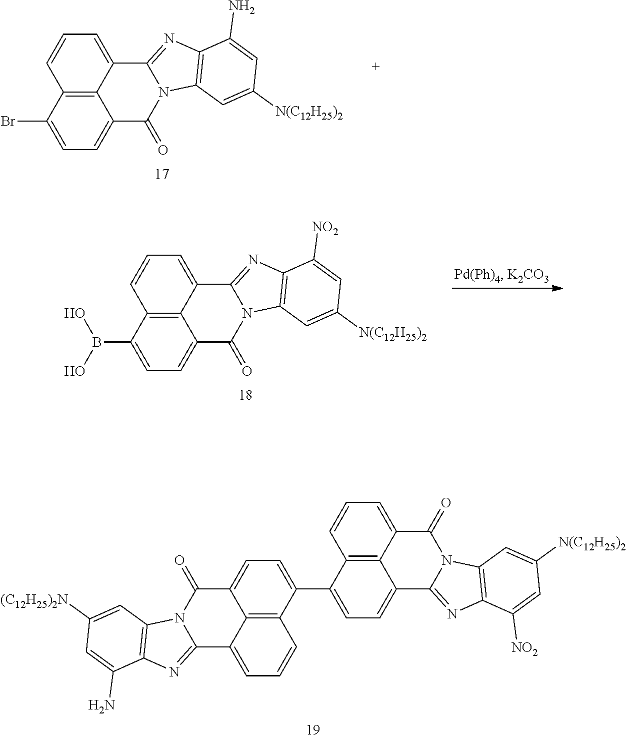

A deaerated mixture of 17 (2.0 mmol), 18 (2.0 mmol), and Pd(Ph)₄ (4·10-2 mmol) in aq. Na2CO3 (1.4 M, 15 ml) was held at 65° C. for 9 hours. Thereafter, the reaction mixture was cooled and extracted with chloroform (3×15 ml). The organic phase was dried over anhydrous MgSO4 and concentrated in vacuo to give 19.

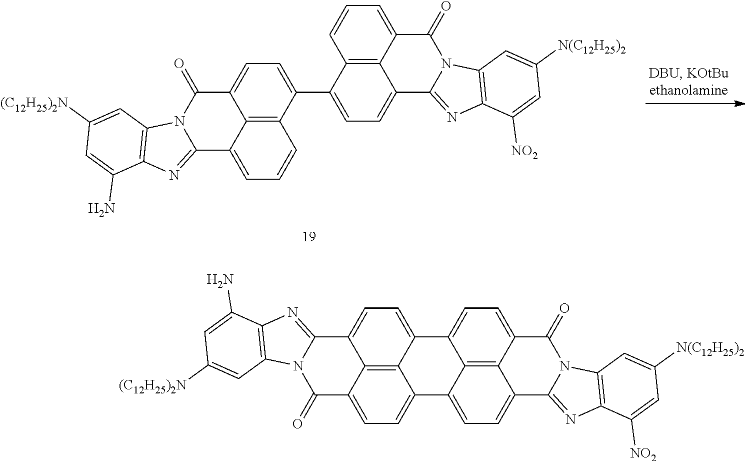

A mixture of 1.48 g (13 mmol) potassium tert-butoxide 2.30 g (15.1 mmol) of diazabicyclo[5.4.0]undec-7-ene (DBU), 2.2 g 36.3 mmol) ethanolamine and 1.0 g of 19 was heated to 140° C. for 11 hours. Afterwards, the same amount of potassium tert-butylat, DBU and ethanolamine were added and the mixture was kept at 140° C. for 18 hours. The reaction mixture was cooled to room temperature, poured into 250 ml of 1M HCl, filtered, washed until neutral pH and then dried to give the final product.

A Sharp polymer has a general structural formula:

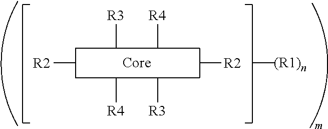

Where Core is an aromatic polycyclic conjugated molecule comprising rylene fragments. This molecule has flat anisometric form and self-assembles by pi-pi stacking in a column-like supramolecule. The substitute R1 provides solubility of the organic compound in a solvent. The parameter n is number of substitutes R1, which is equal to 0, 1, 2, 3, 4, 5, 6, 7 or 8. The substitute R2 is an electrically resistive substitute located in terminal positions, which provides resistivity to electric current and comprises hydrocarbon (saturated and/or unsaturated), fluorocarbon, siloxane, and/or polyethyleneglycol as linear or branched chains. The substitutes R3 and R4 are substitutes located on side (lateral) positions (terminal and/or bay positions) comprising one or more ionic groups from a class of ionic compounds that are used in ionic liquids connected to the aromatic polycyclic conjugated molecule (Core), either directly, e.g., with direct bound SP2-SP3 carbons, or via a connecting group. The parameter m is a number of the aromatic polycyclic conjugated molecules in the column-like supramolecule, which is in a range from 3 to 100,000.

In another embodiment of the composite organic compound, the aromatic polycyclic conjugated molecule comprises an electro-conductive oligomer, such as a phenylene, thiophene, or polyacene quinine radical oligomer or combinations of two or more of these. In yet another embodiment of the composite organic compound, the electro-conductive oligomer is selected from phenylene, thiophene, or substituted and/or unsubstituted polyacene quinine radical oligomer of lengths ranging from 2 to 12 or combination of two or more of these. Wherein the substitutions of ring hydrogens by O, S or NR5, and R5 is selected from the group consisting of unsubstituted or substituted C₁-C₁₈alkyl, unsubstituted or substituted C₂-C₁₈alkenyl, unsubstituted or substituted C₂-C₁₈alkynyl, and unsubstituted or substituted C₄-C₁₈ aryl.

In some embodiments, the substitute providing solubility (R1) of the composite organic compound is C_{X}Q_{2X+1}, where X≥1 and Q is hydrogen (H), fluorine (F), or chlorine (Cl). In still another embodiment of the composite organic compound, the substitute providing solubility (R1) of the composite organic compound is independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tert-butyl groups, and the aryl group is selected from phenyl, benzyl and naphthyl groups or siloxane, and/or polyethylene glycol as linear or branched chains.

In some embodiments, at least one electrically resistive substitute (R2) of the composite organic compound is C_{X}Q_{2X+1}, where X≥1 and Q is hydrogen (H), fluorine (F), or chlorine (Cl). In another embodiment of the composite organic compound, at least one electrically resistive substitute (R2) is selected from the list comprising —(CH₂)ₙ—CH₃, —CH((CH₂)ₙCH₃)₂) (where n≥1), alkyl, aryl, substituted alkyl, substituted aryl, branched alkyl, branched aryl, and any combination thereof and wherein the alkyl group is selected from methyl, ethyl, propyl, butyl, iso-butyl and tert-butyl groups, and the aryl group is selected from phenyl, benzyl and naphthyl groups. In yet another embodiment of the composite organic compound.

In some embodiments, the substitute R1 and/or R2 is connected to the aromatic polycyclic conjugated molecule (Core) via at least one connecting group. The at least one connecting group may be selected from the list comprising the following structures: ether, amine, ester, amide, substituted amide, alkenyl, alkynyl, sulfonyl, sulfonate, sulfonamide, or substituted sulfonamide.

In some embodiments, the substitute R3 and/or R4 may be connected to the aromatic polycyclic conjugated molecule (Core) via at least one connecting group. The at least one connecting group may be selected from the list comprising CH₂, CF₂, SiR₂O, CH₂CH₂O, wherein R is selected from the list comprising H, alkyl, and fluorine. In another embodiment of the composite organic compound, the one or more ionic groups include at least one ionic group selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine.

In some implementations, the aromatic polycyclic conjugated molecule (Core) comprises rylene fragments. In another embodiment of the composite organic compound, the rylene fragments are selected from structures 1 to 21 as given in Table 1.

TABLE 1
Examples of the polycyclic organic molecule (Core) comprising rylene fragments

| | |
|---|---|
| 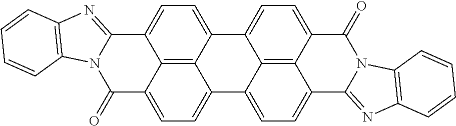 [SMILES: O=c1c2ccc3c4ccc5c6c(ccc(c7ccc(c2c37)c2nc3ccccc3n12)c46)c(=O)n1c2ccccc2nc51] | 1 |
| 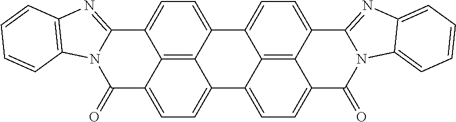 [SMILES: O=c1c2ccc3c4ccc5c(=O)n6c7ccccc7nc6c6ccc(c7ccc(c2c37)c2nc3ccccc3n12)c4c56] | 2 |
| 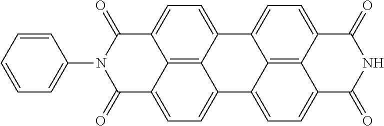 [SMILES: O=C1NC(=O)c2ccc3c4ccc5c6c(ccc(c7ccc1c2c73)c64)C(=O)N(c1ccccc1)C5=O] | 3 |
| 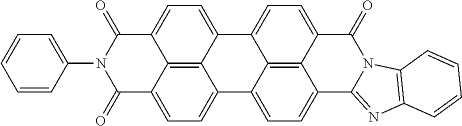 [SMILES: O=C1c2ccc3c4ccc5c(=O)n6c7ccccc7nc6c6ccc(c7ccc(c2c37)C(=O)N1c1ccccc1)c4c56] | 4 |
| 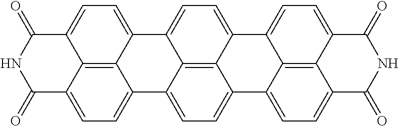 [SMILES: O=C1NC(=O)c2ccc3c4ccc5c6ccc7c8c(ccc(c9ccc(c%10ccc1c2c%103)c4c95)c86)C(=O)NC7=O] | 5 |
| 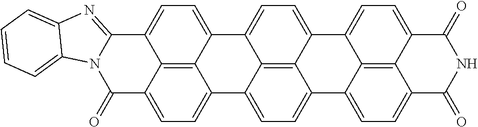 [SMILES: O=C1NC(=O)c2ccc3c4ccc5c6ccc7c8c(ccc(c9ccc(c%10ccc1c2c%103)c4c95)c68)c(=O)n1c2ccccc2nc71] | 6 |
| 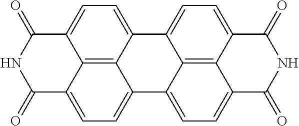 [SMILES: O=C1NC(=O)c2ccc3c4ccc5c6c(ccc(c7ccc1c2c73)c64)C(=O)NC5=O] | 7 |
| 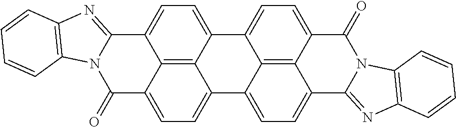 [SMILES: O=c1c2ccc3c4ccc5c6c(ccc(c7ccc(c2c37)c2nc3ccccc3n12)c46)c(=O)n1c2ccccc2nc51] | 8 |
| 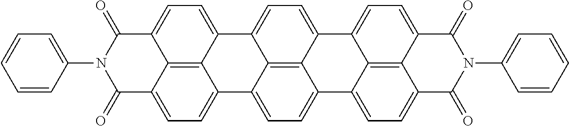 [SMILES: O=C1c2ccc3c4ccc5c6ccc7c8c(ccc(c9ccc(c%10ccc(c2c3%10)C(=O)N1c1ccccc1)c4c59)c86)C(=O)N(c1ccccc1)C7=O] | 9 |
| 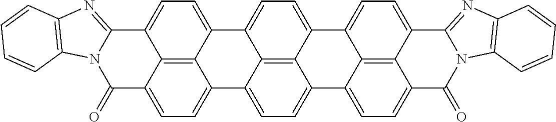 [SMILES: O=c1c2ccc3c4ccc5c6ccc7c(=O)n8c9ccccc9nc8c8ccc(c9ccc(c%10ccc(c2c3%10)c2nc3ccccc3n12)c4c59)c6c78] | 10 |
| 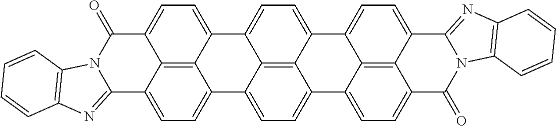 [SMILES: O=c1c2ccc3c4ccc5c6ccc7c8c(ccc(c9ccc(c%10ccc(c2c3%10)c2nc3ccccc3n12)c4c95)c68)c(=O)n1c2ccccc2nc71] | 11 |
| 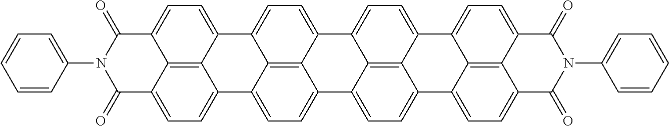 [SMILES: O=C1c2ccc3c4ccc5c6ccc7c8ccc9c%10c(ccc(c%11ccc(c%12ccc(c%13ccc(c2c3%13)C(=O)N1c1ccccc1)c4c5%12)c6c7%11)c%108)C(=O)N(c1ccccc1)C9=O] | 12 |
| 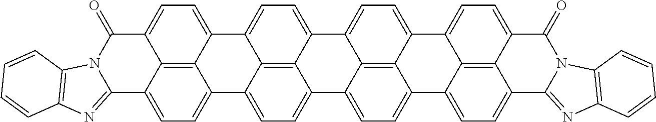 [SMILES: O=c1c2ccc3c4ccc5c6ccc7c8ccc9c(=O)n%10c%11ccccc%11nc%10c%10ccc(c%11ccc(c%12ccc(c%13ccc(c2c3%13)c2nc3ccccc3n12)c4c5%12)c6c7%11)c8c9%10] | 13 |
| 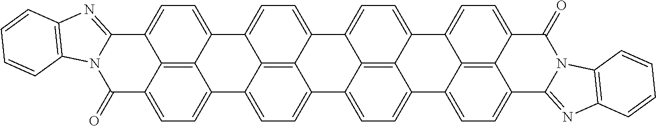 [SMILES: O=c1c2ccc3c4ccc5c6ccc7c8ccc9c%10c(ccc(c%11ccc(c%12ccc(c%13ccc(c2c3%13)c2nc3ccccc3n12)c4c5%12)c6c%117)c8%10)c(=O)n1c2ccccc2nc91] | 14 |
| 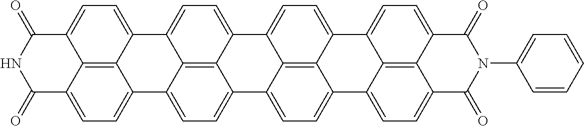 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)N(c1ccccc1)C9=O] | 15 |
| 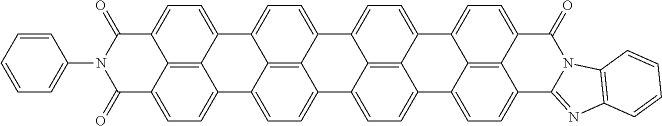 [SMILES: O=C1c2ccc3c4ccc5c6ccc7c8ccc9c(=O)n%10c%11ccccc%11nc%10c%10ccc(c%11ccc(c%12ccc(c%13ccc(c2c3%13)C(=O)N1c1ccccc1)c4c5%12)c6c7%11)c8c9%10] | 16 |
| 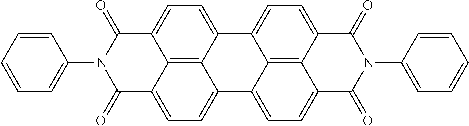 [SMILES: O=C1c2ccc3c4ccc5c6c(ccc(c7ccc(c2c37)C(=O)N1c1ccccc1)c64)C(=O)N(c1ccccc1)C5=O] | 17 |
| 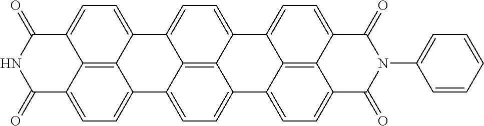 [SMILES: O=C1NC(=O)c2ccc3c4ccc5c6ccc7c8c(ccc(c9ccc(c%10ccc1c2c%103)c4c95)c86)C(=O)N(c1ccccc1)C7=O] | 18 |
| 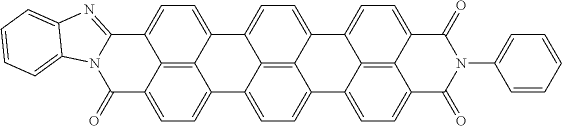 [SMILES: O=C1c2ccc3c4ccc5c6ccc7c(=O)n8c9ccccc9nc8c8ccc(c9ccc(c%10ccc(c2c3%10)C(=O)N1c1ccccc1)c4c59)c6c78] | 19 |
| 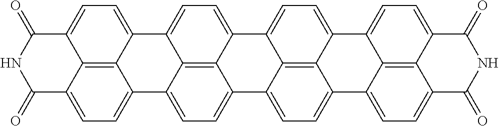 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)NC9=O] | 20 |
| 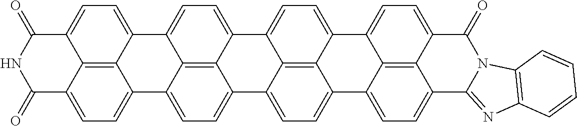 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c8%10)c(=O)n1c2ccccc2nc91] | 21 |

In other implementations, the aromatic polycyclic conjugated molecule comprises an electro-conductive oligomer, such as a phenylene, thiophene, or polyacene quinine radical oligomer or combinations of two or more of these. In yet another embodiment of the composite organic compound, the electro-conductive oligomer is selected from structures 22 to 30 as given in Table 2, wherein I=2, 3, 4, 5, 6, 7, 8, 9, 10, 11 or 12, Z is ═O, ═S or ═NR5, and R5 is selected from the group consisting of unsubstituted or substituted C₁-C₁₈alkyl, unsubstituted or substituted C₂-C₁₈alkenyl, unsubstituted or substituted C₂-C₁₈alkynyl, and unsubstituted or substituted C₄-C₁₈aryl:

TABLE 2
Examples of the polycyclic organic molecule (Core)
comprising electro-conductive oligomer

| | |
|---|---|
| 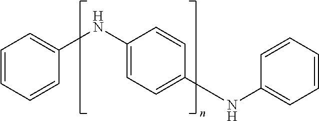 | 22 |
| 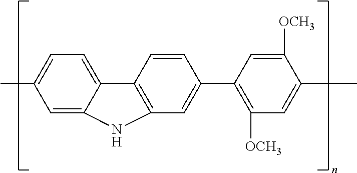 | 23 |
| 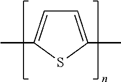 | 24 |
| 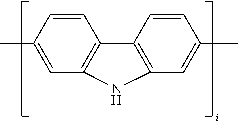 | 25 |
| 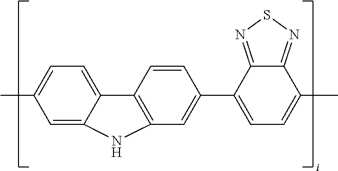 | 26 |
| 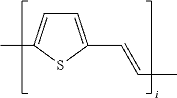 | 27 |
| 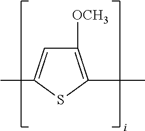 | 28 |
| 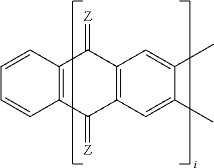 | 29 |
| 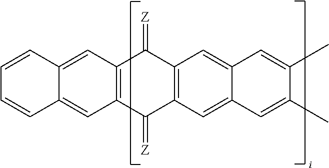 | 30 |

In some implementations, the substitute providing solubility (R1) of the composite organic compound is C_{X}Q_{2X+1}, where i≥1 and Q is hydrogen (H), fluorine (F), or chlorine (Cl). In still another embodiment of the composite organic compound, the substitute providing solubility (R1) of the composite organic compound is independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tert-butyl groups, and the aryl group is selected from phenyl, benzyl and naphthyl groups or siloxane, and/or polyethyleneglycol as linear or branched chains.

In one embodiment of the composite organic compound, the solvent is selected from benzene, toluene, xylenes, acetone, acetic acid, methylethylketone, hydrocarbons, chloroform, carbontetrachloride, methylenechloride, dichlorethane, chlorobenzene, alcohols, nitromethan, acetonitrile, dimethylforamide, 1,4-dioxane, tetrahydrofuran (THF), methylcyclohexane (MCH), and any combination thereof.

In some embodiments, at least one electrically resistive substitute (R2) of the composite organic compound is C_{X}Q_{2X+1}, where i≥1 and Q is hydrogen (H), fluorine (F), or chlorine (Cl). In another embodiment of the composite organic compound, at least one electrically resistive substitute (R2) is selected from the list comprising —(CH₂)ₙ—CH₃, —CH((CH₂)ₙCH₃)₂) (where n≥1), alkyl, aryl, substituted alkyl, substituted aryl, branched alkyl, branched aryl, and any combination thereof and wherein the alkyl group is selected from methyl, ethyl, propyl, butyl, iso-butyl and tert-butyl groups, and the aryl group is selected from phenyl, benzyl and naphthyl groups. In yet another embodiment of the composite organic compound.

In some embodiments, at least one electrically resistive substitute (R2) is selected from the group of alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, n-butyl, iso-butyl and tert-butyl groups, and the aryl group is selected from phenyl, benzyl and naphthyl groups or siloxane, and/or polyethyleneglycol as linear or branched chains.

In some embodiments, the substitute R1 and/or R2 is connected to the aromatic polycyclic conjugated molecule (Core) via at least one connecting group. The at least one connecting group may be selected from the list comprising the following structures: 31-41 as given in Table 3, where W is hydrogen (H) or an alkyl group.

TABLE 3
Examples of the connecting group

| | |
|---|---|
| 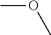 | 31 |
| 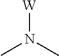 | 32 |
| 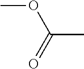 | 33 |
| 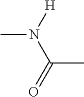 | 34 |
| 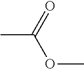 | 35 |
| 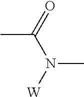 | 36 |
| 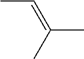 | 37 |
| 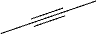 | 38 |
| 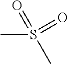 | 39 |
| 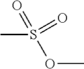 | 40 |
| 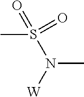 | 41 |

In some embodiments, the substitute R3 and/or R4 may be connected to the aromatic polycyclic conjugated molecule (Core) via at least one connecting group. The at least one connecting group may be selected from the list comprising CH₂, CF₂, SiR₂O, CH₂CH₂O, wherein R is selected from the list comprising H, alkyl, and fluorine. In another embodiment of the composite organic compound, the one or more ionic groups include at least one ionic group selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine.

Sharp polymers have hyperelectronic or ionic type polarizability. “Hyperelectronic polarization may be considered due to the pliant interaction of charge pairs of excitons, localized temporarily on long, highly polarizable molecules, with an external electric field (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

In some implementations, the metadielectric may include one or more Sharp polymers in the form of a composite organic compound characterized by polarizability and resistivity having the above general structural formula.

Further, characteristics of metadielectrics include a relative permittivity greater than or equal to 1,000 and resistivity greater than or equal to 10¹⁶ ohm/cm. Individually, the Sharp Polymers in a metadielectric may form column like supramolecular structures by pi-pi interaction. Said supramolecules of Sharp polymers allow formation of crystal structures of the metadielectric material. By way of using Sharp polymers in a dielectric material, polarization units are incorporated to provide the molecular material with high dielectric permeability. There are several mechanisms of polarization such as dipole polarization, ionic polarization, and hyper-electronic polarization of molecules, monomers and polymers possessing metal conductivity. All polarization units with the listed types of polarization may be used in aspects of the present disclosure. Further, Sharp polymers are composite materials which incorporate an envelope of insulating substituent groups that electrically isolate the supramolecules from each other in the dielectric crystal layer and provide high breakdown voltage of the energy storage molecular material. Said insulating substituent groups are resistive alkyl or fluro-alkyl chains covalently bonded to a polarizable core, forming the resistive envelope.

In order that the invention may be more readily understood, reference is made to the following examples, which are intended to be illustrative of the invention, but are not intended to be limiting the scope.

### Example 2

This Example describes synthesis of one type of Sharp polymer according following structural scheme:

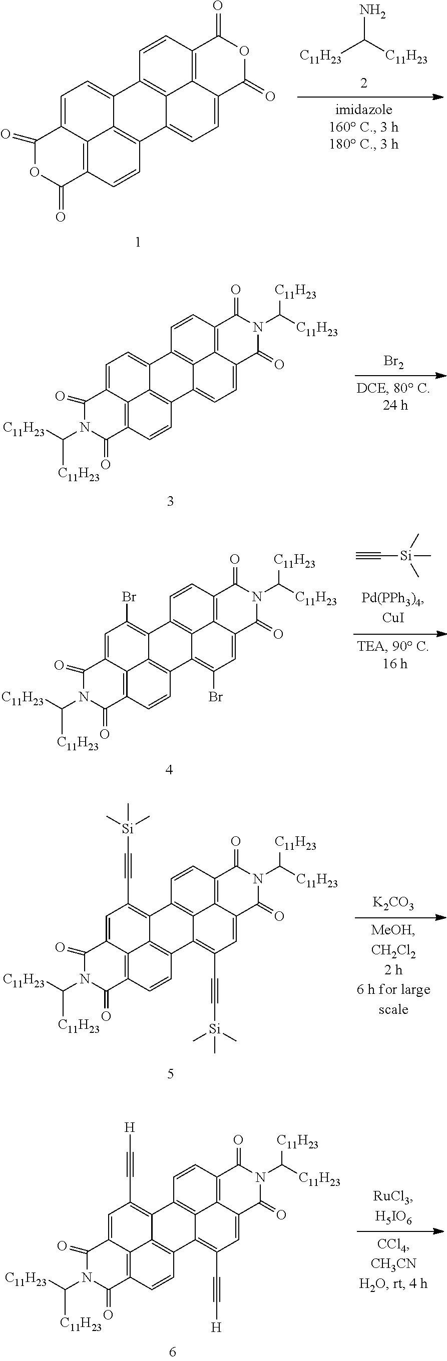

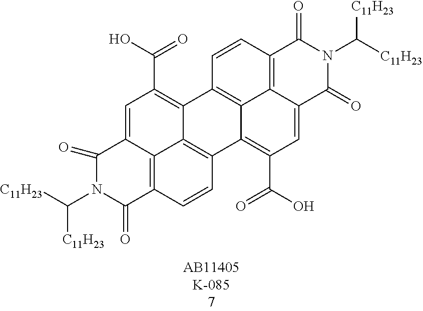

The process involved in the synthesis in this example may be understood in terms of the following five steps.

### a) First Step:

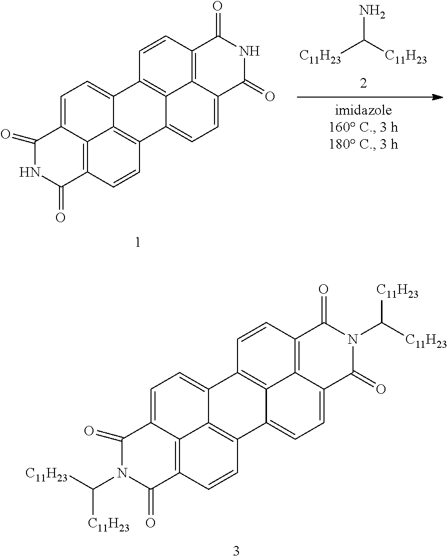

Anhydride 1 (60.0 g, 0.15 mol, 1.0 eq), amine 2 (114.4 g, 0.34 mol, 2.2 eq) and imidazole (686.0 g, 10.2 mol, 30 eq to 2) were mixed well into a 500 mL of round-bottom flask equipped with a bump-guarder. The mixture was degassed three times, stirred at 160° C. for 3 hr, 180° C. for 3 hr, and cooled to rt. The reaction mixture was crushed into water (1000 mL) with stirring. Precipitate was collected with filtration, washed with water (2×500 mL), methanol (2×300 mL) and dried on high vacuum. The crude product was purified by flash chromatography column (CH₂Cl₂/hexane=1/1) to give 77.2 g (48.7%) of the desired product 3 as an orange solid. ¹H NMR (300 MHz, CDCl₃) δ 8.65-8.59 (m, 8H), 5.20-5.16 (m, 2H), 2.29-2.22 (m, 4H), 1.88-1.82 (m, 4H), 1.40-1.13 (m, 64H), 0.88-0.81 (t, 12H). Rf=0.68 (CH₂Cl₂/hexane=1/1).

### b) Second Step:

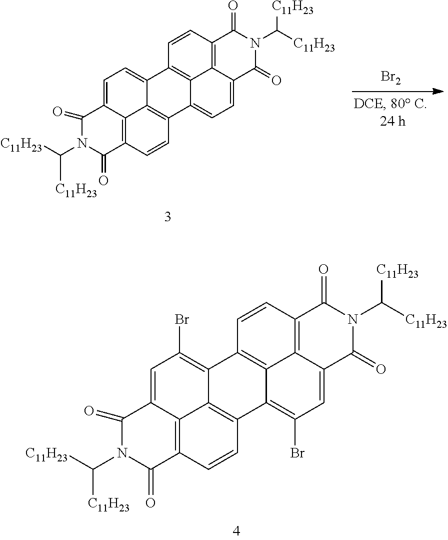

To a solution of the diimide 3 (30.0 g, 29.0 mmol, 1.0 eq) in dichloroethane (1500 mL) was added bromine (312.0 g, 1.95 mol, 67.3 eq). The resulting mixture was stirred at 80° C. for 36 hr, cooled, washed with 10% NaOH (aq, 2×1000 mL), water (100 ml), dried over Na₂SO₄, filtered and concentrated. The crude product was purified by flash chromatography column (CH₂Cl₂/hexanes=1/1) to give 34.0 g (98.2%) of the desired product 4 as a red solid. ¹H NMR (300 MHz, CDCl₃) δ 9.52 (d, 2H), 8.91 (bs, 2H), 8.68 (bs, 2H), 5.21-5.13 (m, 2H), 2.31-2.18 (m, 4H), 1.90-1.80 (m, 4H), 1.40-1.14 (m, 64H), 0.88-0.81 (t, 12H). Rf=0.52 (CH₂Cl₂/hexanes=1/1).

### c) Third Step

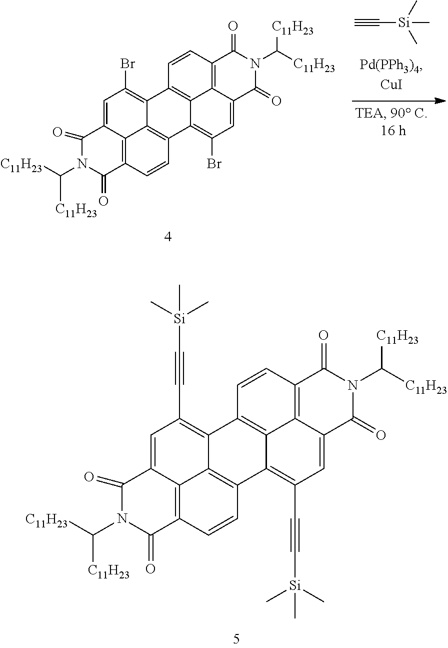

To a solution of the di-bromide 4 (2.0 g, 1.68 mmol, 1.0 eq) in triethylamine (84.0 mL) was added CuI (9.0 mg, 0.048 mmol, 2.8 mol %) and (trimethylsilyl)acetylene (80.49 g, 5.0 mmol, 3.0 eq). The mixture was degassed three times. Catalyst Pd(PPh₃)₄ (98.0 mg, 0.085 mmol, 5.0 mol %) was added. The mixture was degassed three times, stirred at 90° C. for 24 hr, cooled, passed through a pad of Celite, and concentrated. The crude product was purified by flash chromatography column (CH₂Cl₂/hexane=1/1) to give 1.8 g (87.2%) of the desired product 5 as a dark-red solid. ¹H NMR (300 MHz, CDCl₃) δ 10.24-10.19 (m, 2H), 8.81 (bs, 2H), 8.65 (bs, 2H), 5.20-5.16 (m, 2H), 2.31-2.23 (m, 4H), 1.90-1.78 (m, 4H), 1.40-1.15 (m, 72H), 0.84-0.81 (t, 12H), 0.40 (s, 18H). Rf=0.72 (CH₂Cl₂/hexane=1/1).

### d) Fourth Step

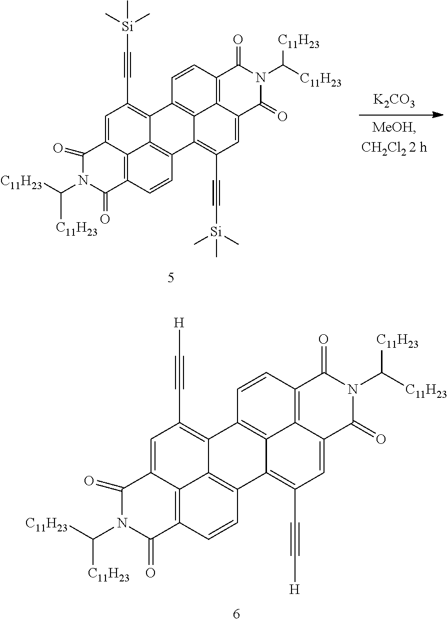

To a solution of diimide 5 (1.8 g, 1.5 mmol, 1.0 eq) in a mixture of MeOH/DCM (40.0 mL/40.0 mL) was added K₂CO₃ (0.81 g, 6.0 mmol, 4.0 eq). The mixture was stirred at room temperature for 1.5 hr, diluted with DCM (40.0 mL), washed with water, brine, dried over Na₂SO₄, filtered and concentrated. The crude product was purified by flash chromatography column (CH₂Cl₂) to give 1.4 g (86.1%) of the desired product 6 as a dark-red solid. ¹H NMR (300 MHz, CDCl₃) δ 10.04-10.00 (m, 2H), 8.88-8.78 (m, 2H), 8.72-8.60 (m, 2H), 5.19-5.14 (m, 2H), 3.82-3.80 (m, 2H), 2.31-2.23 (m, 4H), 1.90-1.78 (m, 4H), 1.40-1.05 (m, 72H), 0.85-0.41 (t, 12H). Rf=0.62 (CH₂Cl₂).

### e) Fifth Step

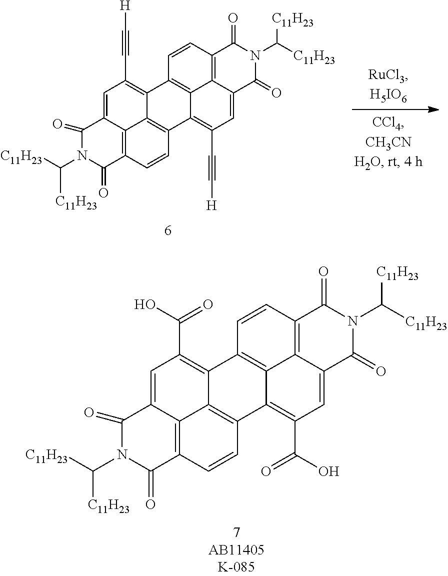

To a suspension of alkyne 6 (1.4 g, 1.3 mmol, 1.0 eq) in a mixture of CCl₄/CH₃CN/H₂O (6 mL/6 mL/12 mL) was added periodic acid (2.94 g, 12.9 mmol, 10.0 eq) and RuCl₃ (28.0 mg, 0.13 mmol, 10 mol %). The mixture was stirred at room temperature under nitrogen for 4 hours, diluted with DCM (50 mL), washed with water, brine, dried over Na₂SO₄, filtered and concentrated. The crude product was purified by flash chromatography column (10% MeOH/CH₂Cl₂) to give 1.0 g (68.5%) of the desired product 7 as a dark-red solid. ¹H NMR (300 MHz, CDCl₃) δ 8.90-8.40 (m, 6H), 5.17-5.00 (m, 2H), 2.22-2.10 (m, 4H), 1.84-1.60 (m, 4H), 1.41-0.90 (m, 72H), 0.86-0.65 (t, 12H). Rf=0.51 (10% MeOH/CH₂Cl₂).

Furuta co-polymers and para-Furuta polymers (herein referred to collectively as Furuta Polymers unless otherwise specified) are polymeric compounds with insulating tails, and linked/tethered/partially immobilized polarizable ionic groups. The insulating tails are hydrocarbon (saturated and/or unsaturated), fluorocarbon, siloxane, and/or polyethylene glycol linear or branched chains covalently bonded to the co-polymer backbone. The tails act to insulate the polarizable tethered/partially immobilized ionic molecular components and ionic pairs from other ionic groups and ionic group pairs on the same or parallel co-polymers, which favorably allows discrete polarization of counter ionic liquid pairs or counter Q groups (i.e. polarization of cationic liquid and anionic liquid tethered/partially immobilized to parallel Furuta polymers) with limited or no interaction of ionic fields or polarization moments of other counter ionic group pairs partially immobilized on the same or parallel co-polymer chains. Further, the insulating tails electrically insulate supra-structures of Furuta polymers from each other. Parallel Furuta polymers may arrange or be arranged such that counter ionic groups (i.e. tethered/partially immobilized ionic groups (Qs) of cation and anion types (sometimes known as cationic Furuta polymers and anionic Furuta polymers)) are aligned opposite from one another. In some implementations, the metadielectric layer may include two or more Furuta polymers, including a Furuta polymer having an immobilized ion liquid group of a cationic or anionic type.

A Furuta co-polymer has the following general structural formula:

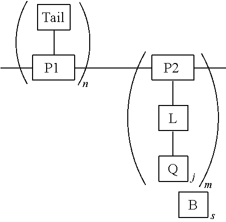

wherein backbone structure of the co-polymer comprises structural units of first type P1 and structural units of second type P2 both of which randomly repeat and are independently selected from the list comprising acrylic acid, methacrylate, repeat units of polypropylene (—[CH₂—CH(CH₃)]⁻), repeat units of polyethylene (—[CH₂]⁻), siloxane, or repeat units of polyethylene terephthalate (sometimes written poly(ethylene terephthalate)) for which the repeat unit may be expressed as —CH₂—CH₂—O—CO—C₆H₄—CO—O—. Parameter n is the number of the P1 structural units in the backbone structure which is in the range from 3 to 100,000 and m is number of the P2 structural units in the backbone structure which is in the range from 3 to 100,000. Further, the first type structural unit (P1) has a resistive substitute Tail which is oligomers of polymeric material with HOMO-LUMO gap no less than 2 eV. Additionally, the second type of structural units (P2) has an ionic functional group Q which is connected to P2 via a linker group L. The parameter j is a number of functional groups Q attached to the linker group L, which may range from 0 to 5. Wherein the ionic functional group Q comprises one or more ionic liquid ions (from the class of ionic compounds that are used in ionic liquids), zwitterions, or polymeric acids. Further, an energy interaction of the ionic Q groups may be less than kT, where k is Boltzmann constant and T is the temperature of environment. Still further, parameter B is a counter ion which is a molecule or molecules or oligomers that can supply the opposite charge to balance the charge of the co-polymer. Wherein, s is the number of the counter ions.

The present disclosure provides an organic co-polymeric compound having the structure described above. In one embodiment of the organic co-polymeric compound, the resistive substitute Tails are independently selected from the list comprising oligomers of polypropylene (PP), oligomers of polyethylene terephthalate (PET), oligomers of polyphenylene sulfide (PPS), oligomers of polyethylene naphthalate (PEN), oligomers of polycarbonate (PP), polystyrene (PS), and oligomers of polytetrafluoroethylene (PTFE). In another embodiment of the organic co-polymeric compound, the resistive substitutes Tail are independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tert-butyl groups, and the aryl group is selected from phenyl, benzyl and naphthyl groups. The resistive substitute Tail may be added after polymerization.

In yet another aspect of the present disclosure, it is preferable that the HOMO-LUMO gap is no less than 4 eV. In still another aspect of the present disclosure, it is even more preferable that the HOMO-LUMO gap is no less than 5 eV. The ionic functional group Q comprises one or more ionic liquid ions from the class of ionic compounds that are used in ionic liquids, zwitterions, or polymeric acids. The energy of interaction between Q group ions on discrete P₂ structural units may be less than kT, where k is Boltzmann constant and T is the temperature of environment. The temperature of environment may be in range between −60° C. of and 150° C. The preferable range of temperatures is between −40° C. and 100° C. Energy interaction of the ions depends on the effective radius of ions. Therefore, by increasing the steric hindrance between ions it is possible to reduce energy of interaction of ions. In one embodiment of the present invention, at least one ionic liquid ion is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine. The functional group Q may be charged after or before polymerization. In another embodiment of the present invention, the linker group L is oligomer selected from structures 42 to 47 as given in Table 4.

TABLE 4
Examples of the oligomer linker group

| | |
|---|---|
| 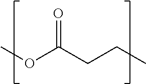 | 42 |
| 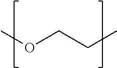 | 43 |
| 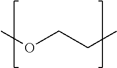 | 44 |
| 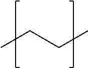 | 45 |
| 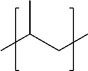 | 46 |
| 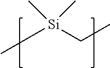 | 47 |

In yet another embodiment of the present invention, the linker group L is selected from structures 48 to 57 as given in Table 5.

TABLE 5
Examples of the linker group

| | |
|---|---|
| 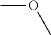 | 48 |
| 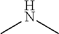 | 49 |
| 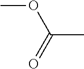 | 50 |
| 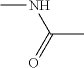 | 51 |
| 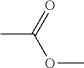 | 52 |
| 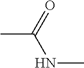 | 53 |
| 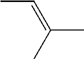 | 54 |
| 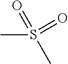 | 55 |
| 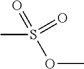 | 56 |
| 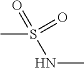 | 57 |

In yet another embodiment of the present invention, the linker group L may be selected from the list comprising CH₂, CF₂, SiR₂O, and CH2CH2O, wherein R is selected from the list comprising H, alkyl, and fluorine. The ionic functional group Q and the linker groups L may be added after polymerization.

In another aspect, the present disclosure provides a dielectric material (sometimes called a metadielectric) comprising of one or more of the class of Furuta polymers comprising protected or hindered ions of zwitterion, cation, anion, or polymeric acid types described hereinabove. The metadielectric material may be a mixture of zwitterion type Furuta polymers, or positively charged (cation) Furuta polymers and negatively charged (anion) Furuta polymers, polymeric acid Furuta polymers, or any combination thereof. The mixture of Furuta polymers may form or be induced to form supra-structures via hydrophobic and ionic interactions. By way of example, but not limiting in scope, the cation on a positively charged Furuta polymer replaces the B counter ions of the anion on a negatively charged Furuta polymer parallel to the positively charged Furuta polymer and vice versa; and the resistive Tails of neighboring Furuta polymers further encourages stacking via van der Waals forces, which increases ionic group isolation. Metadielectrics comprising both cationic and anionic Furuta polymers have a 1:1 ratio of cationic and anionic Furuta polymers.

The Tails of hydrocarbon (saturated and/or unsaturated), fluorocarbon, siloxane, and/or polyethylene glycol linear or branched act to insulate linked/tethered/partially immobilized polarizable ionic liquids, zwitterions, or polymeric acids (ionic Q groups). The Tails insulate the ionic Q groups from other ionic Q groups on the same or parallel Furuta polymer via steric hindrance of the ionic Q groups' energy of interaction, which favorably allows discrete polarization of the ionic Q groups (i.e. polarization of cationic liquid and anionic liquid tethered/partially immobilized to parallel Furuta polymers). Further, the Tails insulate the ionic groups of supra-structures from each other. Parallel Furuta polymers may arrange or be arranged such that counter ionic liquids (i.e. tethered/partially immobilized ionic liquids (Qs) of cation and anion types) are aligned opposite from one another (sometimes known as cationic Furuta polymers and anionic Furuta polymers).

The Furuta polymers have hyperelectronic or ionic type polarizability. “Hyperelectronic polarization may be considered due to the pliant interaction of charge pairs of excitons, localized temporarily on long, highly polarizable molecules, with an external electric field (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

Further, a metadielectric layer may be comprised of one or more types of zwitterion Furuta polymer and/or selected from the anionic Q⁺ group types and cationic Q⁻ group types and/or polymeric acids, having the general configuration of Furuta polymers:

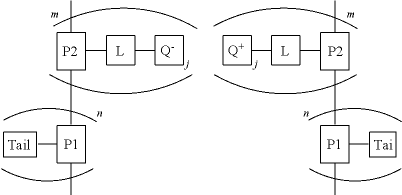

In order that the invention may be more readily understood, reference is made to the following examples of synthesis of Furuta co-polymers, which are intended to be illustrative of the invention, but are not intended to be limiting the scope.

### Example 3

Carboxylic acid co-polymer P002. To a solution of 1.02 g (11.81 mmol) of methacrylic acid and 4.00 g (11.81 mmol) of stearylmethacrylate in 2.0 g isopropanol was added a solution of 0.030 g 2,2′-azobis(2-methylpropionitrile) (AIBN) in 5.0 g of toluene. The resulting solution was heated to 80° C. for 20 hours in a sealed vial, after which it became noticeably viscous. NMR shows <2% remaining monomer. The solution was used without further purification in film formulations and other mixtures.

### Example 4

Amine co-polymer P011. To a solution of 2.52 g (11.79 mmol) of 2-(diisopropylamino)ethyl methacrylate and 3.00 g (11.79 mmol) of laurylmethacrylate in 2.0 g toluene was added a solution of 0.030 g 2,2′-azobis(2-methylpropionitrile) (AIBN) in 4.0 g of toluene. The resulting solution was heated to 80° C. for 20 hours in a sealed vial, after which it became noticeably viscous. NMR shows <2% remaining monomer. The solution was used without further purification in film formulations and other mixtures.

### Example 5

Carboxylic acid co-polymer and amine co-polymer mixture. 1.50 g of a 42 wt % by solids solution of P002 was added to 1.24 g of a 56 wt % solution of P011 with 1 g of isopropanol and mixed at 40° C. for 30 minutes. The solution was used without further purification.

A para-Furuta polymer has repeat units of the following general structural formula:

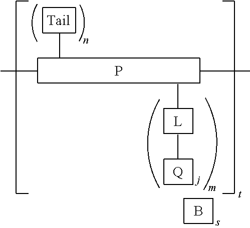

wherein a structural unit P comprises a backbone of the copolymer, which is independently selected from the list comprising acrylic acid, methacrylate, repeat units for polypropylene (PP) (—[CH₂—CH(CH₃)]⁻), repeat units for polyethylene (PE) (—[CH₂]⁻), siloxane, or repeat units of polyethylene terephthalate (sometimes written poly(ethylene terephthalate)) for which the repeat unit may be expressed as —CH₂—CH₂—O—CO—C₆H₄—CO—O—. Wherein the first type of repeat unit (Tail) is a resistive substitute in the form of an oligomer of a polymeric material. The resistive substitute preferably has a HOMO-LUMO gap no less than 2 eV. The parameter n is a number of Tail repeat units on the backbone P structural unit, and is in the range from 3 to 100,000. Further, the second type of repeat units (-L-Q) include an ionic functional group Q which is connected to the structural backbone unit (P) via a linker group L, and m is number of the -L-Q repeat units in the backbone structure which is in the range from 3 to 100,000. Additionally, the ionic functional group Q comprises one or more ionic liquid ions (from the class of ionic compounds that are used in ionic liquids), zwitterions, or polymeric acids. An energy of interaction of the ionic Q groups may be less than kT, where k is Boltzmann constant and T is the temperature of environment. Still further, the parameter t is average of para-Furuta polymer repeat units, ranging from 6 to 200,000. Wherein B's are counter ions which are molecules or oligomers that can supply the opposite charge to balance the charge of the co-polymer, s is the number of the counter ions.
In some implementations, the resistive substitute Tails are independently selected from the list comprising polypropylene (PP), polyethylene terephthalate (PET), polyphenylene sulfide (PPS), polyethylene naphthalate (PEN), polycarbonate (PP), polystyrene (PS), and polytetrafluoroethylene (PTFE). In another embodiment of the organic polymeric compound, the resistive substitutes Tail are independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tert-butyl groups, and the aryl group is selected from phenyl, benzyl and naphthyl groups. The resistive substitute Tail may be added after polymerization. In yet another embodiment of the present disclosure, it is preferable that the HOMO-LUMO gap is no less than 4 eV. In still another embodiment of the present disclosure, it is even more preferable that the HOMO-LUMO gap is no less than 5 eV. The ionic functional group Q comprises one or more ionic liquid ions from the class of ionic compounds that are used in ionic liquids, zwitterions, or polymeric acids. Energy of interaction between Q group ions on discrete P structural units may be less than kT, where k is Boltzmann constant and T is the temperature of environment. The temperature of environment may be in range between −60° C. and 150° C. The preferable range of temperatures is between −40° C. and 100° C. Energy interaction of the ions depends on the effective radius of ions. Therefore, by increasing the steric hindrance between ions it is possible to reduce energy of interaction of ions. In one embodiment of the present invention, at least one ionic liquid ion is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine. The functional group Q may be charged after or before polymerization. In another embodiment of the present invention, the linker group L is oligomer selected from structures 42 to 47 as given in Table 3 or structures 48 to 57 in Table 4.

In some implementations, the linker group L is selected from the list comprising CH₂, CF₂, SiR₂O, and CH₂CH₂O, wherein R is selected from the list comprising H, alkyl, and fluorine. The ionic functional group Q and the linker groups L may be added after polymerization.

In some implementations, the metadielectric includes one or more of the class of para-Furuta polymers comprising protected or hindered ions of zwitterion, cationic liquid ions, anionic liquid ions, or polymeric acid types described hereinabove. The metadielectric material may be a mixture of zwitterion type para-Furuta polymers, or positively charged (cation) para-Furuta polymers and negatively charged (anion) para-Furuta polymers, polymeric acid para-Furuta polymers, or any combination thereof. The mixture of para-Furuta polymers may form or be induced to form supra-structures via hydrophobic and ionic interactions. By way of example, but not limiting in scope, the cation(s) on a positively charged para-Furuta polymer replaces the B counter ions of the anion(s) on a negatively charged para-Furuta polymer parallel to the positively charged para-Furuta polymer and vice versa; and the resistive Tails of neighboring para-Furuta polymers further encourages stacking via van der Waals forces, which increases ionic group isolation. Metadielectrics comprising both cationic and anionic para-Furuta polymers preferably have a 1:1 ratio of cationic and anionic para-Furuta polymers.

The Tails of hydrocarbon (saturated and/or unsaturated), fluorocarbon, siloxane, and/or polyethylene glycol linear or branched act to insulate linked/tethered/partially immobilized polarizable ionic liquids, zwitterions, or polymeric acids (ionic Q groups). The Tails insulate the ionic Q groups from other ionic Q groups on the same or parallel para-Furuta polymer via steric hindrance of the ionic Q groups' energy of interaction, which favorably allows discrete polarization of the ionic Q groups (i.e. polarization of cationic liquid and anionic liquid tethered/partially immobilized to parallel para-Furuta polymers). Further, the Tails insulate the ionic groups of supra-structures from each other. Parallel para-Furuta polymers may arrange or be arranged such that counter ionic liquids (i.e. tethered/partially immobilized ionic liquids (Qs) of cation and anion types) are aligned opposite from one another (sometimes known as cationic para-Furuta polymers and anionic para-Furuta polymers).

The para-Furuta polymers have hyperelectronic or ionic type polarizability. “Hyperelectronic polarization may be considered due to the pliant interaction of charge pairs of excitons, localized temporarily on long, highly polarizable molecules, with an external electric field [.] (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

Further, a metadielectric layer may be comprised of one or more types of zwitterion para-Furuta polymer and/or selected from the anionic Q group types and cationic Q group types and/or polymeric acids, which may have the following general arrangement of para-Furuta polymers:

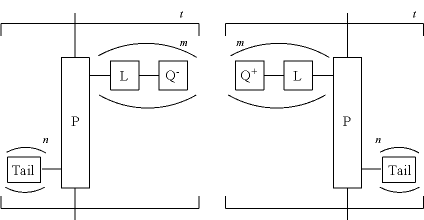

A metadielectric is defined here as a dielectric material comprised of one or more types of structured polymeric materials (SPMs) having a relative permittivity greater than or equal to 1000 and resistivity greater than or equal to 10¹³ ohm/cm. Individually, the SPMs in a metadielectric may form column like supramolecular structures by pi-pi interaction or hydrophilic and hydrophobic interactions. Said supramolecules of SPMs may permit formation of crystal structures of the metadielectric material. By way of using SPMs in a dielectric material, polarization units are incorporated to provide the molecular material with high dielectric permeability. There are several mechanisms of polarization such as dipole polarization, ionic polarization, and hyper-electronic polarization of molecules, monomers and polymers possessing metal conductivity. All polarization units with the listed types of polarization may be used in aspects of the present disclosure. Further, SPMs are composite materials which incorporate an envelope of insulating substituent groups that electrically isolate the supramolecules from each other in the dielectric layer and provide high breakdown voltage of the energy storage molecular material. Said insulating substituent groups are hydrocarbon (saturated and/or unsaturated), fluorocarbon, siloxane, and/or polyethylene glycol linear or branched chains covalently bonded to a polarizable core or co-polymer backbone, forming the resistive envelope.

In general, a YanLi polymer is a composite oligomeric material comprised of monomers that have polarizable and insulating components. The monomers may include a polarizable unit having a non-linear polarizable core that includes a conjugated ring system and at least one dopant group. The monomers also include an insulating tail as a side chain on the polarizable unit, on the handle linking a polarizable unit to the monomer backbone, or directly attached to the backbone. In some embodiments, a YanLi polymer may be a co-polymer wherein one monomer unit includes an insulating tail and a second monomer unit includes a polarizable unit having a non-linear polarizable core that includes a conjugated ring system and at least one dopant group. In some embodiments, the polarizable unit may be partially or fully incorporated into the monomer backbone. Additionally, the polarizable unit may be partially or fully incorporated into the monomer backbone.

A metadielectric layer may be a film made from composite polymers referred to herein as YanLi materials. A particular subclass of YanLi materials are referred to herein as YanLi dielectrics, which are materials of one or more YanLi polymers, of one or more YanLi oligomer, or any combination thereof. Such a composite polymeric material is characterized by a chemical structure that includes a repeating backbone unit, a polarizable unit, and a resistive tail. The polarizable unit must possess a high degree of conjugation. Herein, we define “polarizable unit” to mean any multicyclic arrangement where electrons are delocalized over the entire portion of the polarizable unit structure via conjugated single and double bonds. Herein, anisometric is defined as the condition of a molecule possessing charge or partial charge asymmetry along an axis. Possible, non-limiting, forms of this conjugation are polycyclic fused aromatic systems or a conjugated bridge where aromatic systems are connected by alternating single and double bonds.

YanLi materials include composite polymeric materials of the following general formula:

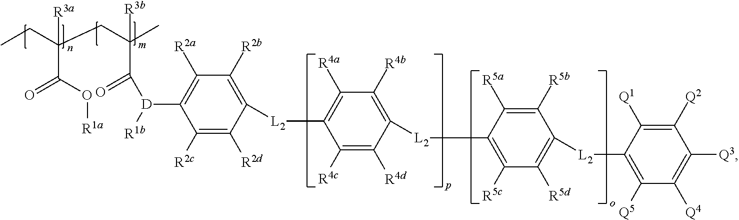

wherein D is

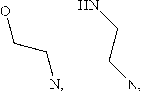

N, or a hydrocarbon chain, wherein R^{1a}, R^{1b}, R^{2a}, R^{2b}, R^{2c}, R^{2d}, R^{3a}, R^{3b}, R^{4a}, R^{4b}, R^{4c}, R^{4d}, R^{5a}, R^{5b}, R^{5c}, R^{5d} are independently selected from —H, —OH, -Ak, -Ak-Xₗ, —OAk, or —OAk-Xₗ; L₂ is a heteroatom bridge in conjugation with the ring system containing R^{2a}, R^{2b}, R^{2c}, R^{2d}, Q¹, Q³, Q⁴, Q⁵; wherein R^{2a}, R^{2b}, R^{2c}, R^{2d}, Q¹, Q², Q³, Q⁴, Q⁵ are each independently selected from —H and any electron withdrawing or electron donating group; wherein Ak is alkyl, X is any halogen, n is 0-150, m is 1-300, l is 1-51, o is 0-10, p is 0-1 when o is less than or equal to one and 1 when o is greater than 1, wherein R^{1a} or R^{1b} is an insulating resistive tail or both R^{1a} and R^{2a} are insulating resistive tails.
In some implementations of composite polymeric materials of the above general formula, the value of n may be equal to or greater than 1.
In some implementations of composite polymeric materials of the above general formula, the value of n may be equal to zero. In such implementations, R^{1a}, R^{1b}, R^{3a} or R^{3b} may possesses at least 7 carbon atoms.
In some implementations of composite polymeric materials of the above general formula, R^{1a}, R^{1b}, R^{3a}, and R^{3b} may be insulating resistive tails are independently selected from the group consisting of saturated hydrocarbon, saturated halogenated hydrocarbon, partially halogenated hydrocarbon, aryl chain, and cycloalkyl, and X—RR′R″; wherein X is selected from C, O, N, and S, and R, R′, and R″ are independently selected from H and C₅₋₅₀, wherein one or more of R, R′, and R″ is C₅₋₅₀. As used in the present disclosure, the notation C₅₋₅₀ means a chain of 5 to 50 carbon atoms. In such implementations a chain may be monounsaturated or partially unsaturated, yet the unsaturated bonds are not conjugated. In such implementations all insulating resistive tails may be selected independently from the group consisting of non-aromatic carbocycles and non-aromatic heterocycles.
In some implementations of composite polymeric materials of the above general formula, all insulating resistive tails may be rigid.
In some implementations of composite polymeric materials of the above general formula, Q₁, Q₂, Q₃, Q₄ and Q₅ may each be independently selected from —NO₂, —NH₃ and —NRR′R″⁺ (quaternary nitrogen salts) with counterion Cl⁻ or Br⁻, —CHO (aldehyde), —CRO (keto group), —SO₃H (sulfonic acids), —SO₃R (sulfonates), SO₂NH₂ (sulfonamides), —COOH (carboxylic acid), —COOR (esters, from carboxylic acid side), —COCl (carboxylic acid chlorides), —CONH₂ (amides, from carboxylic acid side), —CF₃, —CCl₃, —CN, —O⁻ (phenoxides) with counter ion Na⁺ or K⁺, —NH₂, —NHR, —NR₂, —OH, OR (ethers), —NHCOR (amides, from amine side), —OCOR (esters, from alcohol side), alkyls, —C₆H₅, vinyls, wherein R and R′ and R″ are radicals selected from the list comprising hydrogen, alkyl (methyl, ethyl, isopropyl, tert-butyl, neopentyl, cyclohexyl etc.), allyl (—CH2-CH═CH2), benzyl (—CH2C6H5) groups, phenyl (+substituted phenyl) and other aryl (aromatic) groups. In some such implementations, one or more of Q¹, Q², Q³, Q⁴, and Q⁵ may be —NO₂.
In some implementations of composite polymeric materials of the above general formula, D may be a hydrocarbon chain that is interrupted by heteroatoms at the point of backbone attachment and side chain attachment.
In some implementations of composite polymeric materials of the above general formula, L₂ may be an azo-bridge or —N═N—, an alkene bridge or —HC═CH—, and alkyne bridge or —C≡C—.
In some implementations of composite polymeric materials of the above general formula, the composite polymeric material may have any of structures 58 to 77 as shown in Table 6 below:

TABLE 6

| | |
|---|---|
| 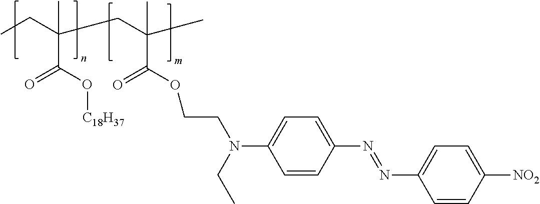 | 58 |
| 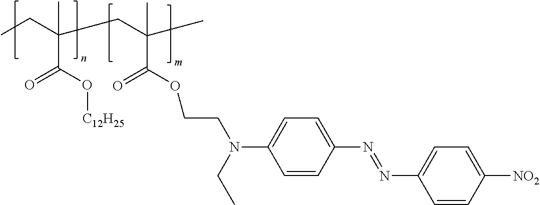 | 59 |
| 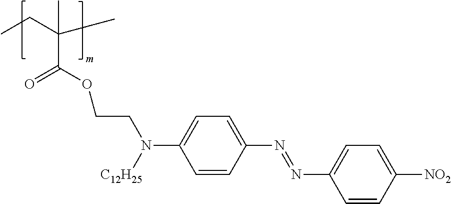 | 60 |
| 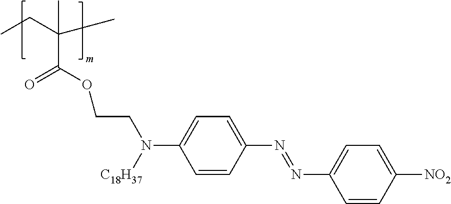 | 61 |
| 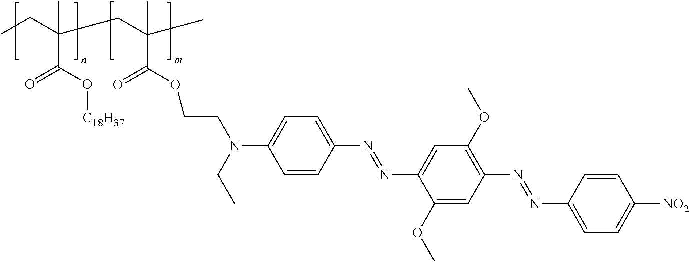 | 62 |
| 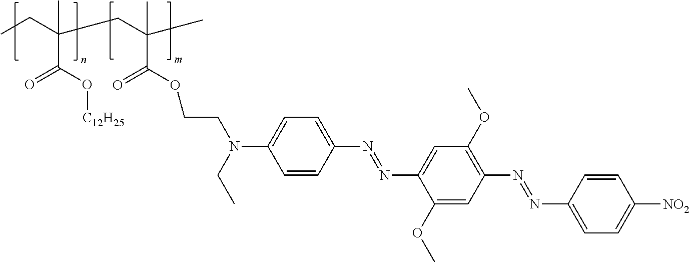 | 63 |
| 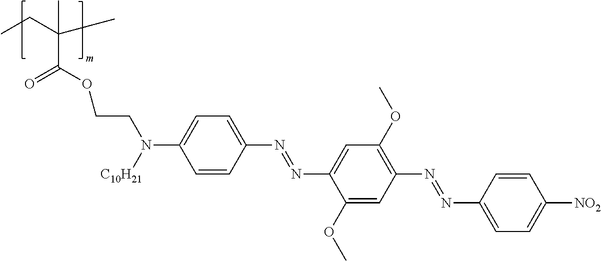 | 64 |
| 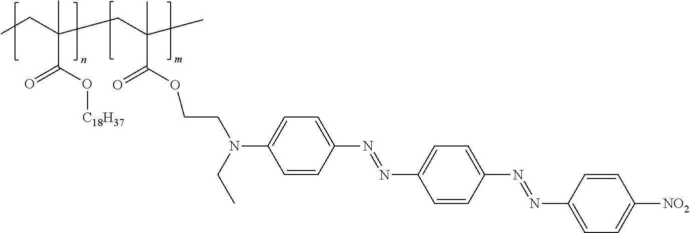 | 65 |
| 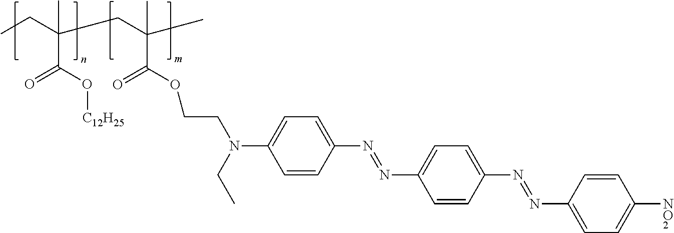 | 66 |
| 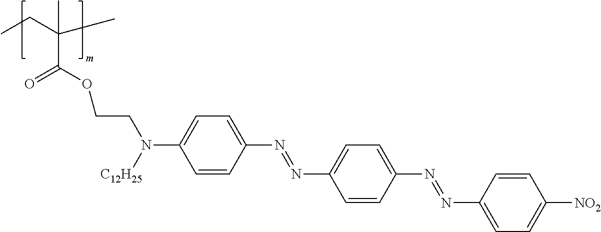 | 67 |
| 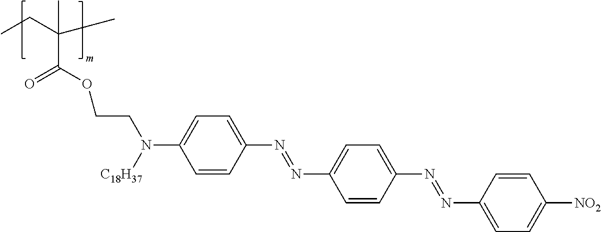 | 68 |
| 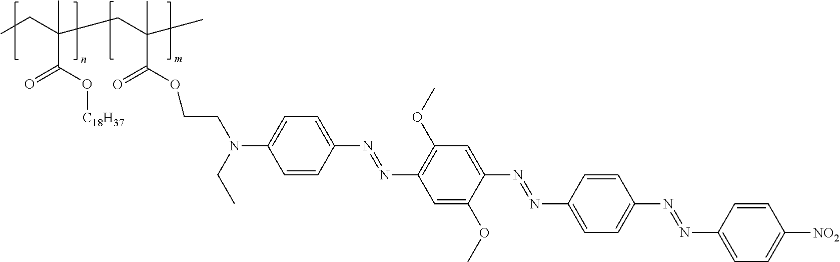 | 69 |
| 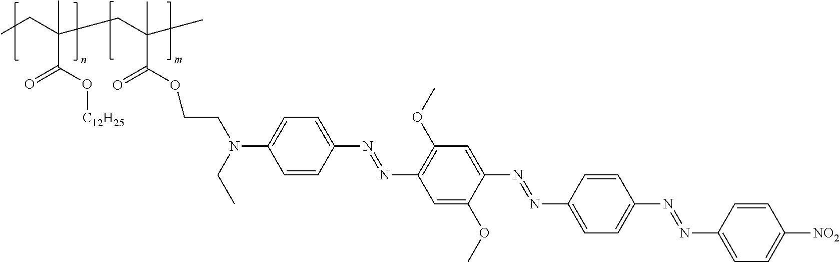 | 70 |
| 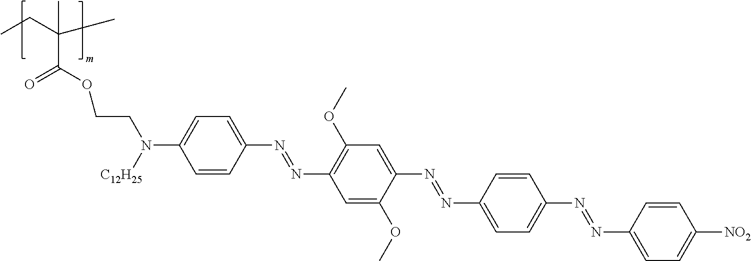 | 71 |
| 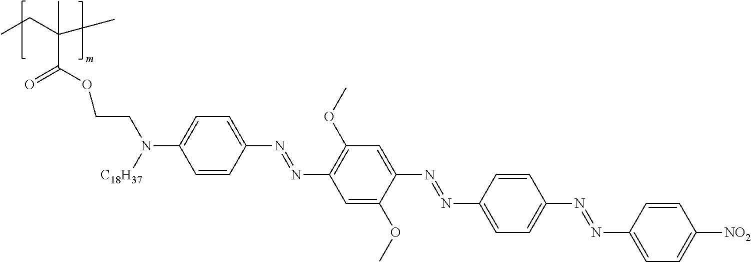 | 72 |
| 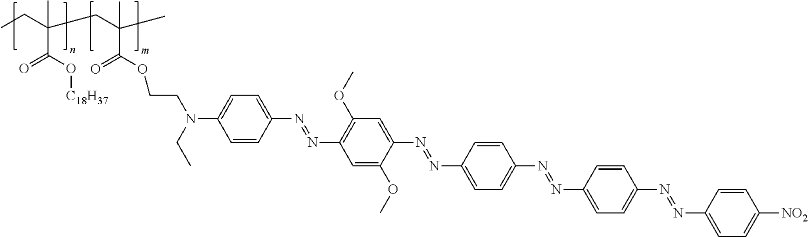 | 73 |
| 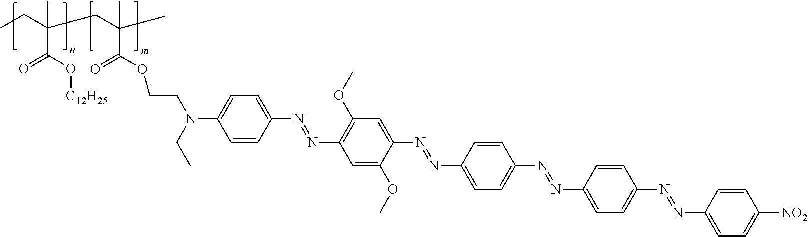 | 74 |
| 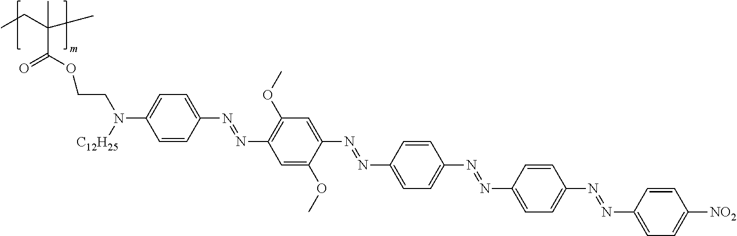 | 75 |
| 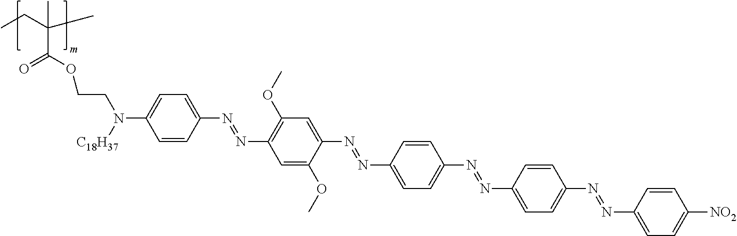 | 76 |
| 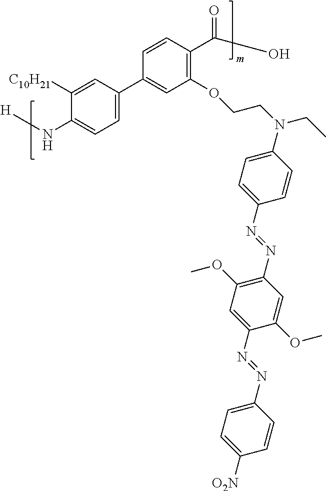 | 77 |

wherein n ranges from 0-150 and m ranges from 1-300. Additionally, the repeat units of co-polymer variants repeat randomly, or more-or-less one-to-one in succession.
In addition, aspects of the present disclosure include composite polymeric materials of the following general formula:

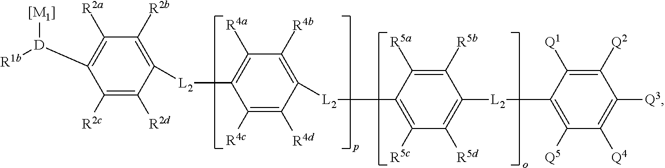

In the above general formula [M1] is:

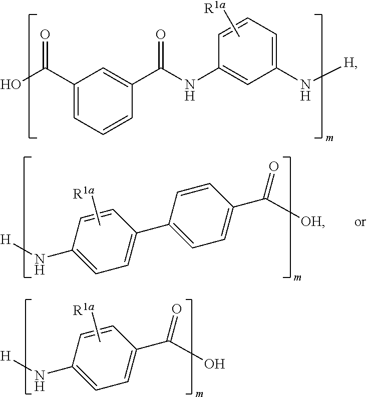

R^{1a}, R^{1b}, R^{2a}, R^{2b}, R^{2c}, R^{2d}, R^{4a}, R^{4b}, R^{4c}, R^{4d}, R^{5a}, R^{5b}, R^{5c}, R^{5d} are independently selected from —H, —OH, -Ak, -Ak-Xₗ, —OAk, or —OAk-Xₗ, L₂ is a heteroatom bridge in conjugation with the ring system containing R^{2a}, R^{2b}, R^{2c}, R^{2d}, Q¹, Q², Q³, Q⁴, Q⁵; wherein R^{2a}, R^{2b}, R^{2c}, R^{2d}, Q¹, Q², Q³, Q⁴, Q⁵ are each independently selected from —H and any electron withdrawing or electron donating group, wherein D is a hydrocarbon chain, wherein Ak is alkyl, X is any halogen, m is 1-300, l is 1-51, o is 0-10, p is 0-1 when o is less than or equal to one and 1 when o is greater than 1, wherein R^{1a} or R^{1b} is an insulating resistive tail or both R^{1a} and R^{1b} are insulating resistive tails.
In some implementations of composite polymeric materials of the above general formula, R^{1a}, R^{1b}, R^{3a} or R^{3b} may possess at least 7 carbon atoms.
In some implementations of composite polymeric materials of the above general formula, R^{1a}, R^{1b}, R^{3a}, and R^{3b} are insulating resistive tails are independently selected from the group consisting of saturated hydrocarbon, saturated halogenated hydrocarbon, partially halogenated hydrocarbon, aryl chain, and cycloalkyl, and X—RR′R″; wherein X is selected from C, O, N, and S, and R, R′, and R″ are independently selected from H and C₅₋₅₀, wherein one or more of R, R′, and R″ is C₅₋₅₀.
In some implementations of composite polymeric materials of the above general formula, the insulating resistive tails may be selected independently from the group consisting of non-aromatic carbocycles and non-aromatic heterocycles.
In some implementations of composite polymeric materials of the above general formula all insulating resistive tails may be rigid.
In some implementations of composite polymeric materials of the above general formula, Q₁, Q₂, Q₃, Q₄ and Q₅ are each independently selected from —NO₂, —NH₃⁺ and —NRR′R″⁺ (quaternary nitrogen salts) with counterion Cl⁻ or Br⁻, —CHO (aldehyde), —CRO (keto group), —SO₃H (sulfonic acids), —SO₃R (sulfonates), SO₂NH₂ (sulfonamides), —COOH (carboxylic acid), —COOR (esters, from carboxylic acid side), —COCl (carboxylic acid chlorides), —CONH₂ (amides, from carboxylic acid side), —CF₃, —CCl₃, —CN, —O⁻ (phenoxides) with counter ion Na⁺ or K⁺, —NH₂, —NHR, —NR₂, —OH, OR (ethers), —NHCOR (amides, from amine side), —OCOR (esters, from alcohol side), alkyls, —C₆H₅, vinyls, wherein R and R′ and R″ are radicals selected from the list comprising hydrogen, alkyl (methyl, ethyl, isopropyl, tert-butyl, neopentyl, cyclohexyl etc.), allyl (—CH2-CH═CH2), benzyl (—CH2C6H5) groups, phenyl (+substituted phenyl) and other aryl (aromatic) groups. In some such implementations, one or more of Q¹, Q², Q³, Q⁴, and Q⁵ may be —NO₂.
In some implementations of composite polymeric materials of the above general formula, D may be a hydrocarbon chain that is interrupted by heteroatoms at the point of backbone attachment and side chain attachment.
In some implementations of composite polymeric materials of the above general formula, L₂ may be an azo-bridge or —N═N—, an alkene bridge or —HC═CH—, and alkyne bridge or —C≡C—.
In some implementations of composite polymeric materials of the above general formula, D may be a hydrocarbon chain interrupted by heteroatoms at the point of backbone attachment and side chain attachment.
In some implementations of composite polymeric materials of the above general formula, L₂ may be an azo-bridge or —N═N—, an alkene bridge or —HC═CH—, and alkyne bridge or —C≡C—.
Furthermore, aspects of the present disclosure include composite polymeric materials of the following general formula:

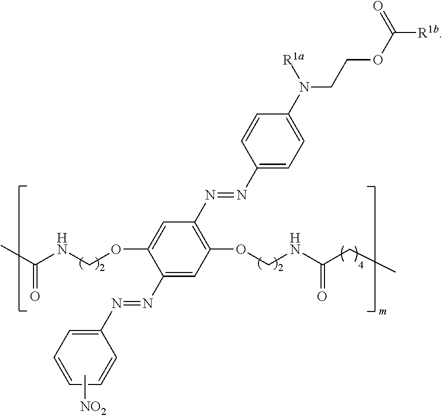

In the foregoing general formula R^{1a} and R^{1b} are independently selected from —H, —OH, -Ak, -Ak-Xₗ, —OAk, and —OAk-Xₗ, Ak is alkyl, X is any halogen, m is 1-300, l is 1-51, and wherein R^{1a} or R^{1b} is an insulating resistive tail or wherein R^{1a} and R^{1b} are both insulating resistive tails.
In some implementations of composite polymeric materials of the above general formula, R^{1a} or R^{1b} may possesses at least 7 carbon atoms.
In some implementations of composite polymeric materials of the above general formula, R^{1a} and R^{1b} may be insulating resistive tails are independently selected from the group consisting of saturated hydrocarbon, saturated halogenated hydrocarbon, partially halogenated hydrocarbon, aryl chain, and cycloalkyl, and X—RR′R″; wherein X is selected from C, O, N, and S, and R, R′, and R″ are independently selected from H and C₅₋₅₀, wherein one or more of R, R′, and R″ is C₅₋₅₀. In some such implementations, the insulating resistive tails may be selected independently from the group consisting of non-aromatic carbocycles and non-aromatic heterocycles.
In some implementations of composite polymeric materials of the above general formula, all insulating resistive tails may be rigid.
In some implementations of composite polymeric materials of the above general formula, the composite polymeric material may have structure 78 as shown below:

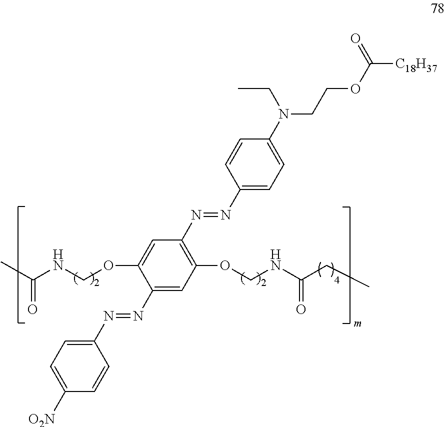

wherein m ranges from 1-300.
Additional aspects of the present disclosure include composite polymeric materials of the following general formula:

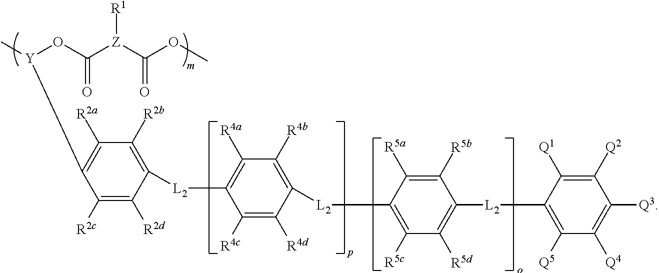

In the foregoing general formula R¹, R^{2a}, R^{2b}, R^{2c}, R^{2d}, R^{4a}, R^{4b}, R^{4c}, R^{4d}, R^{5a}, R^{5b}, R^{5c}, R^{5d} are independently selected from —H, —OH, -Ak, -Ak-Xₗ, —OAk, or —OAk-Xₗ, L₂ is a heteroatom bridge in conjugation with the ring system containing R^{2a}, R^{2b}, R^{2c}, R^{2d}, Q¹, Q², Q³, Q⁴, Q⁵; wherein R^{2a}, R^{2b}, R^{2c}, R^{2d}, Q¹, Q², Q³, Q⁴, Q⁵ are each independently selected from —H and any electron withdrawing or electron donating group, wherein Ak is alkyl, X is any halogen, wherein o is 0-10, p is 0-1 when o is less than or equal to one and 1 when o is greater than 1, wherein R¹ is an insulating resistive tail; wherein Z is substituted or unsubstituted hydrocarbon cyclic or chain linkage, Y is any hydrocarbon chain which may be interrupted by a hetero atom at the point of attachment.
In some implementations of composite polymeric materials of the above general formula, the composite polymeric material may have structure 79 as shown below:

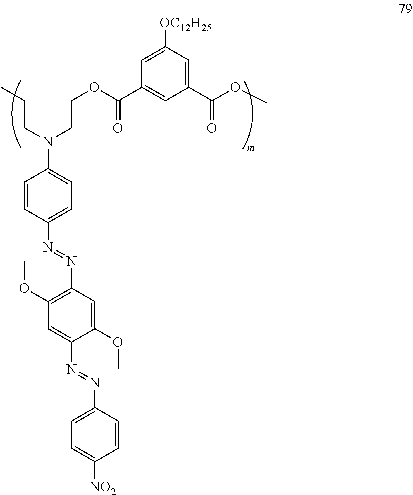

wherein m ranges from 1-300.
In some implementations of composite polymeric materials of the above general formula, R¹ may possess at least 7 carbon atoms.
In some implementations of composite polymeric materials of the above general formula, R¹ may be an insulating resistive tail selected from the group consisting of saturated hydrocarbon, saturated halogenated hydrocarbon, partially halogenated hydrocarbon, aryl chain, and cycloalkyl, and X—RR′R″; wherein X is selected from C, O, N, and S, and R, R′, and R″ are independently selected from H and C₅₋₅₀, wherein one or more of R, R′, and R″ is C₅₋₅₀.
In some implementations of composite polymeric materials of the above general formula, R¹ may be a rigid insulating resistive tail. In some such implementations, the rigid insulating resistive tail may be selected from the group consisting of non-aromatic carbocycles and non-aromatic heterocycles.

In some implementations of composite polymeric materials of the above general formula, Q₁, Q₂, Q₃, Q₄ and Q₅ may each be independently selected from —NO₂, —NH₃₊ and —NRR′R″⁺(quaternary nitrogen salts) with counterion Cl⁻ or Br⁻, —CHO (aldehyde), —CRO (keto group), —SO₃H (sulfonic acids), —SO₃R (sulfonates), SO₂NH₂ (sulfonamides), —COOH (carboxylic acid), —COOR (esters, from carboxylic acid side), —COCl (carboxylic acid chlorides), —CONH₂ (amides, from carboxylic acid side), —CF₃, —CCl₃, —CN, —O⁻ (phenoxides) with counter ion Na⁺ or K⁺, —NH₂, —NHR, —NR₂, —OH, OR (ethers), —NHCOR (amides, from amine side), —OCOR (esters, from alcohol side), alkyls, —C₆H₅, vinyls, wherein R and R′ and R″ are radicals selected from the list comprising hydrogen, alkyl (methyl, ethyl, isopropyl, tert-butyl, neopentyl, cyclohexyl etc.), allyl (—CH2-CH═CH2), benzyl (—CH2C6H5) groups, phenyl (+substituted phenyl) and other aryl (aromatic) groups. In some such implementations, one or more of Q¹, Q², Q³, Q⁴, and Q⁵ may be —NO₂.

By way of example, and not by way of limitation, according to aspects of the present disclosure, a metadielectric film may include a polymer matrix and at least one material of any of the four general formulae discussed above or any specific implementations mentioned above or discussed further below.

In some embodiments, the metadielectric layer may be comprised of a mixture or YanLi materials selected from at least one YanLi material of the four general formulae discussed above or a mixture of any specific implementations mentioned above.

Alternatively, in some embodiments the metadielectric layer may be comprised of the aforementioned YanLi materials and the aforementioned oligomers, compounds, polymers, monomers or polymers of the backbone units of said YanLi materials, one or more plasticizers (phthalates or non-phthalates), or any combination thereof. Use of non-ionic plasticizers can improve the metadielectric layer's resistivity through smoothing out electric field lines. This phenomenon occurs when the plasticizers fill voids and/or assists in supramolecular alignment.

Additionally, plasticizers can improve the material's mechanical properties by reducing brittleness of the material during and post processing.

In one embodiment, the composite polymer comprises more than one type of resistive tails. In another embodiment, the composite polymer comprises more than one type of ordered resistive tails. In yet another embodiment, the composite polymer comprises at least one resistive tail or at least one type of ordered resistive tails.

In order that the invention may be more readily understood, reference is made to the following examples, which are intended to be illustrative of the invention, but are not intended to limit the scope.

In one embodiment, a liquid or solid composite polymer is placed between the first and second electrodes. A solid chromophore is, for example, pressed into a pellet and placed between the first electrode and the second electrode. The chromophore can be ground into a powder before pressing.

In another embodiment, at least one type of YanLi polymer or YanLi oligomer may be dissolved or suspended in a solvent. The resultant material can be spin coated, extruded via slot die, roll-to-roll coated, or pulled and dried to form a dielectric film.

In another embodiment, a composite oligomer may be dissolved or suspended in a polymer. This is termed a “guest-host” system where the oligomer is the guest and the polymer is the host. Polymer hosts include, but are not limited to, poly(methyl methacrylate), polyimides, polycarbonates and poly(ε-caprolactone). These systems are cross-linked or non-cross-linked. In some instances, it may be beneficial to use tailless composite oligomers.

In another embodiment, a composite oligomer may be attached to a polymer. This is termed a “side-chain polymer” system. This system has the advantages over guest-host systems because high composite oligomer concentrations are incorporated into the polymer with high order and regularity and without phase separation or concentration gradients. Side chain polymers include, but are not limited to, poly[4-(2,2-dicyanovinyl)-N-bis(hydroxyethyl)aniline-alt-(4,4′-methylenebis(phenylisocyanate))]urethane, poly[4-(2,2-dicyanovinyl)-N-bis(hydroxyethyl)aniline-alt-(isophoronediisocyanate)]urethane, poly(9H-carbazole-9-ethyl acrylate), poly(9H-carbazole-9-ethyl methacrylate), poly(Disperse Orange 3 acrylamide), poly(Disperse Orange 3 methacrylamide), poly(Disperse Red 1 acrylate), poly(Disperse Red 13 acrylate), poly(Disperse Red 1 methacrylate), poly(Disperse Red 13 methacrylate), poly[(Disperse Red 19)-alt-(1,4-diphenylmethane urethane)], poly(Disperse Red 19-p-phenylene diacrylate), poly(Disperse Yellow 7 acrylate), poly(Disperse Yellow 7 methacrylate), poly[(methyl methacrylate)-co-(9-H-carbazole-9-ethyl acrylate)], poly[(methyl methacrylate)-co-(9-H-carbazole-9-ethyl methacrylate)], poly[methyl methacrylate-co-(Disperse Orange 3 acrylamide)], poly[methyl methacrylate-co-(Disperse Orange 3 methacrylamide)], poly[(methyl methacrylate)-co-(Disperse Red 1 acrylate)], poly[(methyl methacrylate)-co-(Disperse Red 1 methacrylate)], poly[(methyl methacrylate)-co-(Disperse Red 13 acrylate)], poly[(methyl methacrylate)-co-(Disperse Red 13 methacrylate)], poly[methyl methacrylate-co-(Disperse Yellow 7 acrylate)], poly[methyl methacrylate-co-(Disperse Yellow 7 methacrylate)], poly [[(S)-1-(4-nitrophenyl)-2-pyrrolidinemethyl]acrylate], poly[((S)-(−)-1-(4-nitrophenyl)-2-pyrrolidinemethyl)acrylate-co-methyl methacrylate], poly [[(S)-1-(4-nitrophenyl)-2-pyrrolidinemethyl]methacrylate] and poly[((S)-(−)-1-(4-nitrophenyl)-2-pyrrolidinemethyl)methacrylate-co-methyl methacrylate]. These systems are cross-linked or non-cross-linked.

In another embodiment, composite oligomers may be embedded in matrices such as oxides, halides, salts and organic glasses. An example of a matrix is inorganic glasses comprising the oxides of aluminum, boron, silicon, titanium, vanadium and zirconium.

According to aspects of the present disclosure, the polymers that make up a YanLi dielectric may be aligned, partially aligned or unaligned. The composite polymer is preferably aligned for optimal geometric configuration of polarizing units as this results in higher capacitance values in the capacitor. One method of alignment is to apply a DC electric field to the composite polymer at a temperature at which the polarizable units can be oriented. This method is termed “poling.” Poling is generally performed near the glass transition temperature of polymeric and glassy systems. One possible method of poling is corona poling. Other methods of alignment could be roll-to-roll, Meyer bar, dip, slot die, and air knife coating of solutions and liquid crystal solutions of said side-chain polymers or composite oligomers.

In some instances, the side-chain polymer or composite oligomers may form liquid crystals in solution or solvent and with or without external influence. Non-limiting examples of liquid crystals include lyotropic and thermotropic liquid crystals. Non-limiting examples of external influences include heat, electric field, mechanical disturbances (e.g. vibration or sonication), and electromagnetic radiation. Said liquid crystals are supramolecular structures comprised of said side-chain polymers or composite oligomer in solution or solvent and are ordered and aligned or partially ordered or partially aligned. Such liquid crystal materials may be coated onto a substrate, e.g., by roll-to-roll, Meyer bar, dip, slot die, or air knife coating in a process that includes mechanical ordering of the liquid crystals, and drying of the liquid crystal solution or evaporation of the solvent such that the liquid crystals form a crystalline or semi-crystalline layer or film of metadielectric material. Alternatively, such liquid crystal materials may be extruded as a film such that the liquid crystals form a crystalline or semi-crystalline film of metadielectric material. In some instances, extrusion of such liquid crystal materials may be coextruded as a multilayer film. Such multilayer films may include alternating layers of conducting layers and insulating layers, wherein the insulating layers may be the aforementioned crystalline or semi-crystalline layer of metadielectric material.

Preferred polymer embodiments are polyester, polyalkylacrylate (preferably methacrylic and acrylic), polyamide, and polyaramid. This resistive tail may be attached to the polarizable side chain or may be its own independent side chain interspersed in any pattern or random assortment with the polarizable side chains or a mixture thereof. These species can be represented by one of the following formula.

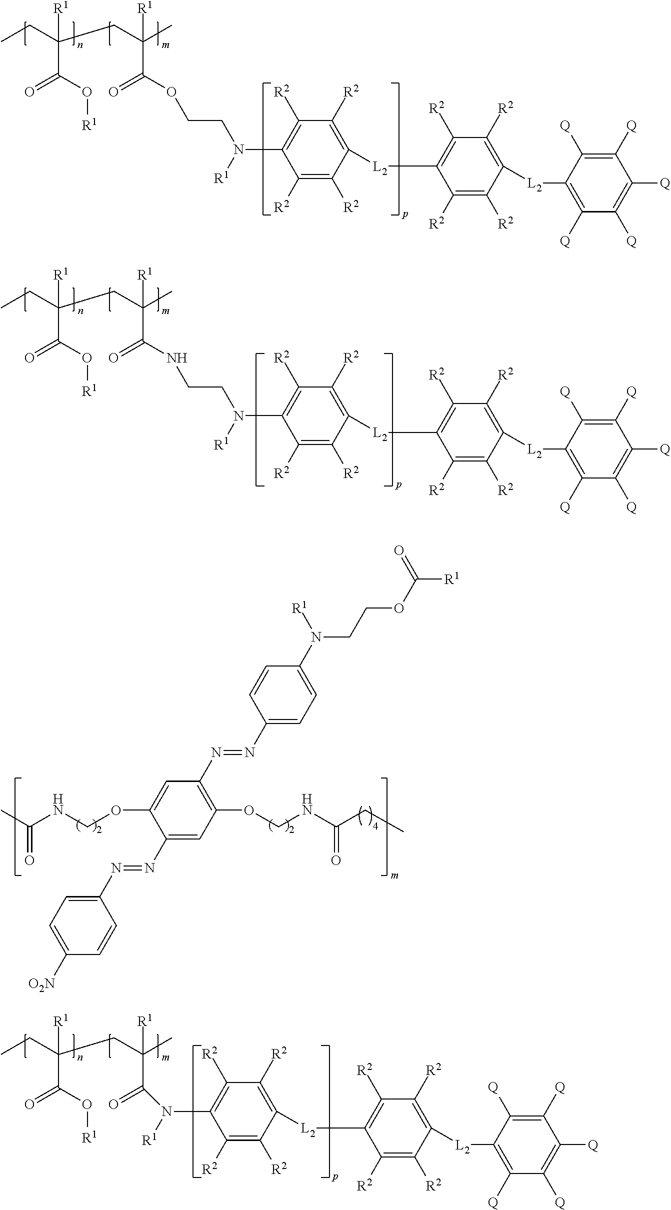

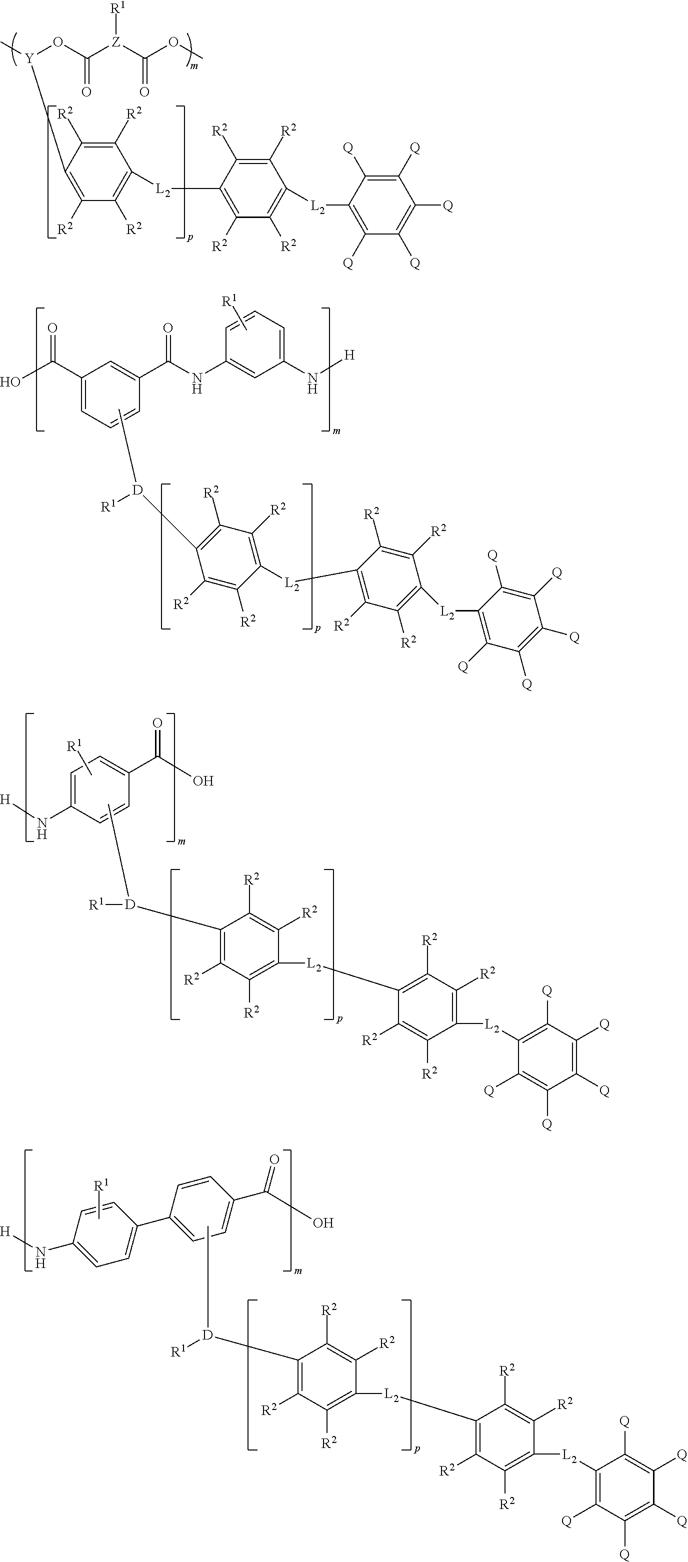

Wherein, each instance of R¹ is independently selected from —H, —OH, -Ak, alkoxy, —OAk-Xₒ, or -Ak-Xₒ, each instance of R² is independently selected from —H, —OH, —OAk, or —OAk-Xₒ; D is any hydrocarbon chain which may be interrupted by hetero atoms at the point of backbone attachment and side chain attachment, L₂ is a heteroatom bridge in conjugation with the ring system of the side chain (e.g. azo-bridge, alkene bridge, and alkyne bridge), each instance of Q is independently selected from any electron donating or electron withdrawing group or H, Z is substituted or unsubstituted hydrocarbon cyclic or chain linkage, Y is any hydrocarbon chain which may be interrupted by a hetero atom at the point of attachment to the side chain, Ak is alkyl, X is any halogen, n is 0-150, m is 1-300, o is 1-51, p is 0-10, q is 0-4, and r is 0-4, with the provisio that at least one instance of R¹ must be a resistive tail. Preferred, but not limiting, embodiments of resistive tails include hydrocarbon and halohydrocarbon chains, non-aromatic hydrocarbocycles, and non-aromatic heterocycles. In some embodiments, it may be preferable for the resistive tails to be ridged. In such embodiments, rigid resistive tails maybe non-aromatic carbocycles or non-aromatic heterocycles.

The conjugated aromatic ring system may be made further polarizable by adding a variety of functional groups to various cyclic positions of the structure. Incorporating electron donors and electron acceptors is one way to enhance the polarizability. Electrophilic groups (electron acceptors) are selected from —NO₂, —NH₃⁺ and —NR₃⁺ (quaternary nitrogen salts), counterion Cl⁻ or Br⁻, —CHO (aldehyde), —CRO (keto group), —SO₃H (sulfonic acids), —SO₃R (sulfonates), SO₂NH₂ (sulfonamides), —COOH (carboxylic acid), —COOR (esters, from carboxylic acid side), —COCl (carboxylic acid chlorides), —CONH₂ (amides, from carboxylic acid side), —CF₃, —CCl₃, —CN, wherein R is radical selected from the list comprising alkyl (methyl, ethyl, isopropyl, tert-butyl, neopentyl, cyclohexyl etc.), allyl (—CH₂—CH═CH₂), benzyl (—CH₂C6H5) groups, phenyl (+substituted phenyl) and other aryl (aromatic) groups. Nucleophilic groups (electron donors) are selected from —O⁻ (phenoxides, like —ONa or —OK), —NH₂, —NHR, —NR₂, —NRR′, —OH, OR (ethers), —NHCOR (amides, from amine side), —OCOR (esters, from alcohol side), alkyls, —C₆H₅, vinyls, wherein R and R′ are radicals independently selected from the list comprising alkyl (methyl, ethyl, isopropyl, tert-butyl, neopentyl, cyclohexyl etc.), allyl (—CH2-CH═CH2), benzyl (—CH2C6H5) groups, phenyl (+substituted phenyl) and other aryl (aromatic) groups. Preferred electron donors include, but are not limited to, amino and phosphino groups and combinations thereof. Preferred electron acceptors include, but are not limited to, nitro, carbonyl, oxo, thioxo, sulfonyl, malononitrile, isoxazolone, cyano, dicyano, tricyano, tetracycano, nitrile, dicarbonitrile, tricarbonitrile, thioxodihydropyrimidinedione groups and combinations thereof. More conjugated bridges include, but are not limited to, 1,2-diphenylethene, 1,2-diphenyldiazene, styrene, hexa-1,3,5-trienylbenzene and 1,4-di(thiophen-2-yl)buta-1,3-diene, alkenes, dienes, trienes, polyenes, diazenes and combinations thereof.

Existence of the electrophilic groups (acceptors) and the nucleophilic groups (donors) in the aromatic polycyclic conjugated molecule promotes increase of electronic polarizability of these molecules. Under the influence of external electric field electrons are displaced across the polarizable unit to compensate the electric field. The nucleophilic groups (donors) and the electrophilic groups (acceptors) add to the electron density of the polarizable unit, which increases polarizability of such molecules and ability to form compensating electric field counter in the presence of an electric field. Thus a distribution of electronic density in the molecules is non-uniform. The presence of the polarizable units leads to increasing of polarization ability of the disclosed material because of electronic conductivity of the polarizable units.

Increasing the number of phenyl rings ‘p’ can increase the linear polarizability (α) and the nonlinear polarizability (β) of the conjugated side chain, as seen in the graphs ‘α vs p’ (depicted in FIG. 4A) and ‘β vs p’ (depicted in FIG. 4B), and corresponding Table 1 below, which lists comparative values of α and β for chromophores having different numbers of phenyl rings. However, increasing the number of conjugated aromatic rings reduces the side chains solubility. Addition of alkoxy groups to at least one of the side chain rings can improve solubility of the choromophores while maintaining high non-linear polarization or slightly improving it. One preferential embodiment is placement of two methoxy groups on a ring that is separated by one conjugated bridge and ring from an electron donating group.

TABLE 7
Impact of number of rings on polarizability

| p | α | β |
|---|---|---|
| 2 | 427 | 16067 |
| 3 | 900 | 71292 |
| 4 | 1343 | 121801 |
| 5 | 1699 | 148208 |
| 6 | 2103 | 161156 |

Ionic groups may increase polarization of the disclosed YanLi material when zwitterionic groups are covalently attached to YanLi polymer sidechains. The polarizable units can be nonlinearly polarizable and may be comprised of an aromatic polycyclic conjugated molecule with at least one dopant group, the polarizable units and are placed into a resistive dielectric envelope formed by resistive substituents. In some instances, the resistive substituents provide solubility of the organic compound in a solvent and act to electrically insulate supramolecular structures comprised of YanLi polymers from neighboring supramolecular structures of YanLi polymers. Additionally, said resistive substituents may act to electrically insulate intra-polymer side chains from one another. A non-centrosymmetric arrangement of the dopant group(s) can lead to a strong nonlinear response of the compound's electronic polarization in the presence of an electric field. Additionally, an anisometric molecule or polarizing unit can lead to a strong nonlinear response of the compound's electronic polarization in the presence of an electric field. Resistive substituents (e.g. resistive tails described above) increase the electric strength of these polarizable compounds and breakdown voltage of the dielectric layers made on their basis.

Specific, but non-limiting embodiments are shown in the following table, wherein co-polymer variants are preferentially alternating more or less one-to-one, or more-or-less randomly. Di-block co-polymer embodiments being less preferential to alternating monomers one-to-one and random or near random arrangements.

TABLE 8
Examples of YanLi Polymers

| | |
|---|---|
| 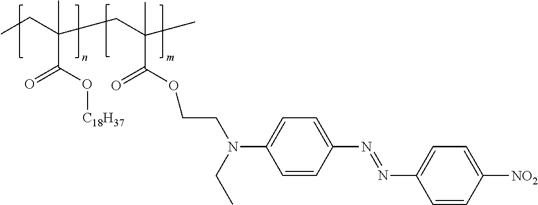 | 80 |
| 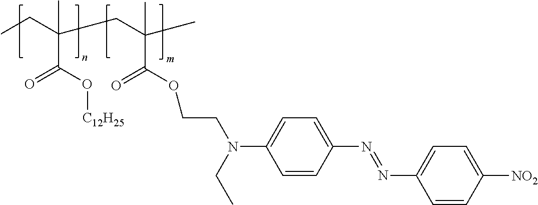 | 81 |
| 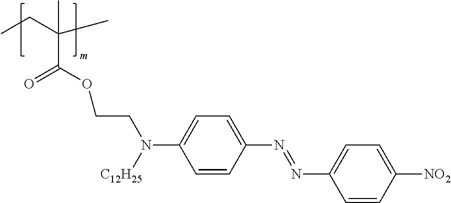 | 82 |
| 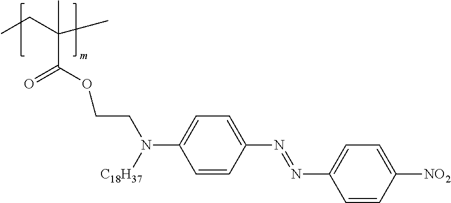 | 83 |
| 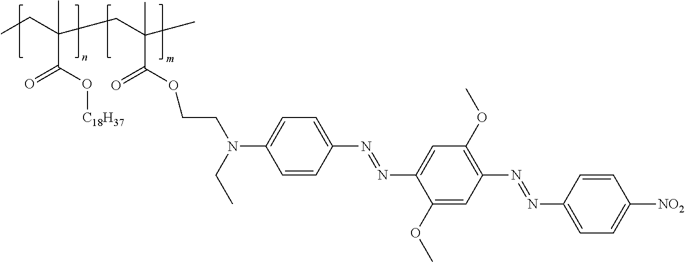 | 84 |
| 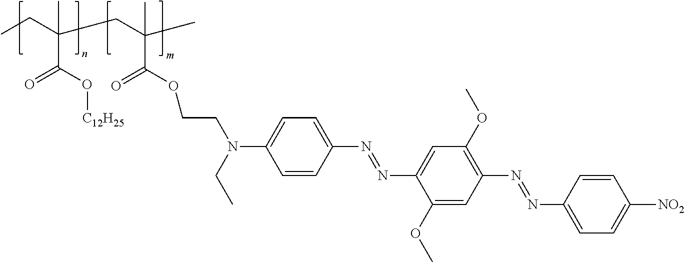 | 85 |
| 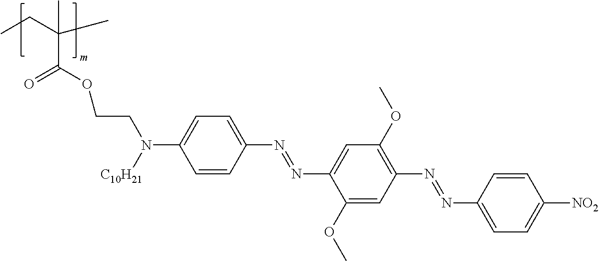 | 86 |
| 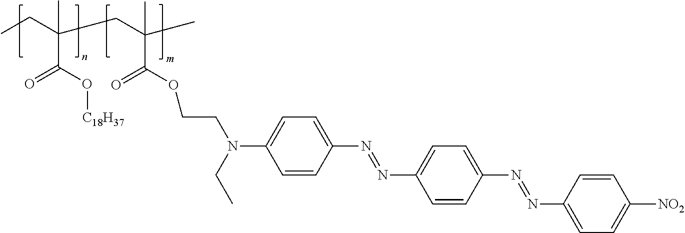 | 87 |
| 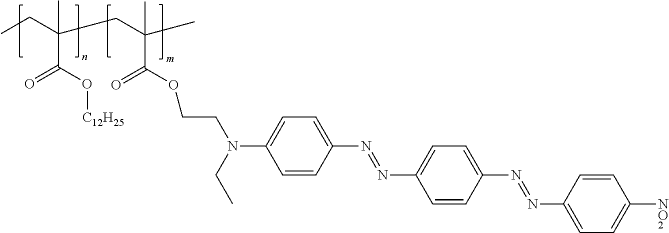 | 88 |
| 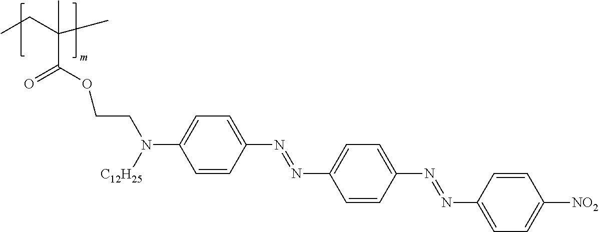 | 89 |
| 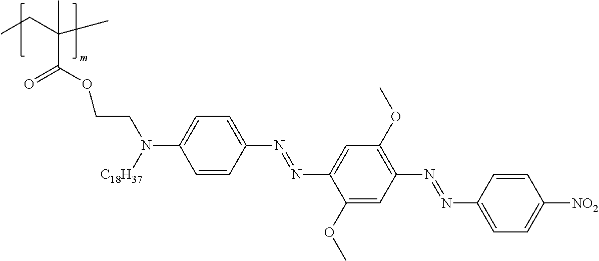 | 90 |
| 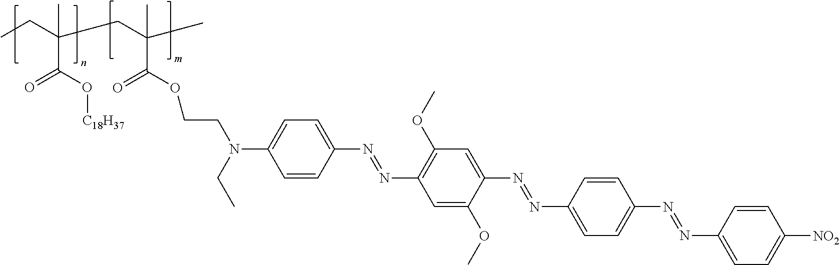 | 91 |
| 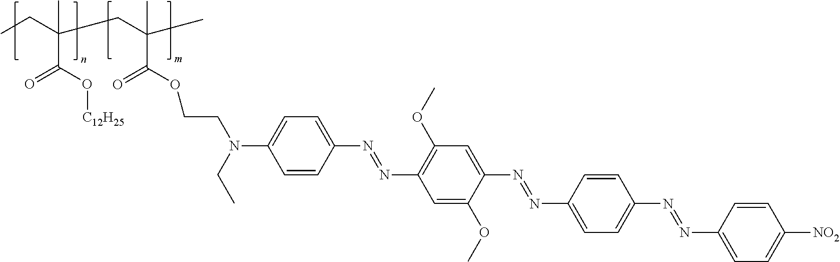 | 92 |
| 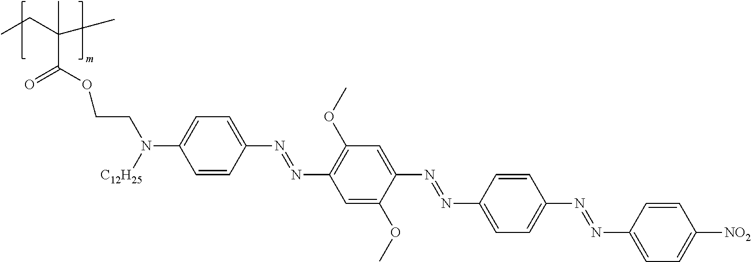 | 93 |
| 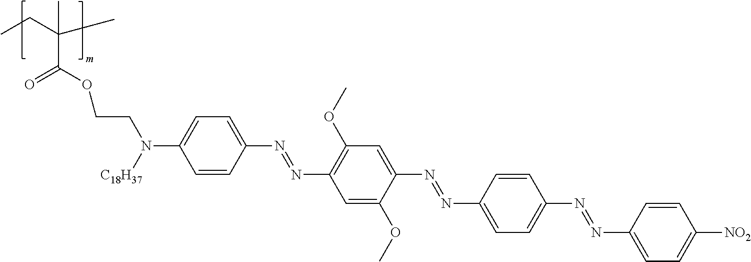 | 94 |
| 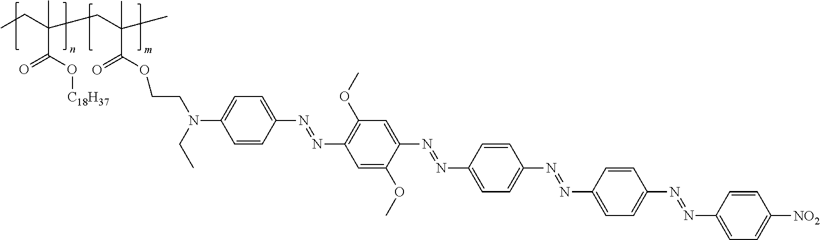 | 95 |
| 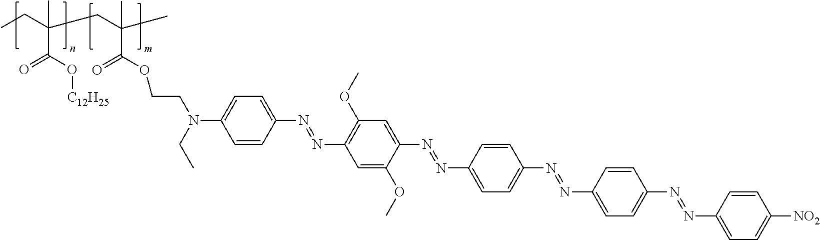 | 96 |
| 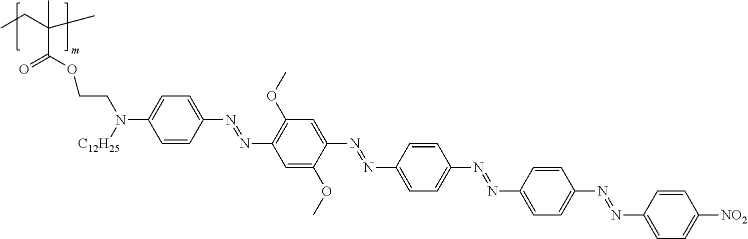 | 97 |
| 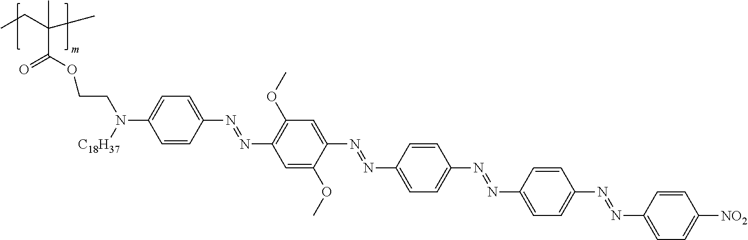 | 98 |
| 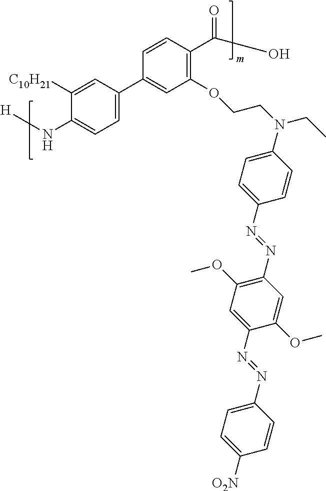 | 99 |
| 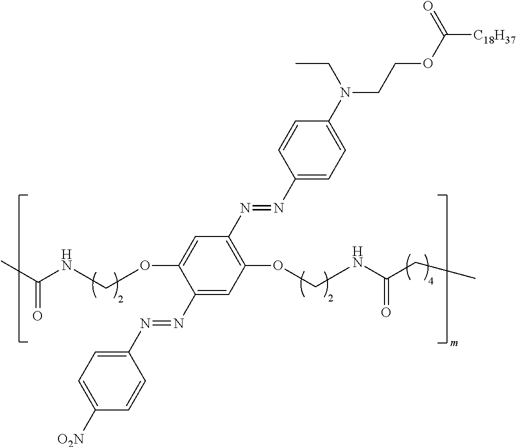 | 100 |
| 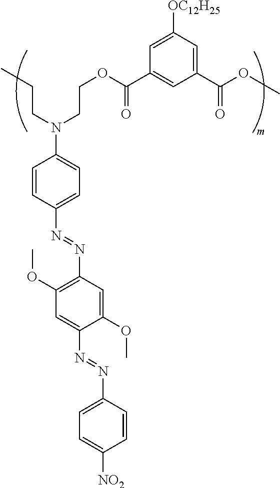 | 101 |

Additional specific examples of YanLi polymers include the following:

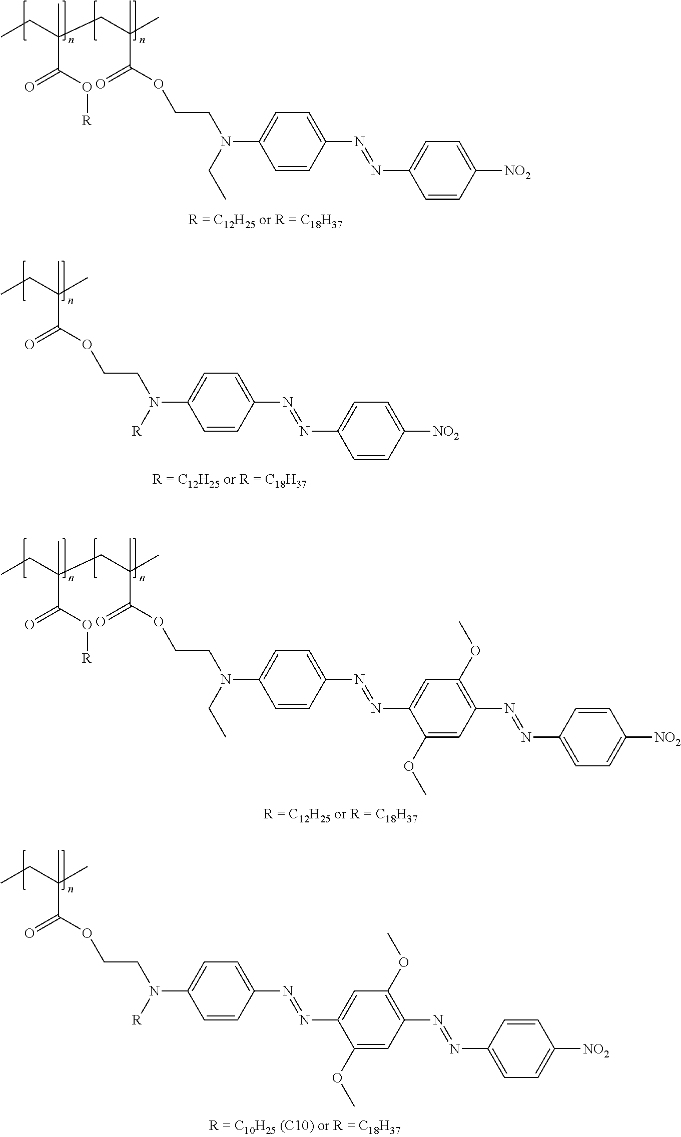

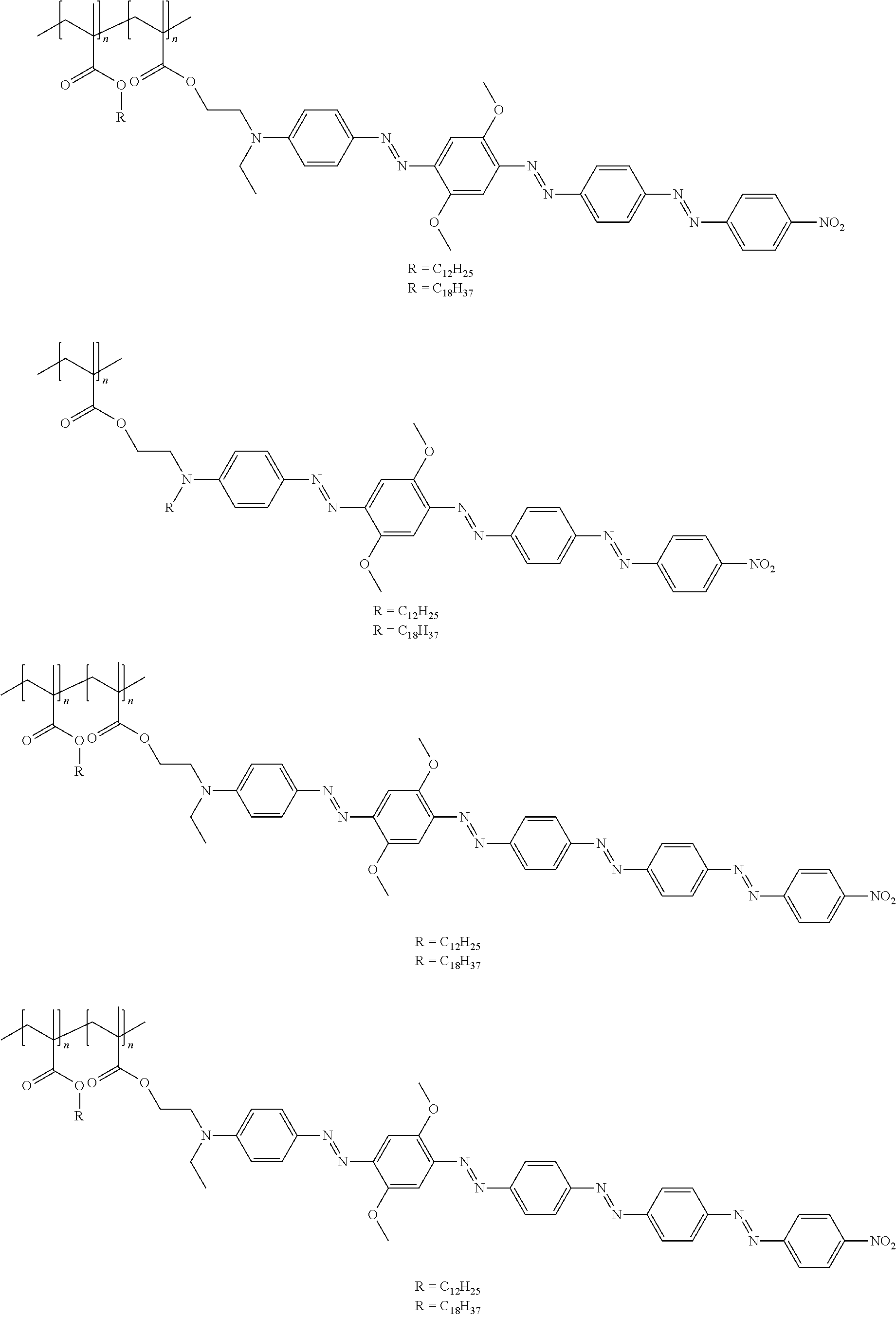

In many embodiments the composite polymer may include a repeating backbone linked to a polarizable unit in the form of one or more azo-dye chromophores. The azo-dye chromophores may consist of phenyl groups in conjugated connection via a conjugated bridge of two heteroatoms (e.g. an azo-bridge), such that there are “n” phenyl groups and “n−1” conjugated bridges where n is an integer between 2 and 16. Side chains may be added to the final backbone product or incorporated into individual monomers that are then polymerized.

These chromophores impart high polarizability due to delocalization of electrons. This polarizability may be enhanced by dopant groups. The composite polymer may further include resistive tails that will provide insulation within the material. In some embodiments, the resistive tails are can be substituted or unsubstituted carbon chains (CₙX₂ₙ₊₁, where “X” represents hydrogen, fluorine, chlorine, or any combination thereof). In some embodiments, the resistive tails may be rigid fused polycyclic aryl groups in order to limit the motion of the side chains, potential stabilizing van der waals interactions between side chains while simultaneously making the material more stable by eliminating voids. In some embodiments, the resistive tails may be rigid in order to limit voids within the material. The synthetic scheme for demonstrative, but not exclusive, species are shown below and are expected to be adaptable to the claimed variations.

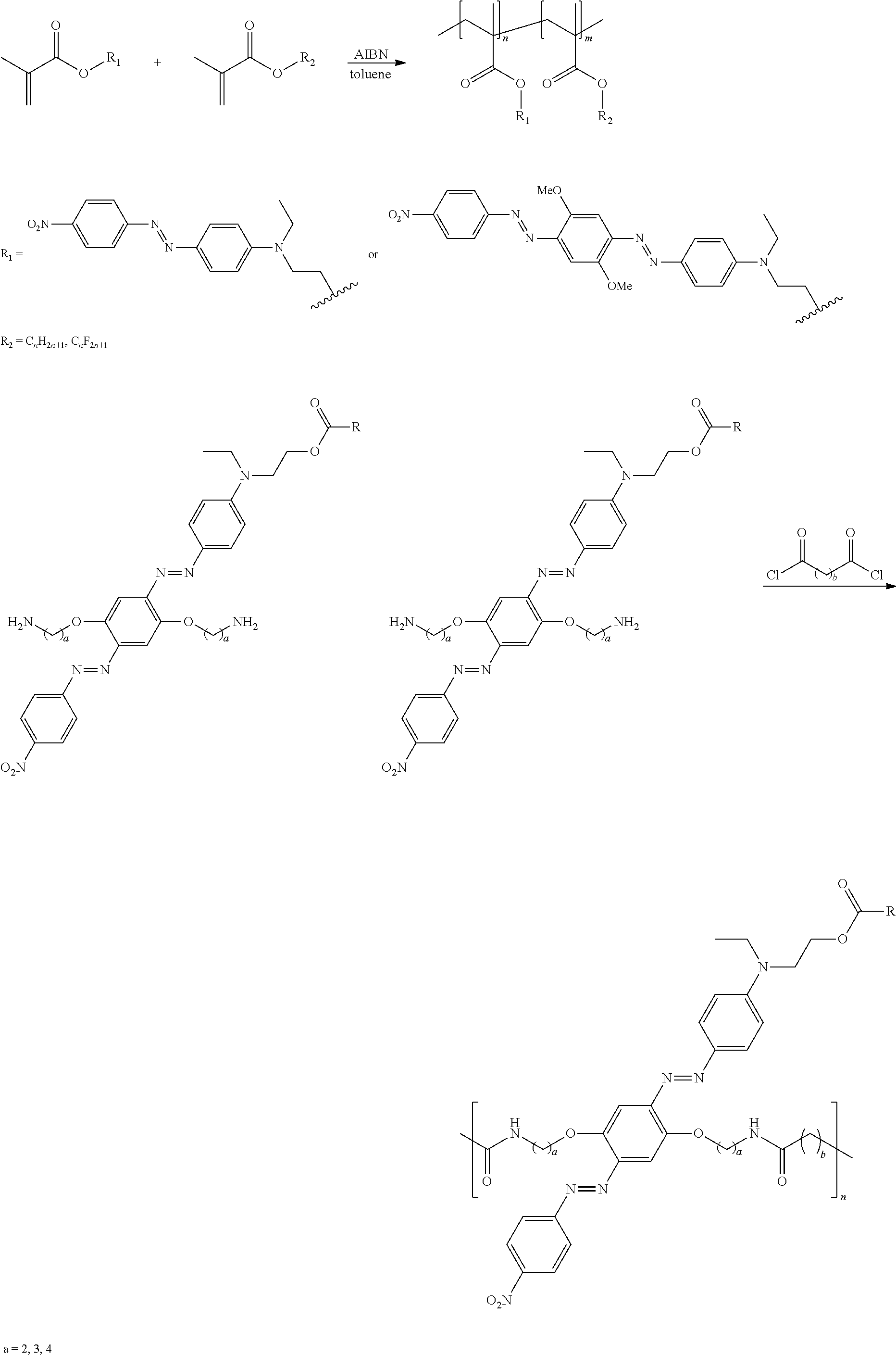

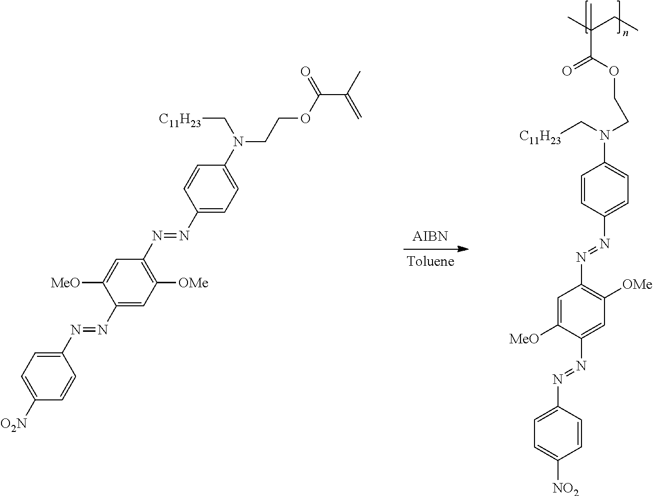

No technical complications are expected in adapting these syntheses to monomers bearing both chromophore and resistive tail, as in structures 80, 81, 84, 87, 88, 91, 92, and 96 from Table 8.

Examples of suitable chromophores include, but are not limited to, Disperse Red-1, Black Hole Quencher-1, and Black Hole Quencher-2. In many of the embodiments it may not be necessary for all monomer units to bear a chromophore, and in some it may be desirable to possess other side chains or sites within the repeating backbone that impart other qualities to the material such as stability, ease of purification, flexibility of finished film, etc.

For embodiments where the chromophores are incorporated as side chains, the resistive tails may be added before the side chains are attached to a finished polymer, after side chains have been chemically added to a finished polymer, or incorporated into the polymer during synthesis by incorporation into monomer units.

For embodiments where the chromophore is part of the backbone the tails may be attached to the finished composite polymer or incorporated into monomer units and added during composite synthesis.

Non-limiting examples of suitable tails are alkyl, haloalkyl, cycloakyl, cyclohaloalkyl, and polyether.

Syntheses of eight different YanLi polymers described herein will be further explained below.

### Example 6: Synthesis of Polymer 1

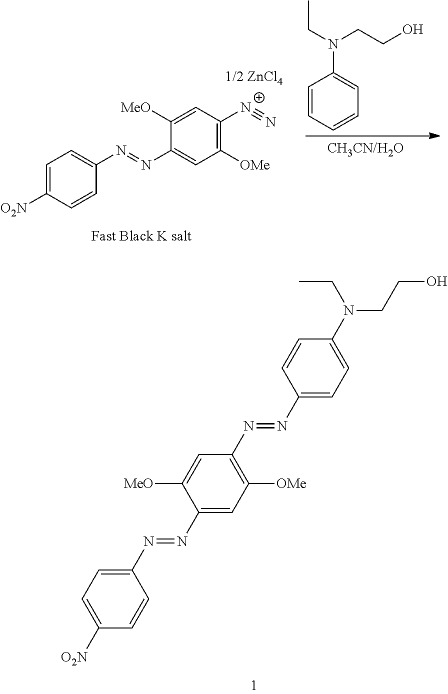 [SMILES: COc1cc([N+]#N)c(OC)cc1/N=N/c1ccc([N+](=O)[O-])cc1 ; CCN(CCO)c1ccccc1 ; CCN(CCO)c1ccc(/N=N/c2cc(OC)c(/N=N/c3ccc([N+](=O)[O-])cc3)cc2OC)cc1]

First compound 1—2-((4-((E)-(2,5-dimethoxy-4-((E)-(4-nitrophenyl) diazenyl)phenyl) diazenyl)phenyl)(ethyl) amino)ethan-1-ol was synthesized from Fast Black K Salt (2,5-Dimethoxy-4-(4-nitrophenylazo)benzenediazonium chloride zinc double salt. Fast Black K Salt (25%, 30 g) was dissolved in 250 mL acetonitrile and 250 mL NaOAc buffer solution (pH=4) and the resulting solution was stirred for 1 hour and then sonicated for 15 min, followed by vacuum filtration. The filtrate was dropwise added to a solution of 2-(ethyl(phenyl)amino)ethan-1-ol (4.1 g in 65 mL acetonitrile) at 0° C. The resultant solution was stirred at room temperature for 16 hours and the precipitate was filtered out and washed with mix solvent of acetonitrile/water (1:1) and dried under vacuum. The product was obtained as a black powder.

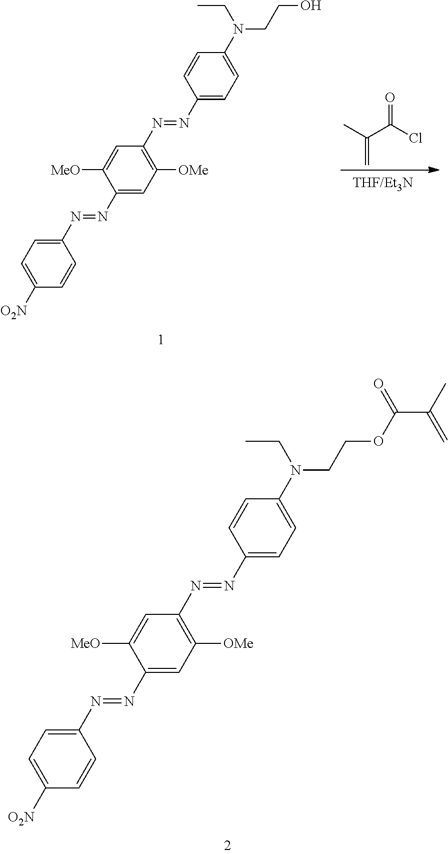

2-((4-((E)-(2,5-dimethoxy-4-((E)-(4-nitrophenyl)diazenyl)phenyl)diazenyl)phenyl)(ethyl) amino)ethyl methacrylate (Compound 2) is then synthesized from compound 1. To the solution of compound 1 (5.0 g) and triethylamine (4.4 mL) in 70 mL THF (anhydrous) at 0° C., was dropwise added a solution of methacryloyl chloride (3.1 mL) in THF (anhydrous, 10 mL). The resulting solution was warmed up to room temperature and was stirred overnight at room temperature. The reaction solution was filtered and THF was used to wash the insoluble; the filtrate was concentrated under vacuum and diluted in dichloromethane. The diluted solution was washed with water and the solvent was removed under vacuum. The crude product was purified with column chromatography and 3.2 g pure product was isolated as a black powder.

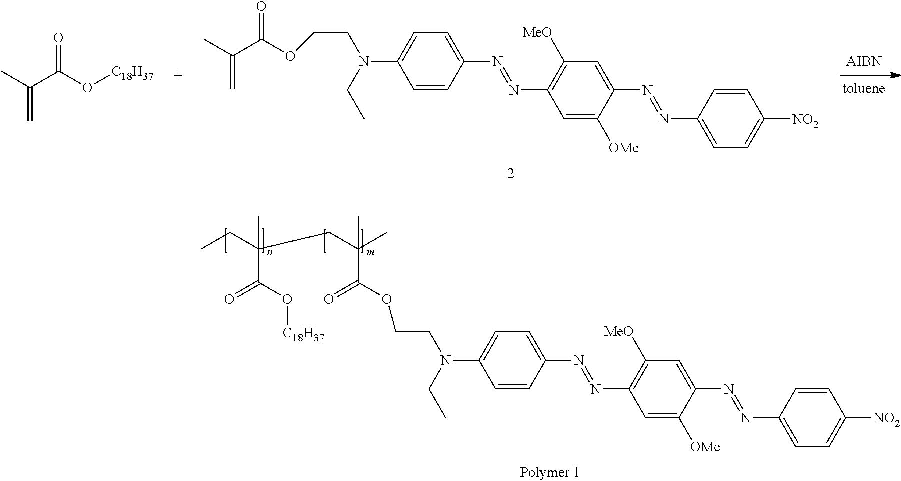

Polymer 1 was then formed from compound 2 as follows. Compound 2 (2.0 g), stearylmethacrylate (1.2 g) and AIBN (160 mg) were dissolved in anhydrous toluene (12 mL) in a sealed flask and the resulting solution was heated to 85° C. for 18 hours and then cooled to room temperature. The polymer was obtained by precipitating in isopropanol.

### Example 7: Synthesis of Polymer 2

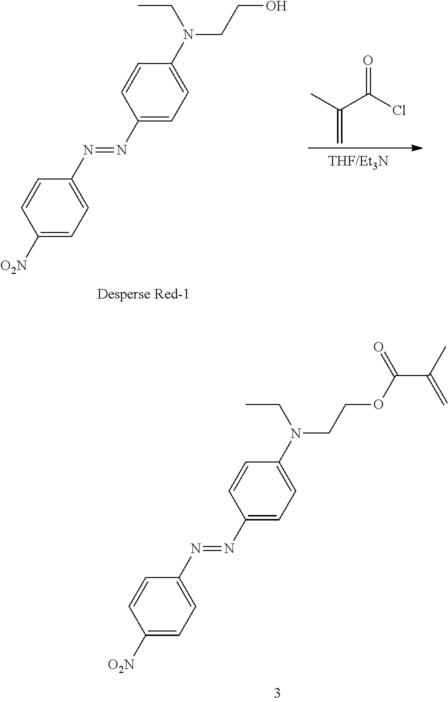

Polymer 2 was synthesized using (E)-2-(ethyl(4-((4-nitrophenyl)diazenyl)phenyl)amino)ethyl methacrylate (compound 3). Compound 3 was synthesized from Disperse Red-1 (2-[N-ethyl-4-[(4-nitrophenyl)diazenyl]anilino]ethanol or C₁₆H₁₈N₄O₃) and methacryloyl chloride using preparation procedure of compound 2.

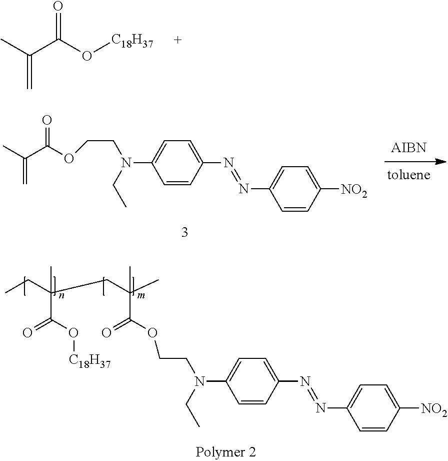

Polymer 2. Polymer 2 was synthesized from compound 3 and stearylmethacrylate using preparation procedure of polymer 1.

### Example 8: Synthesis of Polymer 3

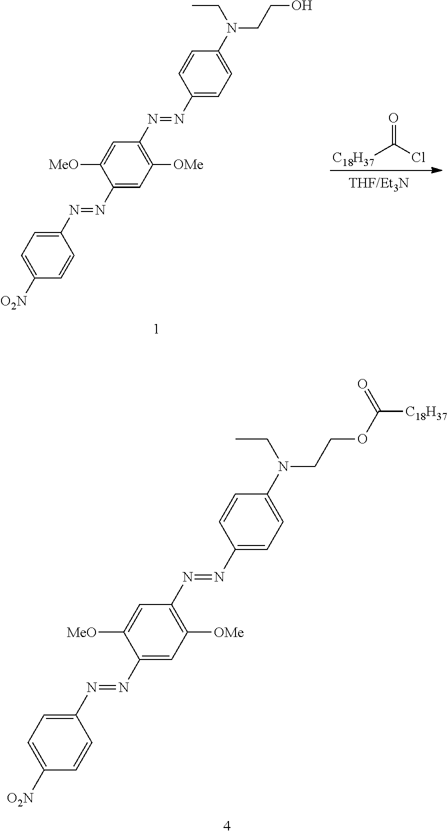

Polymer 3 was synthesized using 2-((4-((E)-(2,5-dimethoxy-4-((E)-(4-nitrophenyl)diazenyl)phenyl)diazenyl)phenyl) (ethyl)amino) ethyl nonadecanoate (compound 4), which was synthesized from compound 1 described above: To a solution of compound 1 (0.5 g) and triethylamine (0.46 mL) in 15 mL THF at 0° C., was dropwise added a solution of stearoyl chloride (1.12 mL) in THF. The resulting solution was warmed up to room temperature and was stirred overnight at room temperature. The reaction solution was filtered and THF was used to wash the insoluble; the filtrate was concentrated under vacuum and residue was taken in dichloromethane. The crude product solution was washed with water and the solvent was removed under vacuum. The crude product was purified with column chromatography.

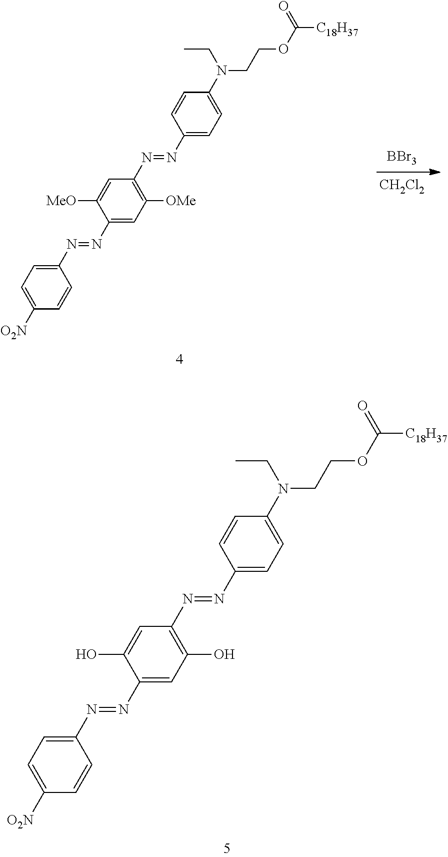

Compound 4 was then used to synthesize 2-((4-((E)-(2,5-dimethoxy-4-((E)-(4-nitrophenyl)diaznyl)pbenyl)diazenyl)phenyl)(ethyl) amino)ethyl nonadecanoate (compound 5). Specifically, compound 4 (1.0 g) was dissolved in dichloromethane (30 mL) and cooled to −78° C.; BBr₃ (0.72 g) was slowly added into the solution. The resulting reaction mixture was slowly warmed to room temperature and was kept at room temperature with stirring for 12 hours. Sodium bicarbonate aqueous solution was injected in the reaction mixture at 0° C. and diluted with dichloromethane. The solution was washed with water and brine, and then concentrated under vacuum. The product was purified via flash column chromatography.

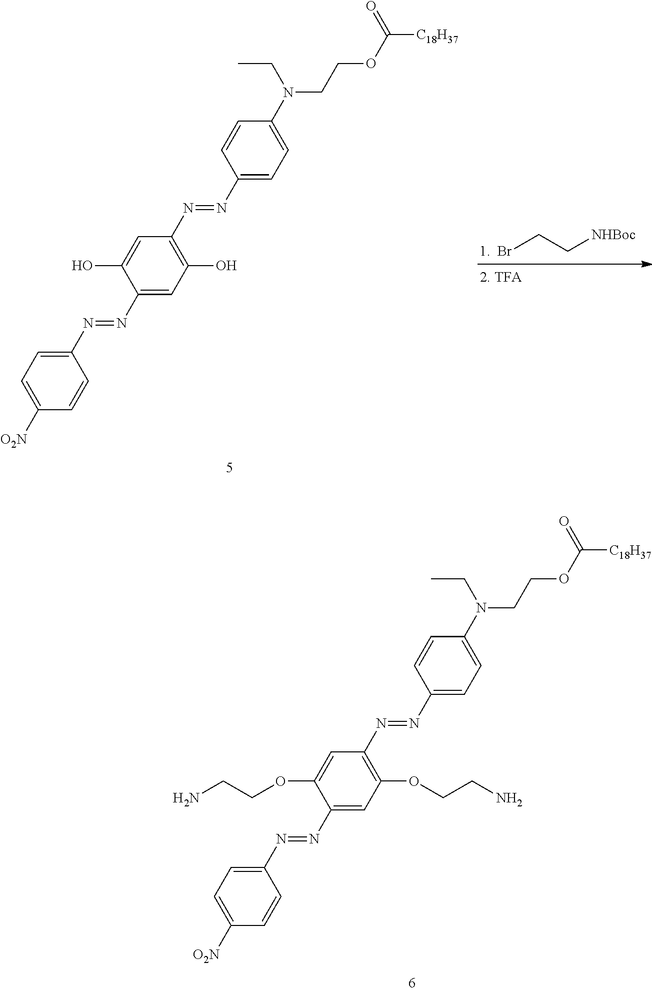

Compound 5 was then used to synthesize compound 6 (2-((4-((E)-(2,5-bis(2-aminoethoxy)-4-((E)-(4-nitrophenyl)diazenyl)phenyl)diazenyl)phenyl) (ethyl)amino)ethyl nonadecanoate). Compound 5 (0.73 g), K₂CO₃ (1.38 g) and tert-butyl (2-bromoethyl)carbamate (0.44 g) were added to dimethylformamide (DMF) (15 mL), and the resulting mixture was stirred at 65° C. overnight. H₂O (400 mL) was added to the reaction mixture and the aqueous layer was extracted with EtOAc (200 mL×2). The combined organic layer was washed with H₂O (100 mL×2) and brine (50 mL), dried over Na₂SO₄, filtered, and concentrated under reduced pressure. The crude product was purified by silica column chromatography. The pure product was dissolved in dichloromethane (10 mL) and TFA (trifluoroacetic acid) (3 mL) and the solution was stirred at room temperature for 2 hours. Then excess reagent and solvent were removed under vacuum. The resulting crude product was neutralized by NaHCO₃ solution, extracted with CH₂Cl₂ (3×50 mL), dried over MgSO₄ and evaporated. The crude product (compound 6) was purified by silica column chromatography.

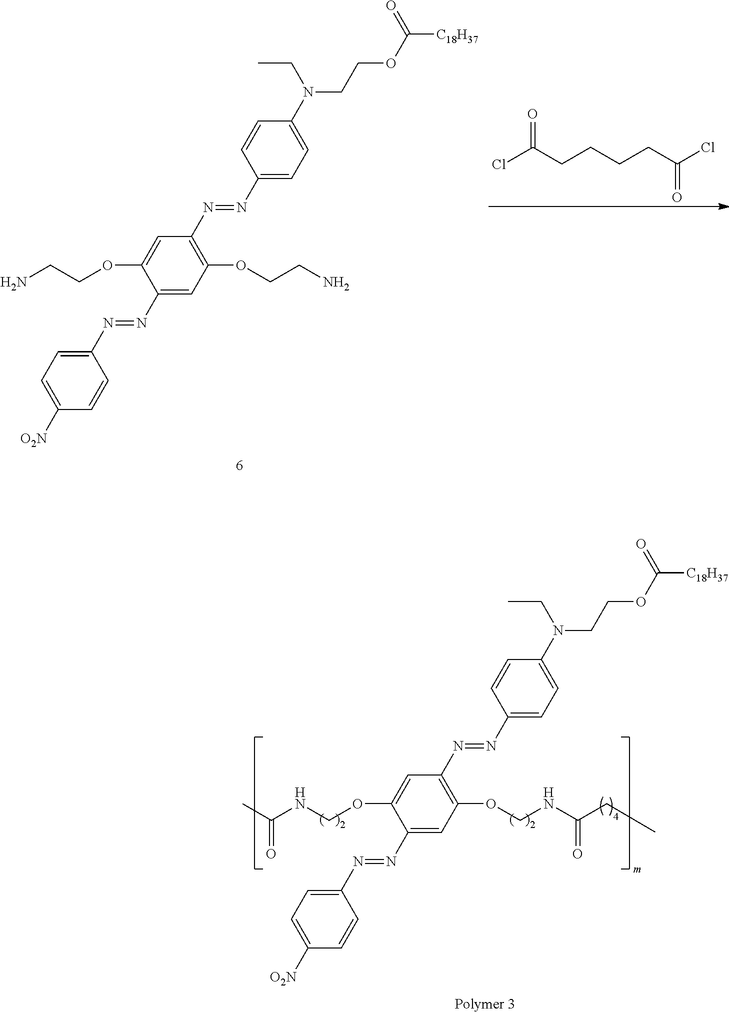

Polymer 3. To the solution of compound 6 (4.1 g) in CH₂Cl₂ (15 mL), was slowly added adipoyl dichloride (0.9 g) at 0° C. After the addition, the solution was allowed to warm to room temperature and stir for 2 hours. The resulting solution was concentrated and dropwise added into isopropanol to precipitate the polymer 3.

### Example 9: Synthesis of Polymer 4

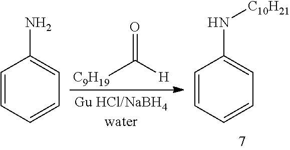

The synthesis of polymer 4 begins by synthesizing N-decylaniline (compound 7).
To a solution containing GuHCl (10 mg, 5 mol %) in H₂O (4 mL), was added decanal (2 mmol) and aniline (2.2 mmol) and the mixture vigorously stirred for 15 min at room temperature. After, NaBH₄ (20 mg, 2.1 mmol) was added, the mixture was stirred for additional 10 min. The reaction mixture was extracted with CH₂Cl₂, dried over Na₂SO₄, concentrated under vacuum and the crude mixture was purified by column chromatography on silica gel to afford the pure products.

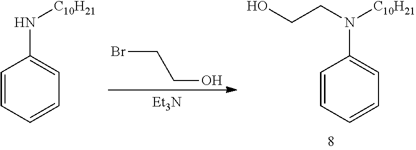

2-(Decyl(phenyl)amino)ethan-1-ol (compound 8) is then synthesized from compound 7.
To a solution of 7 (470 mg, 2.00 mmol) in toluene (5 ml) was added triethylamine (405 mg, 4.00 mmol) and 2-bromoethanol (501 mg, 4.01 mmol), and the mixture was refluxed for 2 h. The resulting mixture was diluted with saturated NH₄Cl and extracted with ethyl acetate. The extract was washed with brine, dried over anhydrous MgSO4, filtered, and concentrated in vacuo. The crude product was purified by silica gel chromatography to give 8.

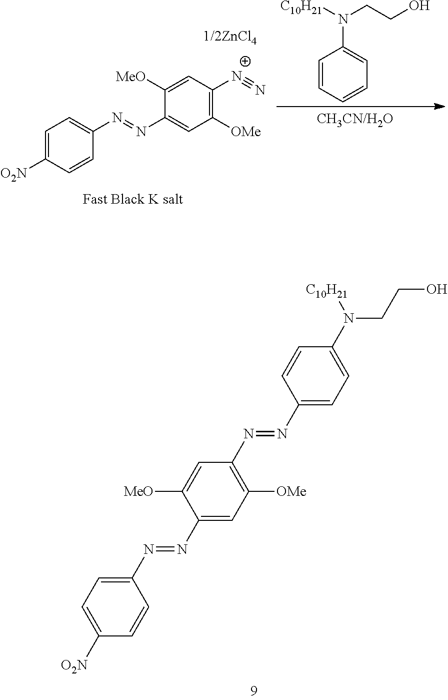

2-(Decyl(4-((E)-(2,5-dimethoxy-4-((E)-(4-nitrophenyl)diazenyl)phenyl)diazenyl) phenyl) amino)ethan-1-ol (compound 9) was then synthesized from Fast Black K Salt and compound 8.
Fast Black K Salt (25%, 30 g) was dissolved in 250 mL acetonitrile and 250 mL NaOAc buffer solution (pH=4) and the resulting solution was stirred for 1 hour and then sonicated for 15 min, followed by vacuum filtration. The filtrate was dropwise added to a solution of compound 8 (6.8 g in 65 mL acetonitrile) at 0° C. The resultant solution was stirred at room temperature for 16 hours and the precipitate was filtered out and washed with mix solvent of acetonitrile/water (1:1) and dried under vacuum. The product was obtained as a black powder.

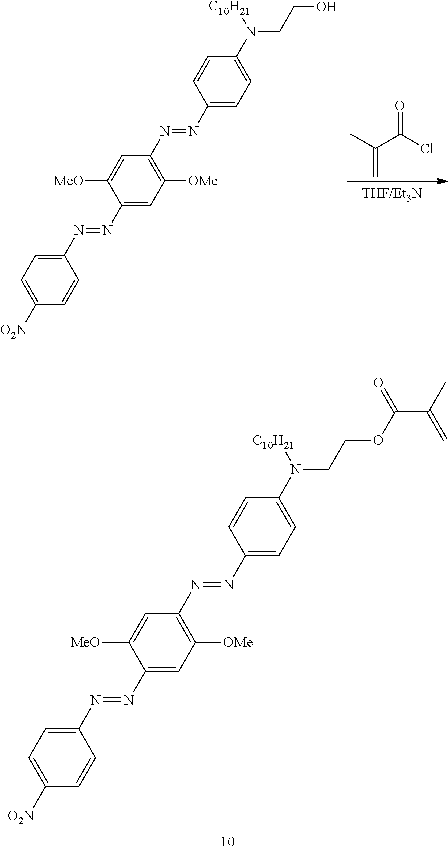

### 2-(decyl(4-((E)-(2,5-dimethoxy-4-((E)-(4-nitrophenyl)diazenyl)phenyl)diazenyl) phenyl) amino)ethyl methacrylate (compound 10)

To the solution of compound 9 (5.0 g) and triethylamine (3.5 mL) in 70 mL THF (anhydrous) at 0° C., was dropwise added a solution of methacryloyl chloride (2.5 mL) in THF (anhydrous, 10 mL). The resulting solution was warmed up to room temperature and was stirred overnight at room temperature. The reaction solution was filtered and THF was used to wash the insoluble; the filtrate was concentrated under vacuum and diluted in dichloromethane. The diluted solution was washed with water and the solvent was removed under vacuum. The crude product was purified with column chromatography and 3.3 g pure product (compound 10) was isolated as a black powder.

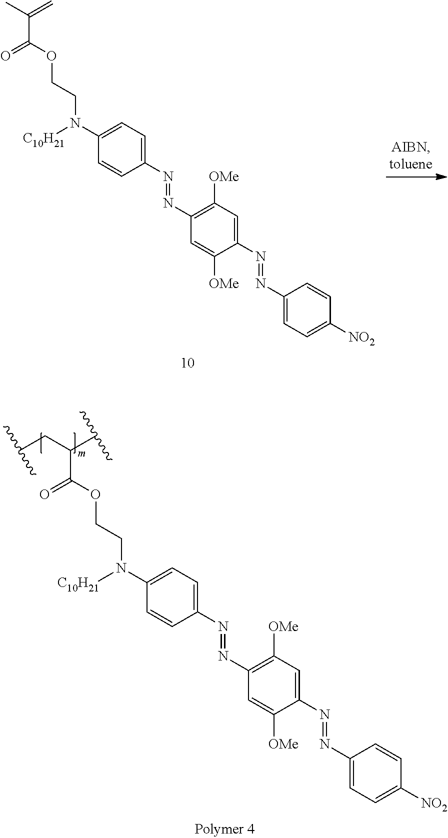

Poly 2-(decyl(4-((E)-(2,5-dimethoxy-4-((E)-(4-nitrophenyl)diazenyl)phenyl)diazenyl) phenyl) amino)ethyl methacrylate (4) (Polymer 4) was then synthesized from compound 10.
Compound 10 (2.0 g) and AIBN (40 mg) were dissolved in anhydrous toluene (6 mL) in a sealed flask and the resulting solution was heated to 85° C. for 18 hours and then cooled to room temperature. The polymer (1.4 g) was obtained by precipitating and washing in 2-isopropanol.

Certain preferred implementations meet one of the following formulae.

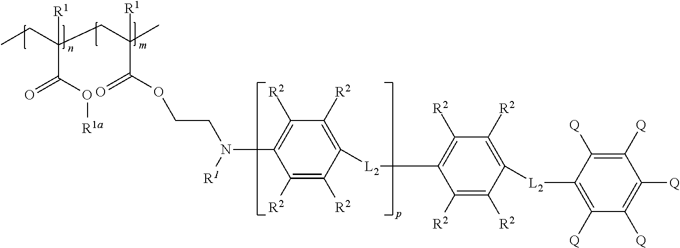

Wherein, each instance of R¹ is independently selected from —H, —OH, -Ak, —OAk, —OAk-Xₒ, or -Ak-Xₒ, or alkoxy; each instance of R² is independently selected from H, —OH, —OAk, —OAk-Xₒ, or Ak; L₂ is a heteroatom bridge in conjugation with the ring system of the side chain (e.g. azo-bridge or —N═N—, alkene bridge or —HC═CH—, and alkyne or —C≡C— bridge), each instance of Q is independently selected from any electron withdrawing group or H, Ak is alkyl or branched alkyl or aryl, X is any halogen, n is 0-150, m is 1-300, o is 1-51, p is 0-10, with the provisio that at least one instance of R¹ must be a resistive tail. Preferred, but not limiting, embodiments of resistive tails include hydrocarbon and halohydrocarbon chains, non-aromatic hydrocarbocycles, and non-aromatic heterocycles. In some embodiments, it may be preferable for the resistive tails to be ridged. In such embodiments, rigid resistive tails maybe non-aromatic carbocycles or non-aromatic heterocycles.

Other embodiments of the invention possess a polyester backbone where resistive tail and Polarizable Unit are each simultaneously side chains to the same monomer. A sample scheme for polyester embodiments is depicted below.

### Example 10: Synthesis of Polymer 5

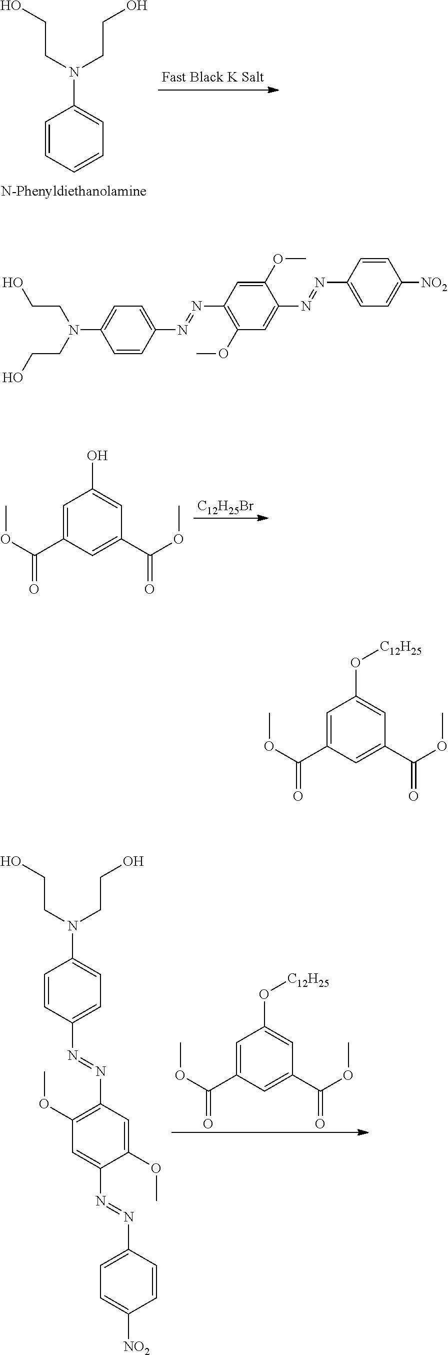

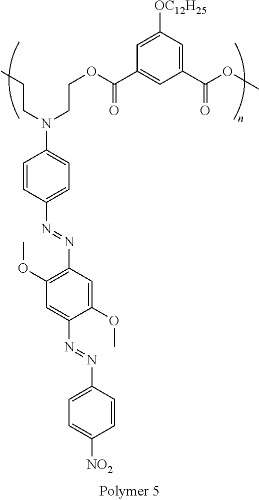

This scheme should be widely adaptable to accommodate a variety of backbones and polarizable units. Such species would meet the following formula.

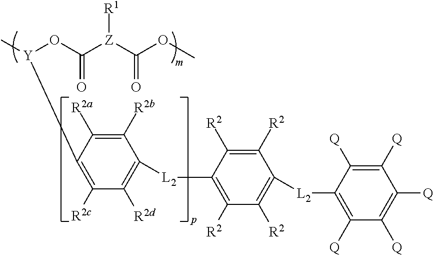

Where each instance of R¹ is independently selected from any alkyl group, each instance of R² is independently selected from —H, —OH, —OAk, or —OAk-Xₒ, L₂ is a heteroatom bridge in conjugation with the ring system of the side chain (e.g. azo-bridge or —N═N—, alkene bridge or —HC═CH—, and alkyne or —C≡C— bridge), each instance of Q is independently selected from any electron donating or electron withdrawing group, Z is substituted or unsubstituted hydrocarbon cyclic or chain linkage, Y is any hydrocarbon chain which may be interrupted by a hetero atom at the point of attachment, m is 1-300, o is 1-51, p is 0-10. Preferred embodiments include m between 60 and 270, and p between 1 and 4.

Other embodiments of the invention possess alternative backbones where resistive tail and Polarizable Unit are each simultaneously side chains to the same monomer. A sample scheme for polyaramid embodiments is depicted below.

### Example 11: Synthesis of Polymer 6

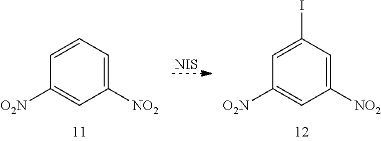

Synthesis of 12: Add 1,3-dinitrobenzene (11) in a round bottom flask with concentrated sulfuric acid (0.5M) with 1.1 equiv. of I₂. Connect to reflux condenser and place reaction vessel in an oil bath heated to 150° C. When the reaction is complete, pour mixture onto ice and filter product. Wash solid with sodium bicarbonate until neutralized and dissolve in dichloromethane until dissolved. Wash with aqueous sodium thiosulfate (10%) solution to remove I₂ and organic solution with magnesium sulfate before filtering. Remove organic solvent under vacuum, recrystallize, and filter to isolate 12.

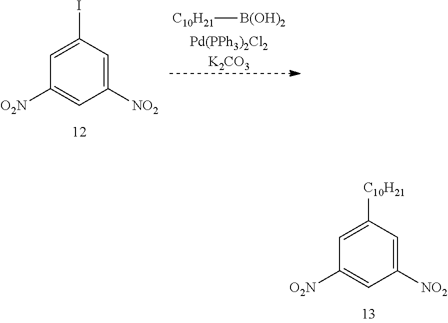

Synthesis of 13: Add 12 (1 equiv.), dodecane boronic acid (1.2 equiv), Pd(PPh₃)₂Cl₂ (0.05 equiv), and potassium carbonate (2 equiv.) into a reaction vessel. Evacuate and backfill with N₂ three times. Add a degassed mixture of toluene and water (10:1) and heat to 80° C. When the reaction is complete, slowly add 1 M aqueous solution of HCl until the aqueous layer is acidic. Extract with dichloromethane (3×) and dry organic fractions with MgSO₄ before filtering. Concentrate the crude reaction mixture and filter through celite before recrystallizing. Filter to isolate product 13.

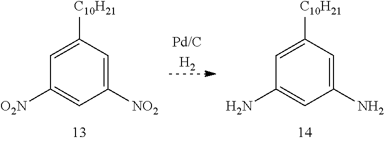

Synthesis of 14: Add 3 (1 equiv) to reaction flask with palladium on carbon (0.1 equiv). Evacuate and backfill with N₂ before adding ethanol (0.1 M). Fill a balloon and needle with H₂ gas and connect to reaction vessel and heat to 80° C. When the reaction is completed, filter through celite making sure the palladium on carbon does not dry. Remove solvent under reduced pressure and recrystallize to purify product 14.

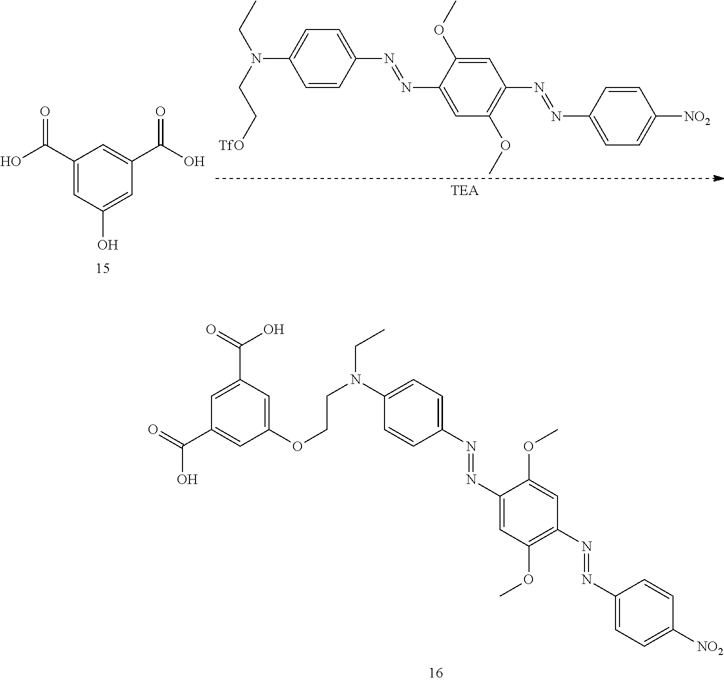 [SMILES: O=C(O)c1cc(O)cc(C(=O)O)c1 ; CCN(CCOS(=O)(=O)C(F)(F)F)c1ccc(/N=N/c2cc(OC)c(/N=N/c3ccc([N+](=O)[O-])cc3)cc2OC)cc1 ; CCN(CCOc1cc(C(=O)O)cc(C(=O)O)c1)c1ccc(/N=N/c2cc(OC)c(/N=N/c3ccc([N+](=O)[O-])cc3)cc2OC)cc1]

Synthesis of 16: Add 15 (1 equiv.) into a round bottom flask and dissolve in solution of dichloromethane/triethylamine (5:1, 0.1 M). Add a solution of 10 (1.1 equiv, 0.5 M) in dichloromethane to the solution of 15. When the reaction is complete, wash with 1M aqueous HCl until acidic and extract with dichloromethane (3 times). Dry organic fractions with MgSO₄, filter, and concentrate under vacuum. Purify through crystallization or SiO₂ column chromatography to isolate 16.

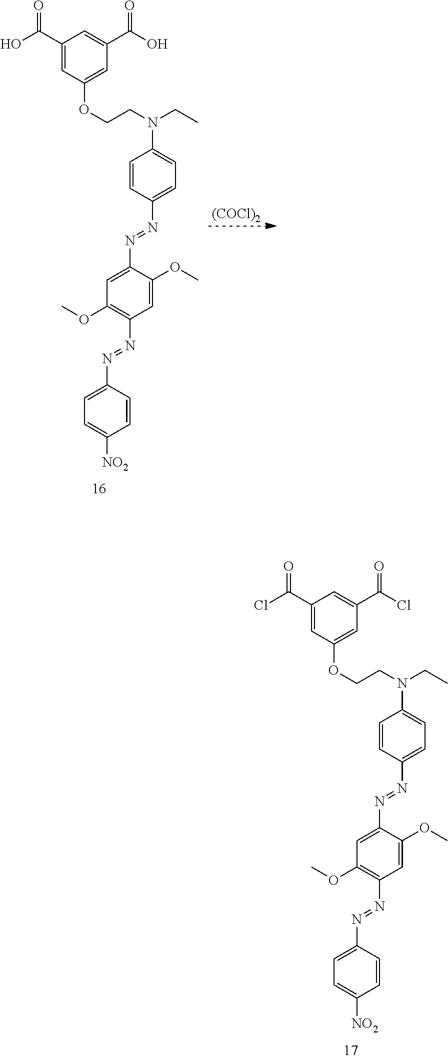

Synthesis of 17: Dissolve 16 (1 equiv.) in dichloromethane (0.1 M) and add oxalyl chloride (2.1 equiv) with a drop of dimethylformamide as catalyst. Let reaction stir at room temperature until bubbling stops. Remove solvent under vacuum to isolate 7.

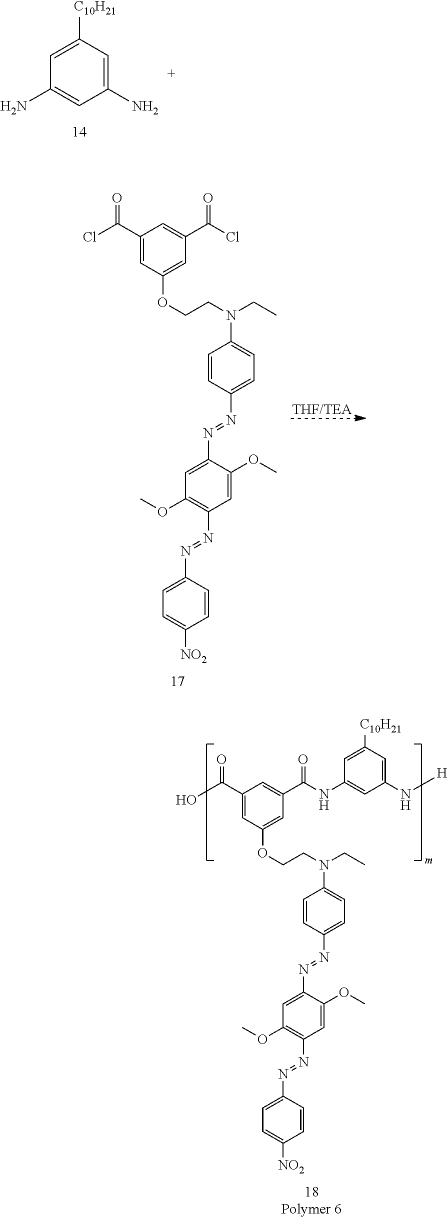

Synthesis of 18: Add 14 (1.0 equiv.) and 17 (1.0 equiv.) to a reaction vessel before adding a mixture of anhydrous tetrahydrofuran and triethylamine (5:1, 0.1 M). When the reaction is complete, concentrate under reduced pressure and precipitate to isolate 18.

The scheme for Polymer 6 should be widely adaptable to accommodate a variety of backbones and polarizable units. Such species would meet the following formula.

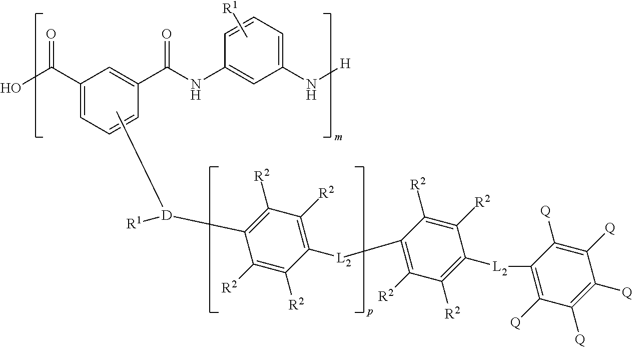

Where each instance of R¹ is independently selected from any alkyl or alkoxyl group or —H, each instance of R² is independently selected from —H, —OH, —OAk, or —OAk-Xₒ, L₂ is a heteroatom bridge in conjugation with the ring system of the side chain (e.g. azo-bridge or —N═N—, alkene bridge or —HC═CH—, and alkyne or —C≡C— bridge), Q is selected from any electron withdrawing group, D is any hydrocarbon chain which may be interrupted by hetero atoms at the point of backbone attachment and side chain attachment, m is 1-300, o is 1-51, p is 0-10. Preferred embodiments include m between 60 and 270, and p between 1 and 4.

### Examples 12 & 12b: Synthesis of Polymers 7a & 7b

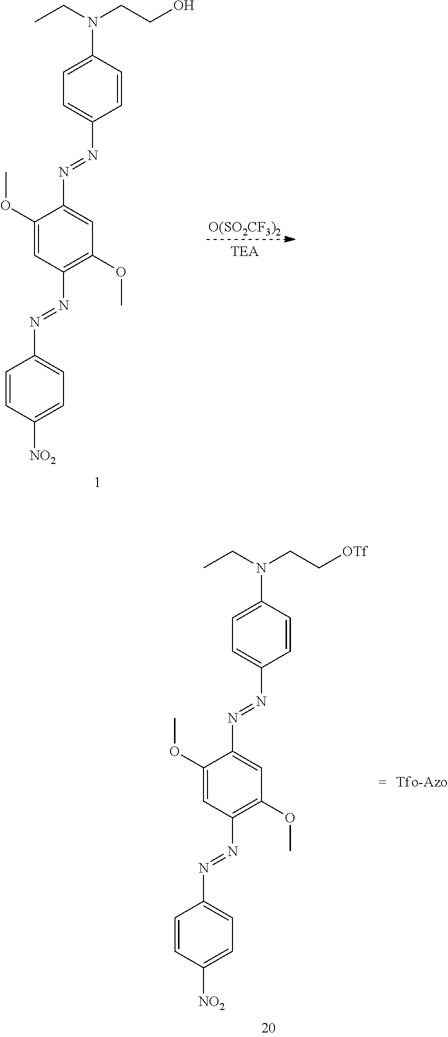

Synthesis of 20: Dissolve 1 (1 equiv.) in a solution of CH₂Cl₂ (0.1 M) and triethyl amine (1 equiv.) and let stir for 10 min. Add trifluoromethanesulfonic anhydride (1.1 equiv.) slowly and let stir for 30 min. Wash reaction mixture with aqueous HCl (1M), extract with dichloromethane, and dry with MgSO₄. Remove solvent to isolate 20.

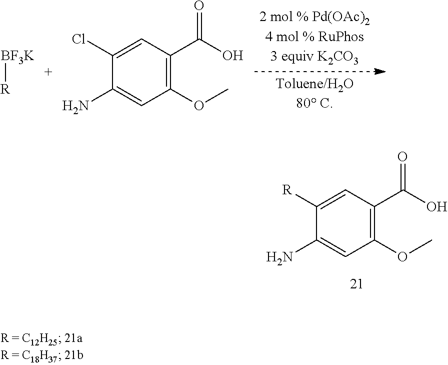

Synthesis of 21a-21b: Add 4-amino-5-chloro-2-methoxybenzoic acid, alkyl potassium trifluoroborate salt, Pd(OAc)₂ (0.02 equiv.), RuPhos (0.04 equiv.), and K₂CO₃ (3 equiv.) to a reaction flask. Evacuate this flask and backfill with N₂ three times. In a separate flask, combine toluene and water (0.3 M; 10:1) and sparge with N₂ for 60 minutes. Transfer this solution mixture to the reaction flask and place this into a preheated oil bath at 80° C. When the reaction is complete, it should cool to room temperature before carefully adding 1M HCl until the aqueous layer has been acidified. Extract this with CH₂Cl₂ and dry the organic fractions with MgSO₄ before filtering. Remove the organic solvent under reduced pressure and isolate the product by silica gel chromatography to isolate 21a or 21b.
The procedure below is adapted from: Molander G A, Sandrock D L. “Potassium trifluoroborate salts as convenient, stable reagents for difficult alkyl transfers”, Current Opinion In Drug Discovery & Development 2009; 12(6): pages 811-823;

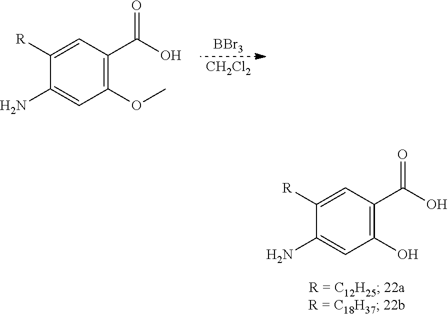

Synthesis of 22a-22b: Dissolve 21a or 21b in anhydrous CH₂Cl₂ (0.3M) in an oven dried round bottom flask. Cool this solution to 0° C. in an ice bath and add boron tribromide (1M in CH₂Cl₂) slowly. Once addition of BBr₃ is complete, remove the ice bath and let the reaction mixture to warm up to ambient temperature for 12 hours. When the reaction is completed, cool it back to 0° C. and slowly add methanol to quench any excess BBr₃ present. Wash this reaction with distilled water and collect the organic fraction. Dry with MgSO₃, filter, then remove solvent under vacuum. Purify by either recrystallization or silica gel chromatography to isolate 22a or 22b

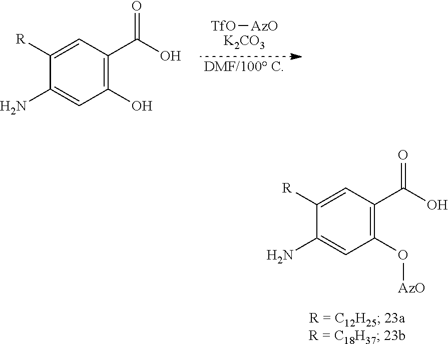

Synthesis of 23a-23b: Add either 22a or 22b (1 equiv.) and K₂CO₃ (2 equiv) into a round bottom flask and dissolve in solution of anhydrous DMF (0.1 M). Dissolve 20 (1.1 equiv, 0.5 M) in DMF and add this to the previous reaction mixture. Place the reaction mixture in a preheated 100° C. oil bath and stir until the reaction is completed. When the reaction is complete, wash with 1M aqueous HCl until acidic and extract with CH₂Cl₂ (3 times). Dry organic fractions with MgSO₄, filter, and concentrate under vacuum. Purify through crystallization or SiO₂ column chromatography to isolate 23a or 23b.

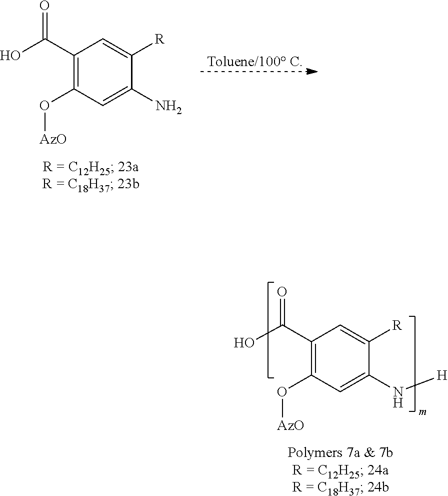

Synthesis of 24a-24b: Dissolve monomers 23b or 23b in toluene (0.4 M) in a round bottom flask equipped with a Dean Stark trap to remove water formed during the reaction and stir at 110° C. in a preheated oil bath. When the reaction is complete, purify the polymer through precipitation and isolate through filtration or centrifugation.

The scheme for Polymers 7a and 7b should be widely adaptable to accommodate a variety of backbones and polarizable units. Such species would meet the following formula.

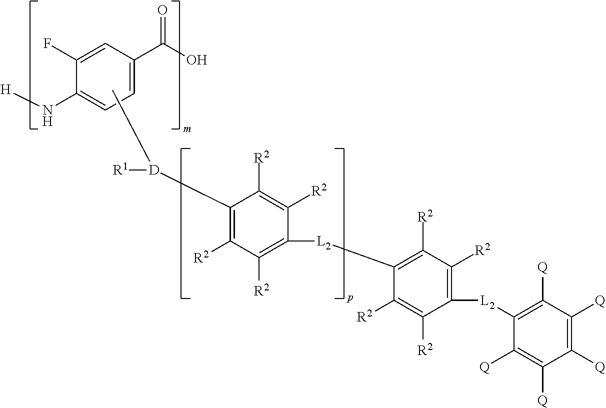

Where each instance of R¹ is independently selected from —H or any alkyl or alkoxyl group, each instance of R² is independently selected from —H, —OH, —OAk, or —OAk-Xₒ, L₂ is a heteroatom bridge in conjugation with the ring system of the side chain (e.g. azo-bridge or —N═N—, alkene bridge or —HC═CH—, and alkyne or —C≡C— bridge), Q is selected from any electron withdrawing group, D is any hydrocarbon chain which may be interrupted by hetero atoms at the point of backbone attachment and side chain attachment, m is 1-300, o is 1-51, p is 0-10. Preferred embodiments include m between 60 and 270, and p between 1 and 4.

### Example 13: Synthesis of Polymer 8

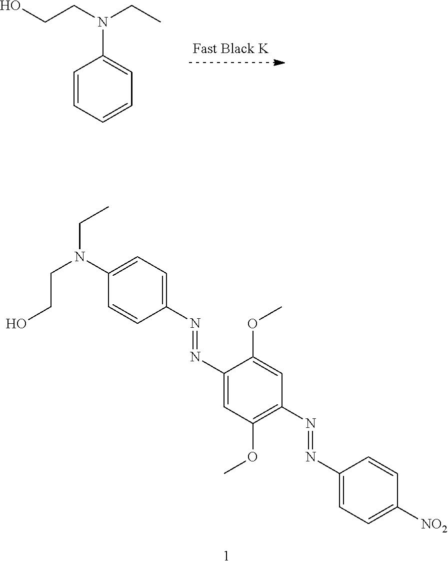 [SMILES: CCN(CCO)c1ccccc1 ; CCN(CCO)c1ccc(/N=N/c2cc(OC)c(/N=N/c3ccc([N+](=O)[O-])cc3)cc2OC)cc1]

Synthesis of 1: Dissolve Fast Black K Salt in acetonitrile and NaOAc buffer solution (pH=4) and stir the resulting solution for 1 hour, followed by vacuum filtration. Add the filtrate dropwise to a solution of 2-(ethyl(phenyl)amino)ethan-1-ol at 0-5° C. Stir the solution at room temperature for 16 hours before filtering the precipitate and wash with a mixture of acetonitrile/water (1:1) and dried under vacuum.

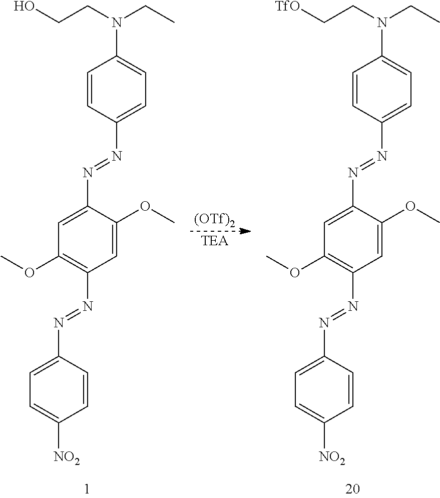

Synthesis of 20: Dissolve 1 (1 equiv.) in a solution of dichloromethane (0.1 M) and triethyl amine (1 equiv.) and let stir for 10 min. Add trifluoromethanesulfonic anhydride (1.1 equiv.) slowly and let stir for 30 min. Wash reaction mixture with aqueous HCl (1M), extract with dichloromethane, and dry with MgSO₄. Remove solvent to isolate 20.

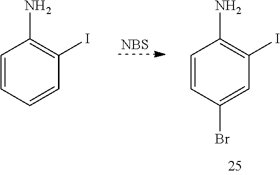

Synthesis of 25: Add 1-iodo-2-aminobenzene to a round bottom flask dissolved in dichloromethane (0.1 M) with 1.1 equiv. of N-bromosuccinimide. Let the reaction stir at room temperature for one hour. When the reaction is complete, wash with aqueous HCl (1 M) and extract with dichloromethane. Dry using MgSO₄, filter, and remove organic solvent under reduced pressure to isolate 25.

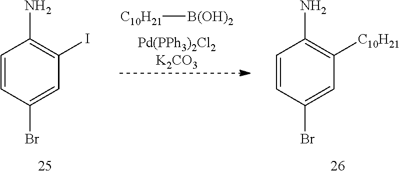

Synthesis of 26: Add 25 (1 equiv.), dodecane boronic acid (1.2 equiv), Pd(PPh₃)₂Cl₂ (0.05 equiv), and potassium carbonate (2 equiv.) into a reaction vessel. Evacuate and backfill with N₂ three times. Add a degassed mixture of toluene and water (10:1) and heat to 80° C. When the reaction is complete, slowly add 1 M aqueous solution of HCl until the aqueous layer is acidic. Extract with dichloromethane (3×) and dry organic fractions with MgSO₄ before filtering. Concentrate the crude reaction mixture and filter through celite before recrystallizing. Filter to isolate product 26.

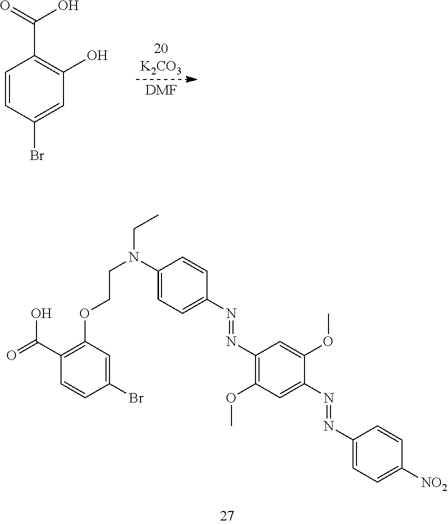

Synthesis of 27: Add 4-bromosalicylic acid (1 equiv.) into a round bottom flask with potassium carbonate (1.5 equiv.) and dissolve in solution of dimethylformamide (0.1 M) and heat the reaction to 100° C. for 2 hours. When the reaction is complete, wash with 1M aqueous HCl until acidic and extract with dichloromethane (3 times). Dry organic fractions with MgSO₄, filter, and concentrate under vacuum. Purify through crystallization or SiO₂ column chromatography to isolate 27.

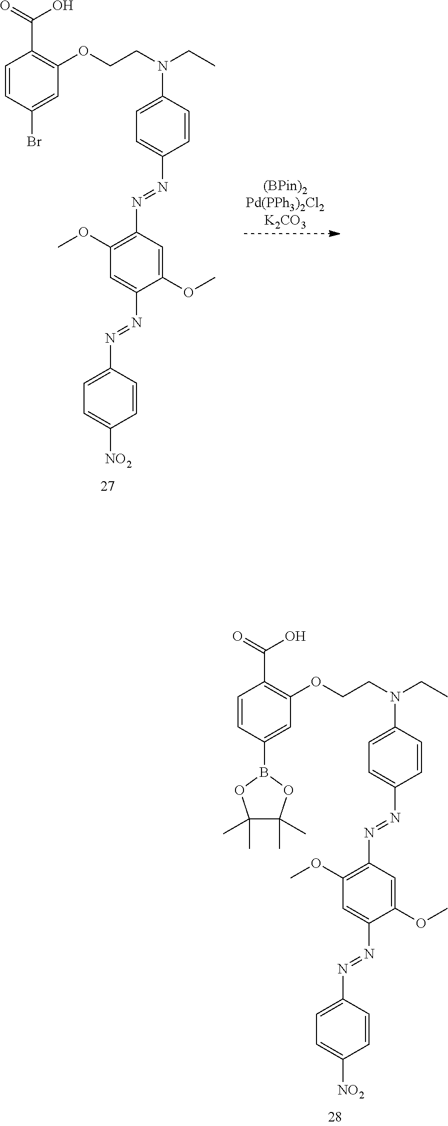

Synthesis of 28: Add 27 (1 equiv.), bispinacolborane (1.5 equiv), Pd(PPh₃)₂Cl₂ (0.05 equiv), and potassium carbonate (2 equiv.) into a reaction vessel. Evacuate and backfill with N₂ three times. Add a degassed mixture of toluene and water (10:1) and heat to 80° C. When the reaction is complete, slowly add 1 M aqueous solution of HCl until the aqueous layer is acidic. Extract with dichloromethane (3×) and dry organic fractions with MgSO₄ before filtering. Concentrate the crude reaction mixture and filter through celite before recrystallizing. Filter to isolate product 28.

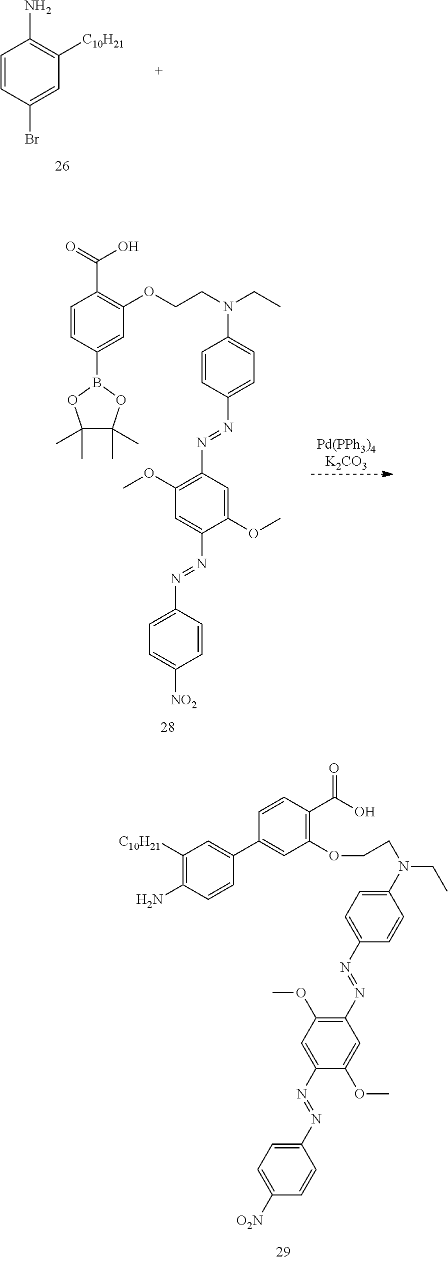

Synthesis of 29: Add 28 (1 equiv.), 26 (1 equiv), Pd(PPh₃)₄ (0.05 equiv), and potassium carbonate (2 equiv.) into a reaction vessel. Evacuate and backfill with N₂ three times. Add a degassed mixture of toluene and water (10:1) and heat to 80° C. When the reaction is complete, slowly add 1 M aqueous solution of HCl until the aqueous layer is acidic. Extract with dichloromethane (3×) and dry organic fractions with MgSO₄ before filtering. Concentrate the crude reaction mixture and filter through celite before recrystallizing. Filter to isolate product 29.

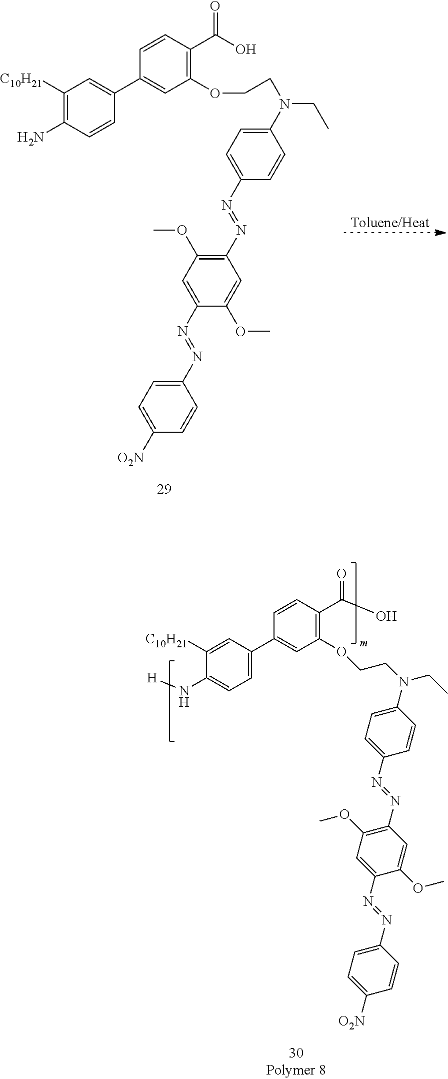

Synthesis of 30: Add 29 (1.0 equiv.) to a reaction vessel before adding toluene and (0.1 M). Connect the reaction vessel to a and dean-stark apparatus and reflux condenser and heat to 150° C. When the reaction is complete, concentrate the crude reaction mixture under reduced pressure and precipitate polymer into hexane to isolate 30.

The scheme for Polymer 8 should be widely adaptable to accommodate a variety of backbones and polarizable units. Such species would meet the following formula.

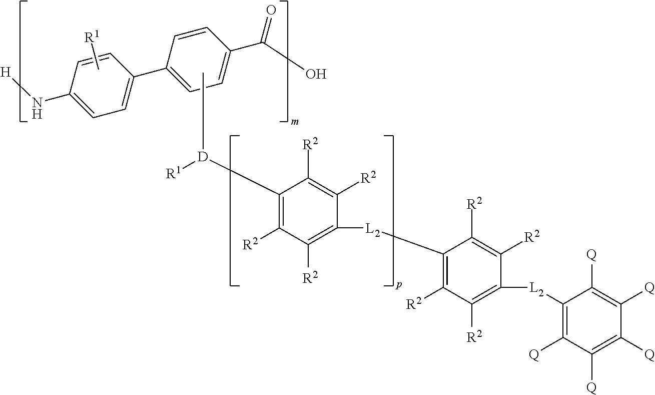

Where each instance of R′ is independently selected from —H or any alkyl or alkoxyl group, each instance of R² is independently selected from —H, —OH, —OAk, or —OAk-Xₒ, L₂ is a heteroatom bridge in conjugation with the ring system of the side chain (e.g. azo-bridge or —N═N—, alkene bridge or —HC═CH—, and alkyne or —C≡C— bridge), Q is selected from any electron withdrawing group, D is any hydrocarbon chain which may be interrupted by hetero atoms at the point of backbone attachment and side chain attachment, m is 1-300, o is 1-51, p is 0-10. Preferred embodiments include m between about 60 and 270, and p between 1 and 4.

composite organic compound characterized by polarizability and resistivity has a general structural formula:

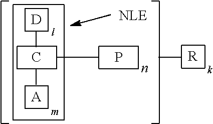

C is a chromophore fragment comprising an aromatic substituent independently selected from the group consisting of six-membered aromatic rings, five-membered heteroaromatic rings, fused ring systems containing at least one six-membered aromatic ring, and fused ring systems containing at least one five-membered heteroaromatic ring having one heteroatom selected from the group consisting of O, N, S and Se,

C has the general structure:

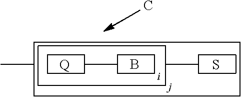

each Q comprises an aromatic substituent independently selected from the group consisting of six-membered aromatic rings, five-membered heteroaromatic rings, fused ring systems of at least one six-membered aromatic ring, and fused ring systems of at least one five-membered heteroaromatic ring having one heteroatom selected from the group consisting of O, N, S and Se,
B comprises a conjugated functional group, the value of i for each B is an integer between zero and three, inclusively, and j is from one to nine, inclusive; and
R, D, A, and B may independently be attached to a member of a heteroaromatic ring alpha to a heteroatom, and when Q is an aromatic ring, B is attached to a member of said aromatic ring para to R or another B, and
D and A can independently be ortho, meta, or para to B on Q.
D comprises an electron donating group capable of releasing electrons into said conjugated aromatic system; 1 is an integer between zero and three, inclusively,
A comprises an electron accepting group capable of pulling electrons from said conjugated aromatic system; m is an integer between zero and three, inclusively,
R is selected from the group consisting of straight-chained or branched alkyl, alkoxy, alkylthio, alkylamino, and fluoro-alkyl group containing from one to thirty carbon atoms attached to said composite organic compound wherein R may independently be attached to C and P by an alkyl moiety or connecting group, k is the number of R groups attached to the composite organic compound wherein R may independently be attached to C and P by an alkyl moiety or a connecting group, the value of k is an integer between 0 and 15, inclusively,
S comprises a heteroaromatic substituent selected from the group consisting of five-membered heteroaromatic rings having one heteroatom selected from the group consisting of O, N, S and Se, fused ring systems containing at least one five-membered heteroaromatic ring having one heteroatom selected from the group consisting of 0, S and Se, fused ring systems containing at least one five-membered heteroaromatic ring having two to four N heteroatoms, fused ring systems containing all five-membered heteroaromatic rings having one heteroatom selected from the group consisting of O, N, S and Se, pyrimidine and purine, so that S is tricyanovinylated at a ring position alpha to a heteroatom;
P is a polycyclic conjugated molecular fragments having two-dimensional flat form and self-assembling by pi-pi stacking in a column-like supramolecule, n is the number of the polycyclic conjugated molecular fragments which is equal to 0, 2, or 4.

### Example 14

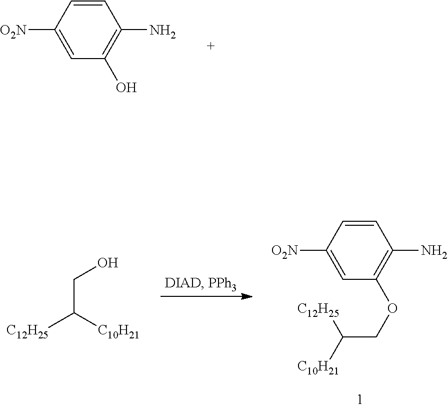

2-decyl-1-tetradecanol (1 equiv.), PPh₃ (2 equiv.), and DIAD (2.3 equiv.) were dissolved in THF and stirred in an ice bath. Then, 2-amino-5-nitrophenol was added and the reaction was allowed to warm to ambient temperature and stirred for 24 h. The reaction mixture was diluted with hexanes and filtered through diatomaceous earth. The filtrate was concentrated and purified on silica gel to give 1.

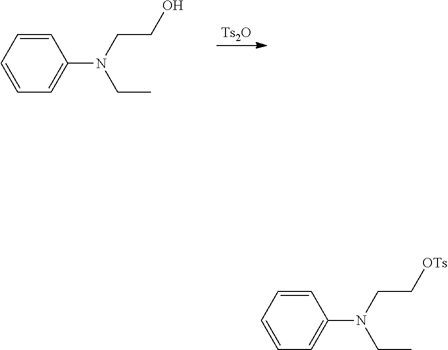 [SMILES: "Ts2O" ; CCN(CCO)c1ccccc1 ; CCN(CCOS(=O)(=O)c1ccc(C)cc1)c1ccccc1]

2-(N-ethylanilino)ethanol (1 equiv.), NaH (2 equiv.), and tosyl chloride (1.2 equiv.) were dissolved in DMF and stirred at room temperature for 18 h. The solution was processed through an aqueous workup. The organics were dried over MgSO₄ and the solvents were removed en vacuo.

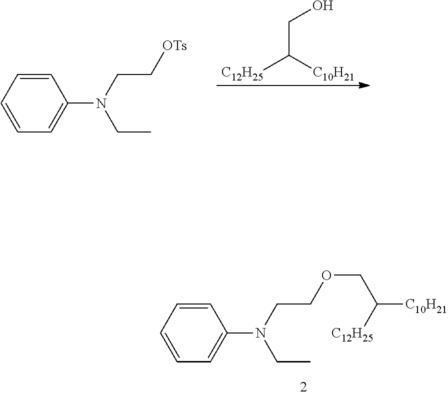

2-decyl-1-tetradecanol (1 equiv.), NaH (2 equiv.), and tosylated 2-(N-ethylanilino)ethanol (1 equiv.) were dissolved in THF and stirred at room temperature for 18 h. The solution was processed through an aqueous workup. The organics were dried over MgSO₄ and the solvents were removed en vacuo to give 2.

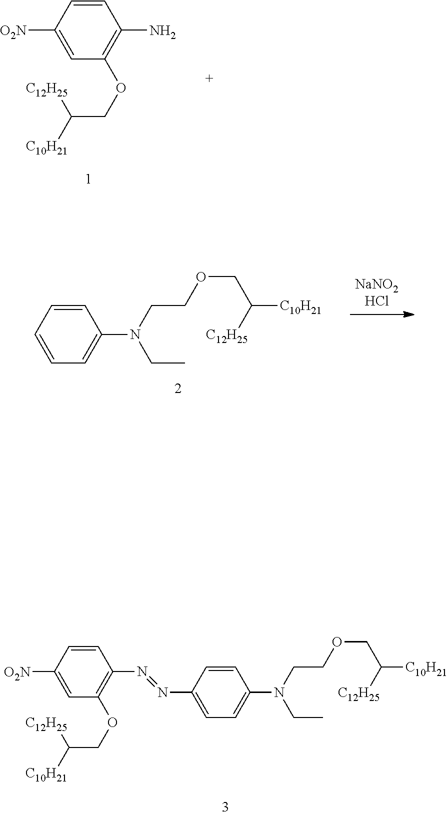

Compound 1 (20 mmol) was dissolved in a solution of 35% hydrochloric acid and the mixture was stirred in an ice bath. Subsequently, a water solution of sodium nitrite (20 mmol) was added slowly and the resulting solution was stirred in the ice bath for 30 min, a solution of 2 (24 mmol) in distilled ethanol was added dropwise and stirred for 1 h. After pH of the resulting solution was adjusted to 7.0 with potassium carbonate, the reaction was stirred for another 30 min. The red solution was diluted with CH₂Cl₂ and washed with brine and deionized water. The crude product was purified by recrystallization.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention. It is intended that the following claims define the scope of the invention and that methods and structures within the scope of these claims and their equivalents be covered thereby.

What is claimed is:

1. A solid state energy storage device, comprising:
a first electrically conductive electrode;
a second electrically conductive electrode;
at least one metadielectric layer located between the first and second conductive electrodes;
wherein the metadielectric layer comprises at least one type of mesogen;
wherein the mesogen consists of an organic compound with at least one electrically resistive substituent and at least one polarizable unit; and
wherein the polarizable unit is independently selected from intramolecular and intermolecular polarizable units.

2. The solid state energy storage device according to claim 1, wherein the device is a film capacitor, and wherein form factor of the thin film capacitor is either a cylindrical coiled capacitor or layered prismatic capacitor.

3. The solid state energy storage device according to claim 1, wherein the organic compound is selected from the list comprising: any compound with rigid electro-polarizable organic units, composite organic polarizable compounds, composite electro-polarizable organic compounds, composite non-linear electro-polarizable compounds, Sharp polymers, Furuta co-polymers, para-Furuta polymers, YanLi polymers, and any combination thereof; and
wherein the composite electro-polarizable organic compounds and composite non-linear electro-polarizable organic compounds are comprised of an aromatic ring system in conjugation with at least one electron donor group and at least one electron withdrawing group.

4. The organic compound from claim 3, wherein the aromatic ring system is selected from: chromophores, tictiods, anisometric conjugated aromatic ring systems, rylene fragments, phenyl groups, naphthyl groups, anthryl groups, and any combination thereof.

5. The solid state energy storage device according to claim 1, wherein the mesogen of the metadielectric layer comprises domain structures selected from any combination of: nematic structures, chematic structures, chiral nematic structures, and lyotropic type structures.

6. The solid state energy storage device according to claim 1, wherein the metadielectric layer has an effective breakdown strength of less than or equal to 1.0V/nm.

7. The solid state energy storage device according to claim 1, wherein the polarizable unit of the organic compound is rigid, wherein the polarizable unit is an aromatic polycyclic conjugated molecule, wherein electrically resistive substituents are present.

8. The solid state energy storage device according to claim 7, wherein the organic compounds form supramolecular structures selected from a list comprising two-dimensional flat form, rod-like, column-like, and disc-like forms; and wherein the polarizable units are oriented in the metadielectric layer such that poles of the polarizable units are substantially perpendicular to the electrodes of the solid state energy storage device.

9. The solid state energy storage device according to claim 1, wherein capacitance varies non-linearly with voltage.

10. The solid state energy storage device according to claim 1, wherein the metadielectric layer has a first relative permittivity (ε₁) below a first critical voltage (Vc₁) and a second relative permittivity (ε₂) above the first critical voltage (Vc₁); wherein the second permittivity (ε₂) is greater than the first permittivity (ε₁) and the metadielectric layer has a second relative permittivity (ε₂) of at least 1,000 above a first critical voltage (Vc₁) and a resistivity between 10¹⁶ Ωcm and 10²⁴ Ωcm.

11. The solid state energy storage device according to claim 10, wherein the metadielectric layer has a third permittivity (ε₃) above a second critical voltage (Vc₂) which is greater than the first critical voltage (Vc₂≥Vc₁) and wherein the second relative permittivity ε₂ is below the second critical voltage Vc₂, and wherein the second permittivity ε₂ is greater than the first permittivity (ε₁), and the third permittivity (ε₃) is greater than the second permittivity (ε₂).

12. The solid state energy storage device according to claim 1, further comprising one or more intermediate layers independently located in following positions: between metadielectric layers, between the metadielectric layer and the first electrode, between the metadielectric layer and the second electrode, wherein the intermediate layer has a permittivity greater than a permittivity of the metadielectric layer and a resistivity less than a resistivity of the metadielectric layer, and smooths interfacial surfaces between the metadielectric layer and the electrically conductive electrode.

13. The solid state energy storage device according to claim 12, further comprising at least one tunnel barrier layer independently located between the metadielectric layer and at least one intermediate layer located near the electrode, wherein the permittivity of the tunnel barrier layer is lower than the permittivity of the intermediate layer, and the breakdown voltage of the tunnel barrier layer is higher than the breakdown voltage of the intermediate layer.

14. The solid state energy storage device according to claim 1, wherein the electrically resistive substituent is selected from the group of: alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the aryl group is selected from substituted and unsubstituted phenyl, benzyl and naphthyl groups or siloxane, and/or polyethyleneglycol as linear or branched chains and wherein the electrically resistive substituent may be C_{X}Q_{2X+1}, where C is Carbon, X≥1 and each instance of Q is selected from hydrogen (H), fluorine (F), or chlorine (Cl), and wherein the at least one electrically resistive substituent is selected from the group consisting of single chain, branched chain, and polycyclic species.

15. The solid state energy storage device according to claim 3, wherein a number W of the electron withdrawing (acceptors) plus a number D of the electron donating groups (donors) is equal to 1, 2, 3, 4, 5, 6, 7, 8, 9, or 10 and each instance of the acceptor and donor groups are independently selected, and wherein the acceptors are independently selected from —NO₂, —NH₃⁺ and —NR₃⁺ (quaternary nitrogen salts), counterion Cl⁻ or Br⁻, —CHO (aldehyde), —CRO (keto group), —SO₃H (sulfonic acids), —SO₃R (sulfonates), —SO₂NH₂ (sulfonamides), —COOH (carboxylic acid), —COOR (esters, from carboxylic acid side), —COCl (carboxylic acid chlorides), —CONH₂ (amides, from carboxylic acid side), —CF₃, —CCl₃, —CN; and wherein the donors are independently selected from —O⁻ (phenoxides, like —ONa or —OK), —NH₂, —NHR, —NR₂, —OH, —OR (ethers), —NHCOR (amides, from amine side), —OCOR (esters, from alcohol side), alkyls, —C₆H₅, vinyls, wherein each instance of R is a radical independently selected from the list comprising alkyl (e.g. methyl, ethyl, isopropyl, tert-butyl, neopentyl, cyclohexyl etc.), allyl (e.g. —CH₂—CH═CH₂), benzyl (e.g. —CH₂C₆H₅) groups, phenyl (including substituted phenyl) and other aryl (aromatic) groups, and wherein the polarizable unit form an anisometric molecular structure.

16. The solid state energy storage device according to claim 1, wherein the metadielectric layer comprises a material having a high breakdown field (E_{bd}) in at least one high-field regions where a breakdown field strength (E_{bd}) is greater than about 1 V/nm and areas of the high-field regions are less than about 1 μm² and/or have volumes less than about 1 μm³, and wherein the materials that comprise the high-field regions are composite organic compounds forming crystalline structures selected from the group of: nematic type crystals, chematic type crystals, chiral nematic type crystals, lamellar structures, micelle structures, and any combination thereof.

17. The solid state energy storage device according to claim 7, wherein the intramolecular or intermolecular polarizable units are substantially evenly dispersed in a matrix formed by electrically resistive substituents, wherein the polarizable units form a substantially crystalline lattice located in the matrix and wherein the matrix is further comprised of one or more alkyl chains, alkyne chains, polymers, crosslinked polymers, the crosslinked electrically resistive substituents, fused poly-cycles, or branched chains which are cross-linked and fluorinated, and the matrix further substantially electrically insulates the intramolecular and intermolecular rigid polarizable units and increases the metadielectric layer's mechanical elasticity during compression and decompression from applying and removing strong electric fields, and wherein the matrix may further comprise a material having an electron effective mass greater than about 0.01 times the free electron mass.

18. The solid state energy storage device according to claim 16, wherein the composite organic compound has a first permittivity under an applied electric field below a critical electric field (Ec) and a second permittivity under an applied electric field above Ec, wherein the first permittivity is lower than the second permittivity.

19. The solid state energy storage device according to claim 16, wherein the composite organic compound further comprises antiferroelectric material and comprises cross-linked substituents attached to the rigid polarizable units of the organic compound and/or comprises inclusions which have a permanent dipole moment.

20. The solid state energy storage device according to claim 16, wherein the composite organic compound further comprises a material having an electron effective mass greater than about 0.1 times the free electron mass.

21. The solid state energy storage device according to claim 1, further comprising at least one conductive layer located between two next metadielectric layers, wherein the breakdown field (E_{bd}) of the device is at least 0.9 V/nm.

22. The solid state energy storage device according to claim 7, wherein a distribution of the intramolecular or intermolecular rigid polarizable units of the organic compound in the metadielectric layer at least partially compensates the electric field applied between electrodes.

23. The solid state energy storage device according to claim 1, wherein the mesogens in the metadielectric layer are electrically coupled together in (by) a positive feedback.

24. The solid state energy storage device according to claim 1, wherein the mesogens are arranged in the metadielectric layer such that electrical coupling in the direction of the applied field is much stronger than electrical coupling in the directions perpendicular to the applied field.

25. The solid state energy storage device according to claim 1, wherein at least one metadielectric layer has a polycrystalline structure, the crystallites being comprised of the mesogens which are either: lyotropic liquid crystal phases or thermotropic liquid crystals, wherein the crystallites have the shape of a needle, sphere, disk, rod, parallelepiped and any combination thereof, and wherein the at least one organic compound has an anisometric shape which is elongated in the direction substantially perpendicular to planes of the conductive electrodes.

26. The solid state energy storage device according to claim 1, wherein the metadielectric layer comprises a mixture organic compounds.

27. The solid state energy storage device according to claim 1, wherein the metadielectric layer consists of a non-ionic plasticizer.
